(19) United States
(12) Patent Application Publication
(10) Pub. No.: US 2025/0314316 A1
(43) Pub. Date: Oct. 9, 2025

(54) FLUID CONTROL VALVE

(71) Applicant: DENSO CORPORATION, Kariya-city (JP)

(72) Inventor: Ryo NOMURA, Kariya-city (JP)

(21) Appl. No.: 19/246,136

(22) Filed: Jun. 23, 2025

Related U.S. Application Data
(63) Continuation of application No. PCT/JP2023/042909, filed on Nov. 30, 2023.

(30) Foreign Application Priority Data
Dec. 28, 2022 (JP) 2022-212182

(51) Int. Cl. F16K 11/083; F16K 27/06

(52) U.S. Cl. CPC F16K 11/0836; F16K 27/062

(57) ABSTRACT

A valve rotatatable about an axial center includes a valve outer wall portion defining flow path portions. A housing includes a housing outer wall portion accommodating the valve and defining opening portions. A seal member is disposed between the valve outer wall portion and the housing outer wall portion. The opening portions are formed in a grid pattern in which two or more opening portions are arranged in the axial-center direction and arranged in two or more columns in the circumferential direction. The number of columns of the opening portions arranged in the circumferential direction is a number of opening columns. The number of columns of the through-holes arranged in the circumferential direction is a number of through-hole columns. The number of through-hole columns is set to be larger than the number of opening columns.

### CROSS REFERENCE TO RELATED APPLICATION

The present application is a continuation application of International Patent Application No. PCT/JP2023/042909 filed on Nov. 30, 2023, which designated the U.S. and claims the benefit of priority from Japanese Patent Application No. 2022-212182 filed on Dec. 28, 2022. The entire disclosures of all of the above applications are incorporated herein by reference.

### TECHNICAL FIELD

The present disclosure relates to a fluid control valve.

### BACKGROUND

Conventionally, a known fluid control valve includes a valve with a plurality of flow path portions through which fluid flows.

### SUMMARY

According to an aspect of the present disclosure, a fluid control valve comprises: a valve configured to rotate about an axial center and including a valve outer wall portion defining a plurality of flow path portions configured to cause fluid to flow therethrough; a housing including a housing outer wall portion defining a valve accommodation space accommodating the valve, and a plurality of opening portions in the housing outer wall portion configured to cause fluid to pass therethrough; and a seal member provided between the valve outer wall portion and a portion of the housing outer wall portion defining the plurality of opening portions. A direction in which the axial center extends is an axial-center direction, a direction in which the valve is rotatable about the axial center is a circumferential direction, and the plurality of opening portions are defined in a grid pattern in which two or more opening portions of the plurality of opening portions are arranged in the axial-center direction in two or more columns in the circumferential direction. The seal member has a plurality of through-holes configured to cause the fluid to pass therethrough. The plurality of flow path portions are in shapes corresponding to the plurality of opening portions and the plurality of through-holes, respectively. The plurality of through-holes include a plurality of through-holes arranged in the axial-center direction and a plurality of through-holes arranged in a plurality of columns in the circumferential direction. The number of columns of the plurality of opening portions, which are arranged in the circumferential direction, may be a number of opening columns. The number of columns of the plurality of through-holes arranged in the circumferential direction may be a number of through-hole columns. The number of through-hole columns may be set to be larger than the number of opening columns.

### BRIEF DESCRIPTION OF DRAWINGS

FIG. 1 is a front view of a fluid control valve according to a first embodiment.

FIG. 2 is a side view of the fluid control valve according to the first embodiment.

FIG. 3 is a top view of the fluid control valve according to the first embodiment.

FIG. 4 is a cross-sectional view taken along line IV-IV illustrated in FIG. 3.

FIG. 5 is a front view of a housing according to the first embodiment.

FIG. 6 is a top view of the housing according to the first embodiment, as viewed from a direction of an arrow denoted by VI in FIG. 5.

FIG. 7 is a view for explaining opening portions according to the first embodiment.

FIG. 8 is a view illustrating a valve according to the first embodiment.

FIG. 9 is a cross-sectional view taken along line IX-IX illustrated in FIG. 1.

FIG. 10 is a developed view of the valve in the circumferential direction according to the first embodiment.

FIG. 11 is a view for explaining fluid passages according to the first embodiment.

FIG. 12 is a view illustrating a state in which a seal member is attached to the housing according to the first embodiment.

FIG. 13 is a view illustrating a state before the seal member according to the first embodiment is attached to the housing.

FIG. 14 is a view illustrating a state in which the seal member according to the first embodiment is attached to the housing.

FIG. 15 is a view for explaining a ninth fluid passage according to the first embodiment.

FIG. 16 is a view for explaining fluid flowing through the ninth fluid passage according to the first embodiment.

FIG. 17 is a front view of a fluid control valve according to a second embodiment.

FIG. 18 is a view illustrating a state before the seal member according to the second embodiment is attached to the housing.

FIG. 19 is a view illustrating a valve according to the second embodiment.

FIG. 20 is a view for explaining fluid flowing through an eleventh fluid passage according to the second embodiment.

FIG. 21 is a cross-sectional view of a fluid control valve according to a third embodiment.

FIG. 22 is a cross-sectional view taken along line XXII-XXII illustrated in FIG. 21.

FIG. 23 is a front view of a fluid control valve according to a fourth embodiment.

FIG. 24 is a top view of the fluid control valve according to the fourth embodiment.

FIG. 25 is a cross-sectional view taken along line XXV-XXV illustrated in FIG. 24.

FIG. 26 is a top view of the fluid control valve according to a modification of

the fourth embodiment.

FIG. 27 is a cross-sectional view taken along line XXVII-XXVII illustrated in FIG. 26.

FIG. 28 is a cross-sectional view of a fluid control valve according to a fifth embodiment.

FIG. 29 is a view illustrating a state in which fluid flowing in from the opening portion on one side of two opening portions arranged in the circumferential direction flows out from the opening portion on the other side.

FIG. 30 is a view illustrating a shape of a valve that allows fluid to flow through two opening portions arranged in the circumferential direction.

FIG. 31 is a view illustrating a state in which fluid flowing in from the opening portion on one side of the two opening portions arranged in the axial-center direction flows out from the opening portion on the other side.

FIG. 32 is a view illustrating a shape of a valve that allows fluid to flow through two opening portions arranged in an axial-center direction.

FIG. 33 is a view illustrating an example of a state in which fluid flowing in from one opening portion flows out from two opening portions.

FIG. 34 is a view illustrating another example of a state in which fluid flowing in from one opening portion flows out from two opening portions.

FIG. 35 is a view illustrating an example of a state in which fluid flowing in from two opening portions flows out from one opening portion.

FIG. 36 is a view illustrating another example of a state in which fluid flowing in from two opening portions flows out from one opening portion.

FIG. 37 is a view illustrating a shape of a valve that allows fluid flowing in from one opening portion to flow out from two opening portions, or allows fluid flowing in from two opening portions to flow out from one opening portion.

FIG. 38 is a view illustrating an example of a state in which fluid flowing in from three opening portions flows out from two opening portions.

FIG. 39 is a view illustrating an example of a state in which fluid flowing in from two opening portions flows out from three opening portions.

FIG. 40 is a view illustrating an example of a state in which fluid flowing in from one opening portion flows out from four opening portions.

FIG. 41 is a view illustrating an example of a state in which fluid flowing in from four opening portions flows out from one opening portion.

FIG. 42 is a view illustrating a shape of a valve that allows fluid flowing in from three opening portions to flow out from two opening portions, allows fluid flowing in from two opening portions to flow out from three opening portions, and the like.

FIG. 43 is a view illustrating an example of a state in which fluid flowing in from one opening portion flows out from six opening portions.

FIG. 44 is a view illustrating an example of a state in which fluid flowing in from six opening portions flows out from one opening portion.

FIG. 45 is a view illustrating an example of a state in which fluid flowing in from three opening portions flows out from four opening portions.

FIG. 46 is a view illustrating an example of a state in which fluid flowing in from five opening portions flows out from two opening portions.

FIG. 47 is a view illustrating a shape of a valve that allows fluid flowing in from one opening portion to flow out from six opening portions, allows fluid flowing in from six opening portions to flow out from one opening portion, and the like.

FIG. 48 is a view illustrating an example of a state in which fluid flowing in from one opening portion flows out from seven opening portions.

FIG. 49 is a view illustrating a shape of a valve that allows fluid flowing in from one opening portion to flow out from seven opening portions.

FIG. 50 is a view for explaining a portion where a rib is not formed in a valve that allows fluid to flow to two opening portions arranged in the circumferential direction.

FIG. 51 is a view for explaining a portion where a rib is not formed in a valve that allows fluid to flow to two opening portions arranged in an axial-center direction.

FIG. 52 is a view for explaining a portion where a rib is not formed in a valve that allows fluid to flow to three opening portions arranged in the circumferential direction.

FIG. 53 is a view for explaining a portion where a rib is not formed in a valve that allows fluid to flow to three opening portions arranged in an axial-center direction.

FIG. 54 is a view for explaining a portion where a rib is not formed in a valve provided with an opening portion for fluid outflow in each of the axial-center direction and the circumferential direction with respect to an opening portion for fluid inflow.

FIG. 55 is a view for explaining a portion where a rib is not formed in a valve provided with an opening portion for fluid outflow in each of the axial-center direction and the circumferential direction with respect to an opening portion for fluid inflow.

FIG. 56 is a view for explaining a portion where a rib is not formed in a valve provided with an opening portion for fluid outflow in the circumferential direction with respect to an opening portion for fluid inflow.

FIG. 57 is a view for explaining a portion where a rib is not formed in a valve provided with an opening portion for fluid outflow in the axial-center direction with respect to an opening portion for fluid inflow.

FIG. 58 is a view for explaining a portion where a rib is not formed in a valve provided with opening portions for fluid inflow that are arranged in each of the axial-center direction and the circumferential direction, and opening portions for fluid outflow that are arranged in the circumferential direction.

FIG. 59 is a view for explaining a portion where a rib is not formed in a valve provided with opening portions for fluid inflow that are arranged in the circumferential direction, and opening portions for fluid outflow that are arranged in each of the axial-center direction and the circumferential direction.

FIG. 60 is a view for explaining a portion where a rib is not formed in a valve that allows fluid to flow between opening portions not adjacent to each other while bypassing portions facing opening portions.

FIG. 61 is a view for explaining a portion where a rib is not formed in a valve that allows fluid to flow between a plurality of opening portions not adjacent to each other while bypassing the portions facing the opening portions.

FIG. 62 is a view for explaining a portion where a rib is not formed in a valve that allows fluid to flow between a plurality of opening portions not adjacent to each other while bypassing the portions facing the opening portions.

### DETAILED DESCRIPTION

Hereinafter, examples of the present disclosure will be described.

According to an example, a fluid control valve includes a valve with a plurality of flow path portions through which fluid flows, a housing that accommodates the valve and includes a plurality of ports for fluid inflow and outflow, and a seal member provided between the valve and the housing. In the fluid control valve, for example, four rows of ports are formed in the housing in the rotational axis direction of the valve, two columns of ports are formed in the rotation direction of the valve, and a total of eight ports are formed in a grid pattern. A plurality of flow path portions capable of straddling two ports along either the rotational axis direction of the valve or the rotation direction of the valve are formed in the outer circumferential portion of the valve. The seal member surrounds all of the eight ports and is formed in a grid pattern with through-holes corresponding to the eight ports. In the fluid control valve including the valve, the housing, and the seal member as above, the valve rotates to switch a flow path portion communicating with each of the eight ports, thereby switching the flow of the fluid flowing into and out of the fluid control valve.

In this example, the seal member includes an outer peripheral portion surrounding all of the eight ports, and partitioning portions surrounding the eight ports, respectively. Thus, in the seal member, when the respective flow path portions are positioned facing the eight ports, the outer peripheral portion and the partitioning portions may reduce the mixture of the fluid flowing through each of the eight ports.

However, when the flow path portion formed to be able to straddle two columns of ports along the rotation direction of the valve is positioned at a position straddling the outer peripheral portion, the seal member cannot surround a portion of the flow path portion straddling the outer peripheral portion that does not face the port. Then, when the side of the valve facing the port is defined as the front side and the side opposite to the front side is defined as the back side, the fluid flowing through the flow path portion straddling the outer peripheral portion flows from the front side to the back side of the valve, and the fluid flows into the flow path portion other than the flow path portion facing the port. This may cause unexpected fluid flow and fluid leakage.

However, adjusting the rotational position of the valve may prevent such unexpected fluid flow and fluid leakage. For example, in the fluid control valve, the rotational position of the valve may be adjusted so that the flow path portion straddling two ports in the rotation direction of the valve does not straddle the outer peripheral portion of the seal member, whereby the flow of the fluid to the back side of the valve can be reduced.

However, intensive studies by the inventors have found that adjusting the rotational position of the valve so that the outer peripheral portion of the seal member is not straddled limits the rotational position of the valve, and the switching pattern is limited when the fluid control valve switches the flow of the fluid.

According to an aspect of the present disclosure, a fluid control valve comprises: a valve configured to rotate about an axial center and including a valve outer wall portion defining a plurality of flow path portions configured to cause fluid to flow therethrough; a housing including a housing outer wall portion defining a valve accommodation space accommodating the valve, and a plurality of opening portions in the housing outer wall portion configured to cause fluid to pass therethrough; and a seal member provided between the valve outer wall portion and a portion of the housing outer wall portion defining the plurality of opening portions. A direction in which the axial center extends is an axial-center direction, a direction in which the valve is rotatable about the axial center is a circumferential direction, and the plurality of opening portions are defined in a grid pattern in which two or more opening portions of the plurality of opening portions are arranged in the axial-center direction in two or more columns in the circumferential direction. The seal member has a plurality of through-holes configured to cause the fluid to pass therethrough. The plurality of flow path portions are in shapes corresponding to the plurality of opening portions and the plurality of through-holes, respectively. The plurality of through-holes include a plurality of through-holes arranged in the axial-center direction and a plurality of through-holes arranged in a plurality of columns in the circumferential direction. The number of columns of the plurality of opening portions, which are arranged in the circumferential direction, is a number of opening columns. The number of columns of the plurality of through-holes arranged in the circumferential direction is a number of through-hole columns. The number of through-hole columns is set to be larger than the number of opening columns.

According to this, when any of the plurality of flow path portions is positioned at a position straddling the opening portion at the end portion in the circumferential direction among the plurality of opening portions, the seal member can surround the flow path portion straddling the opening portion at the end portion in the circumferential direction. Therefore, even when the flow path portion is positioned at a position straddling the opening portion at the end portion in the circumferential direction, it is possible to reduce the flow of the fluid that flows through the flow path portion from between the valve outer wall portion and the housing outer wall portion to the back side of the valve. Therefore, the rotational position of the valve may not be adjusted so that the plurality of flow path portions do not straddle the opening portion at the end portion in the circumferential direction. That is, it is possible to reduce the flow of the fluid to the back side of the valve without limiting the switching pattern of the fluid control valve that is switched by rotating the valve.

Hereinafter, embodiments of the present disclosure will be described with reference to the drawings. In the following embodiments, the same or equivalent parts to those described in the preceding embodiment are denoted by the same reference numerals, and the description thereof may be omitted. When only some of the constituent elements are described in the embodiment, the constituent elements described in the preceding embodiment can be applied to the other constituent elements. In the following embodiments, the embodiments can be partially combined with each other as long as the combination is not particularly hindered, even when not particularly specified.

### First Embodiment

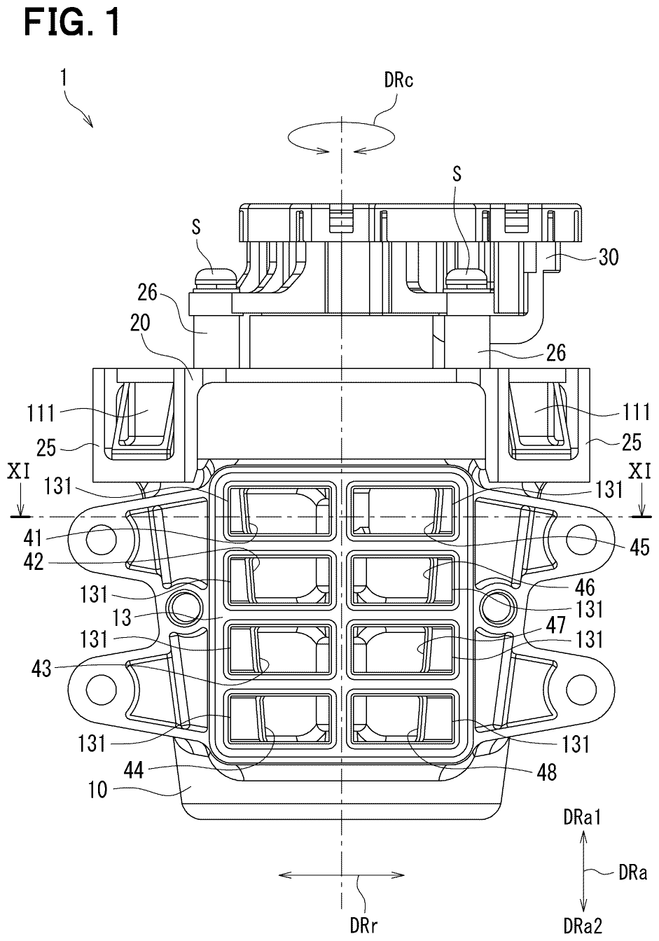

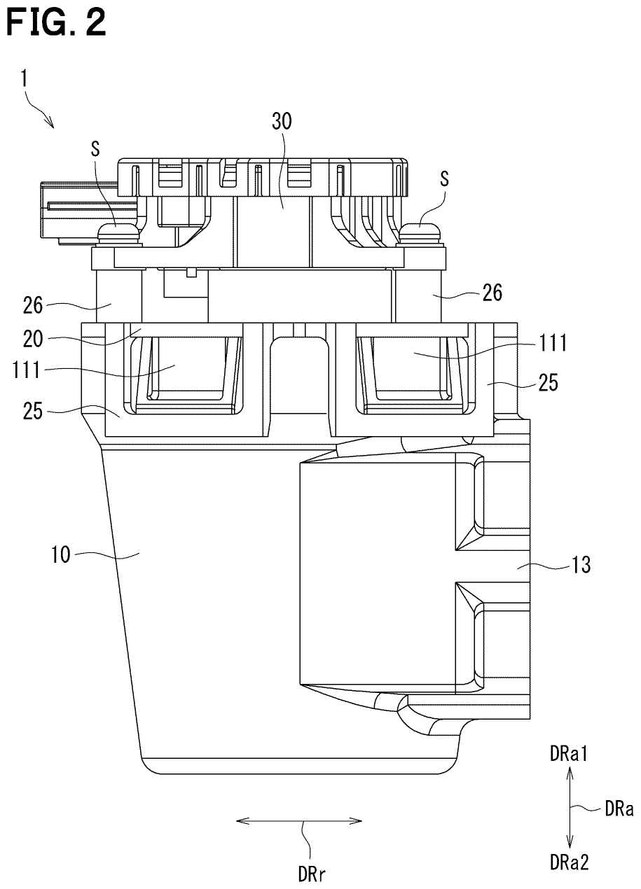

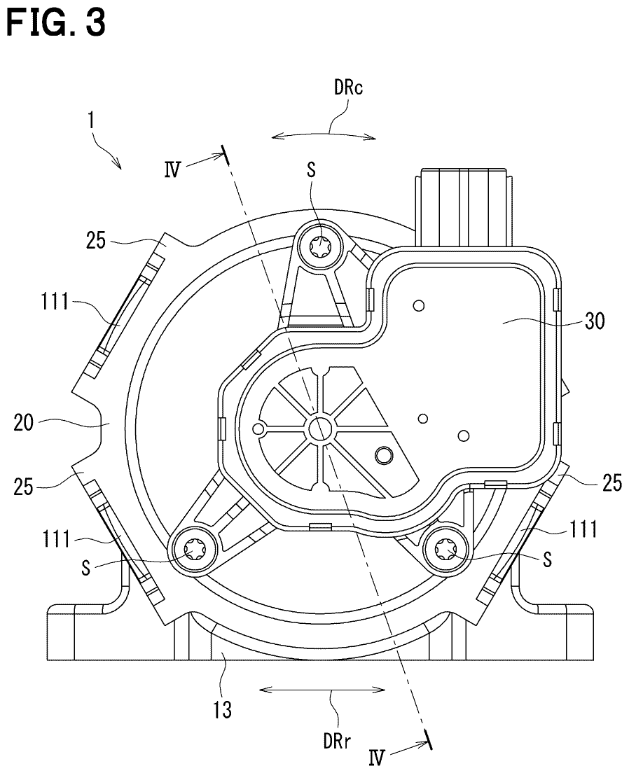

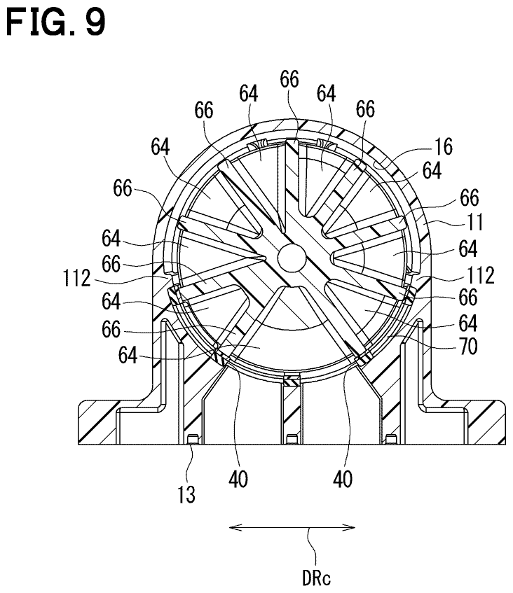

The present embodiment will be described with reference to FIGS. 1 to 16. A fluid control valve 1 of the present embodiment is, for example, a valve device applied to fluid circulation system in which fluid (in this example, cooling water) circulates to adjust the temperatures of a vehicle interior and a battery of an electric vehicle or a hybrid vehicle. The fluid circulation system is a system that circulates cooling water to a power source for vehicle travel, a radiator, a heater core for vehicle interior air conditioning, a battery, and the like. As the cooling water, for example, long-life coolant, that is, LLC, containing ethylene glycol is used. The fluid control valve 1 performs switching of the flow path of the fluid in the fluid circulation system, adjustment of the flow rate, or the like.

First, the fluid control valve 1 of the present embodiment will be described. As illustrated in FIGS. 1 to 5, the fluid control valve 1 of the present embodiment includes a housing 10, a housing cover 20, a drive unit 30, a valve 60, a seal member 70, a biasing portion 80, and the like. The fluid control valve 1 of the present embodiment is configured as a valve device that switches the flow path of the cooling water flowing through the fluid circulation system by the drive unit 30 rotating the valve 60 about an axial center CL to be described later.

The fluid control valve 1 is configured to switch the operation mode of the fluid control valve 1 to switch the flow path of the fluid flowing in the fluid circulation system. The operation mode of the fluid control valve 1 is switched by the drive unit 30. Details of the operation mode will be described later.

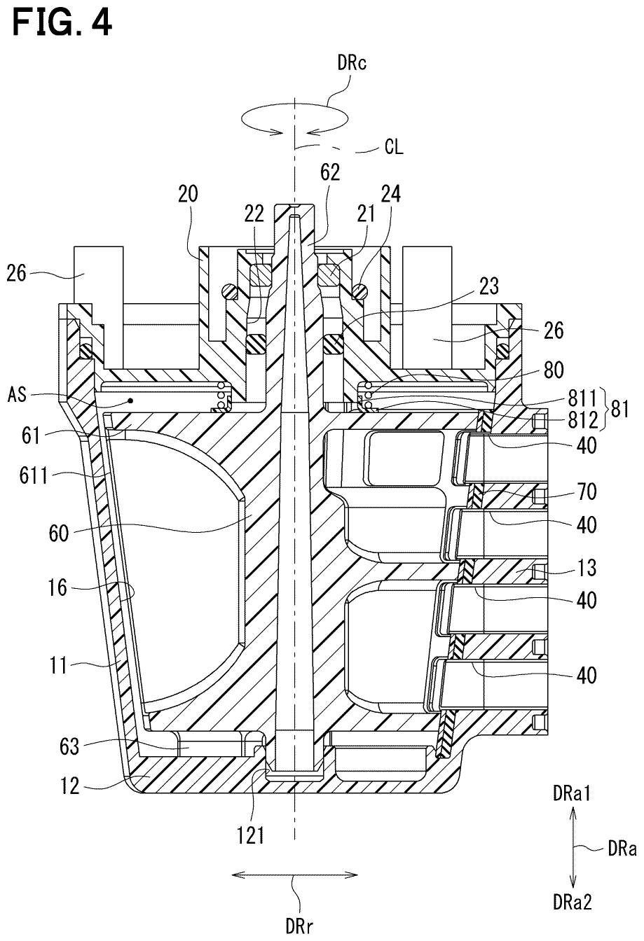

As illustrated in FIG. 4, the housing 10 constitutes the outer shell of the fluid control valve 1, and forms a valve accommodation space AS that accommodates the valve 60 inside the outer shell. The housing 10 is a non-rotating member that does not rotate. Specifically, the housing 10 includes a cylinder 11 formed in a bottomed cylindrical shape, a bottom 12 forming a bottomed cylindrical bottom-side portion, and a port forming portion 13 that allows fluid to flow into and out of the valve accommodation space AS. The cylinder 11, the bottom 12, and the port forming portion 13 are molded, for example, by injection molding in which a resin material is poured into a mold and solidified into a desired shape. Specifically, the housing 10 is formed of, for example, any of a reinforcement of polyamide 66 (hereinafter referred to as “PA66”), a reinforcement of polyphthalamide (hereinafter referred to as “PPA”), and a reinforcement of polyphenylene sulfide (hereinafter referred to as “PPS”). The reinforcement is, for example, a member formed by combining PA66, PPA, or PPS with a glass fiber or the like. In FIG. 4, the drive unit 30 is omitted.

As illustrated in FIG. 4, the valve 60 and the seal member 70 are accommodated in the valve accommodation space AS that is the inside of the housing 10. In the housing 10, the opening side of the cylinder 11 is closed by the housing cover 20.

Hereinafter, as illustrated in FIG. 1 and the like, various configurations and the like will be described, with a direction along the axial center CL defined as an axial-center direction DRa, a direction on one side in the axial-center direction DRa defined as a first axial-center direction DRa1, and a direction opposite to the first axial-center direction DRa1 defined as a second axial-center direction DRa2. In the present embodiment, the opening side of the cylinder 11 is defined as the first axial-center direction DRa1, and the bottom 12 side of the housing 10 is defined as the second axial-center direction DRa2.

In addition, various configurations and the like will be described, with a direction orthogonal to the axial-center direction DRa and extending radially from the axial center CL defined as a radial direction DRr, and a direction about the axial center CL, centered on the axial center CL, defined as a circumferential direction DRc. The circumferential direction DRc is a direction in which the valve 60 rotates by the driving force supplied from the drive unit 30. In the circumferential direction DRc, one side is defined as a first circumferential direction DRc1, and the other side is defined as a second circumferential direction DRc2. The directions illustrated in FIG. 1 and the like are examples, and do not limit the installation state of the fluid control valve 1 of the present disclosure.

The cylinder 11 is a portion surrounding most of the portion of the valve 60 and is formed in a cylindrical shape. The cylinder 11 is formed such that the central axis is coaxial with the axial center CL. The cylinder 11 is formed in a substantially conical shape with the outer diameter and inner diameter decreasing from the first axial-center direction DRa1 toward the second axial-center direction DRa2. That is, the cylinder 11 is formed in a substantially conical shape, in which the second axial-center direction DRa2 side is an apex side and the first axial-center direction DRa1 side is a bottom side. In other words, in the cross-section of the cylinder 11 orthogonal to the axial center CL, the distance from the axial center CL to the outer shell decreases from the first axial-center direction DRa1 toward the second axial-center direction DRa2. However, the cylinder 11 is formed flat, with the end portion on the first axial-center direction DRa1 side not being the apex. The cylinder 11 of the present embodiment functions as a housing outer wall portion forming the valve accommodation space AS.

As illustrated in FIG. 1 and the like, a claw portion 111 for attaching the housing cover 20 is provided on the first axial-center direction DRa1 side of the cylinder 11. The bottom 12 is connected to the cylinder 11 on the second axial-center direction DRa2 side.

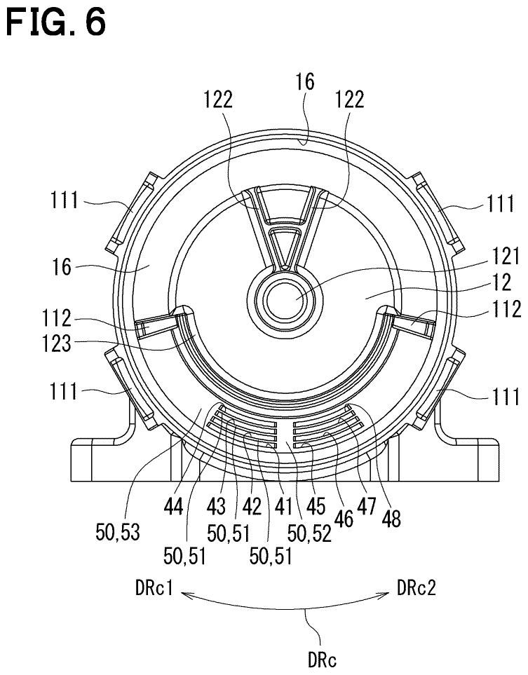

As illustrated in FIG. 6, a circumferential-side seal regulating portion 112 that regulates the movement of the seal member 70 in the circumferential direction DRc is provided inside the cylinder 11. The circumferential-side seal regulating portion 112 regulates the movement of the seal member 70 in the circumferential direction DRc with the rotation of the valve 60 when the valve 60 rotates in the circumferential direction DRc. The circumferential-side seal regulating portion 112 is formed protruding toward the axial center CL at each of positions corresponding to the end portion of the seal member 70 on the first circumferential direction DRc1 side and the end portion on the second circumferential direction DRc2 side in a portion where the seal member 70 is disposed on the inner circumferential surface 16 of the cylinder 11.

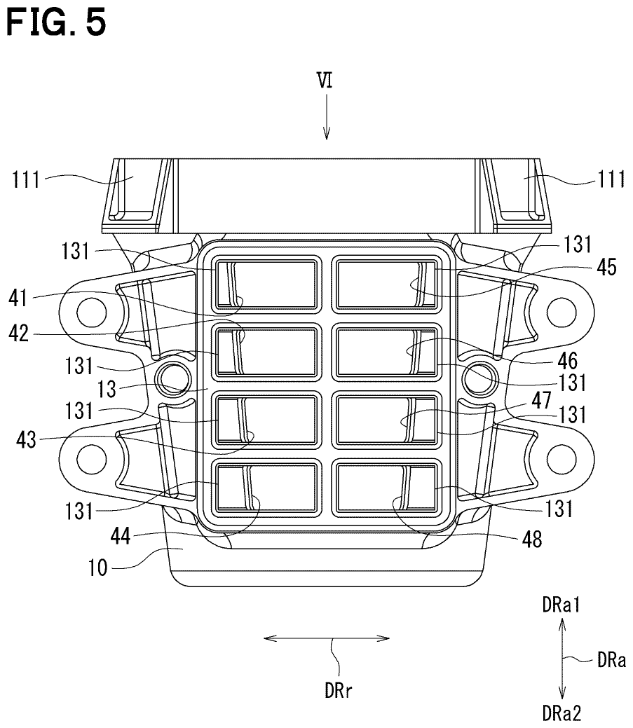

The cylinder 11 is formed with a plurality of opening portions 40 through which the fluid flows into the valve accommodation space AS, as illustrated in FIGS. 5 to 7, and the fluid flowing into the valve accommodation space AS flows out of the housing 10, as illustrated in FIG. 4. Specifically, as illustrated in FIGS. 5 to 7, eight opening portions 41, 42, 43, 44, 45, 46, 47, 48 are formed in the cylinder 11. The eight opening portions 41, 42, 43, 44, 45, 46, 47, 48 are formed in a portion of the cylinder 11 where the port forming portion 13 is provided. The eight opening portions 41, 42, 43, 44, 45, 46, 47, 48 are formed through the cylinder 11 in the radial direction DRr. That is, the eight opening portions 41, 42, 43, 44, 45, 46, 47, 48 are formed by cutting out the cylinder 11.

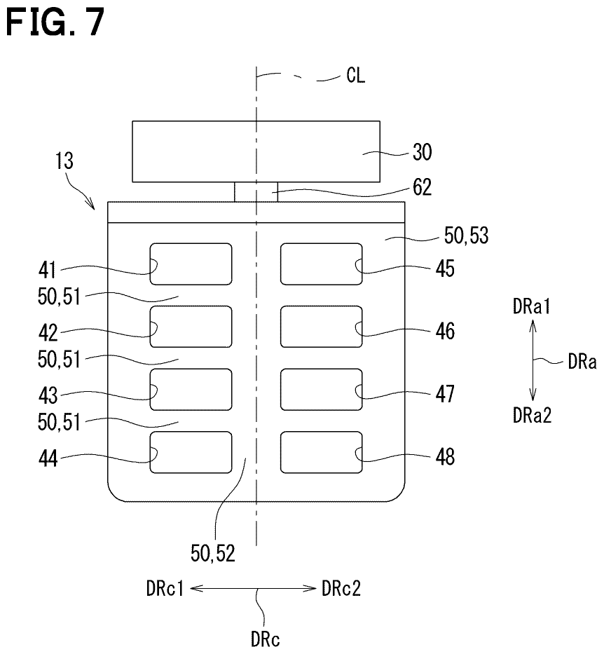

Hereinafter, the eight opening portions 41, 42, 43, 44, 45, 46, 47, 48 may be referred to as eight opening portions 41 to 48. FIG. 7 is a view for explaining the eight opening portions 41 to 48, and is a view schematically illustrating a portion of the housing 10 where the eight opening portions 41 to 48 are formed when the housing 10 is viewed from a direction along the radial direction DRr.

As illustrated in FIGS. 5 to 7, the eight opening portions 41 to 48 are formed in a grid pattern with four opening portions arranged in the axial-center direction DRa and the opening portions arranged in two columns in the circumferential direction DRc. The eight opening portions 41 to 48 have shapes corresponding to the substantially conical cylinder 11 with the outer diameter and inner diameter decreasing from the first axial-center direction DRa1 toward the second axial-center direction DRa2. Specifically, as illustrated in FIGS. 5 and 6, each of the eight opening portions 41 to 48 has an opening shape that is a substantially trapezoidal shape, and the size in the circumferential direction DRc on the second axial-center direction DRa2 side is smaller than that on the first axial-center direction DRa1 side. The opening area, that is, the cross-sectional area orthogonal to the radial direction DRr, of each of the eight opening portions 41 to 48 decreases from the first axial-center direction DRa1 side toward the second axial-center direction DRa2 side.

The cylinder 11 includes a partition 50 that separates the eight opening portions 41 to 48. Specifically, the partition 50 includes three circumferential-side partitions 51 that separate the eight opening portions 41 to 48 in the axial-center direction DRa, and one axial-side partition 52 that separates the eight opening portions 41 to 48 in the circumferential direction DRc. The partition 50 includes an outer peripheral partition 53 surrounding the eight opening portions 41 to 48 and communicating with three circumferential-side partitions 51 and one axial-side partition 52.

The three circumferential-side partitions 51 are formed extending in the circumferential direction DRc. Among the eight opening portions 41 to 48 arranged in two columns, the three circumferential-side partitions 51 separate, in the axial-center direction DRa, four opening portions 41, 42, 43, 44 arranged in one column in the axial-center direction DRa on the first circumferential direction DRc1 side. Among the eight opening portions 41 to 48 arranged in two columns, the three circumferential-side partitions 51 separate, in the axial-center direction DRa, four opening portions 45, 46, 47, 48 arranged in the other column in the axial-center direction DRa on the second circumferential direction DRc2 side.

One axial-side partition 52 is formed extending in the axial-center direction DRa. Among the eight opening portions 41 to 48 arranged in two columns, one axial-side partition 52 separates the opening portions 41, 42, 43, 44 in one column and the opening portions 45, 46, 47, 48 in the other column in the circumferential direction DRc.

The outer peripheral partition 53 is an outer peripheral portion surrounding the eight opening portions 41 to 48. The outer peripheral partition 53 surrounds the eight opening portions 41 to 48 on the first circumferential direction DRc1 side, the second axial-center direction DRa2 side, the first axial-center direction DRa1 side, and the second axial-center direction DRa2 side.

In the present embodiment, among the eight opening portions 41, 42, 43, 44, 45, 46, 47, 48, four opening portions 42, 44, 45, 47 allow the fluid to flow into the valve accommodation space AS, and four opening portions 41, 43, 46, 48 allow the fluid to flow out of the housing 10. Hereinafter, the opening portions 42, 44, 45, 47 for fluid inflow to the valve accommodation space AS are referred to as a first fluid inlet 42, a second fluid inlet 44, a third fluid inlet 45, and a fourth fluid inlet 47. The four opening portions 41, 43, 46, 48 through which the fluid flows out of the housing 10 are referred to as a first fluid outlet 41, a second fluid outlet 43, a third fluid outlet 46, and a fourth fluid outlet 48.

The first fluid inlet 42, the second fluid inlet 44, the third fluid inlet 45, and the fourth fluid inlet 47 are inlet ports that allow fluid to flow into the valve accommodation space AS in the housing 10. The first fluid outlet 41, the second fluid outlet 43, the third fluid outlet 46, and the fourth fluid outlet 48 are outlet ports that allow the fluid flowing into the valve accommodation space AS in the housing 10 to flow out to the outside of the valve accommodation space AS.

In the present embodiment, the first fluid outlet 41, the first fluid inlet 42, the second fluid outlet 43, and the second fluid inlet 44 are arranged from the first axial-center direction DRa1 toward the second axial-center direction DRa2 on the first circumferential direction DRc1 side. The third fluid inlet 45, the third fluid outlet 46, the fourth fluid inlet 47, and the fourth fluid outlet 48 are arranged from the first axial-center direction DRa1 toward the second axial-center direction DRa2 on the second circumferential direction DRc2 side.

That is, the first fluid inlet 42 and the first fluid outlet 41 are adjacent to each other in the axial-center direction DRa. The second fluid inlet 44 and the second fluid outlet 43 are adjacent to each other in the axial-center direction DRa. The third fluid inlet 45 and the third fluid outlet 46 are adjacent to each other in the axial-center direction DRa. The fourth fluid inlet 47 and the fourth fluid outlet 48 are adjacent to each other in the axial-center direction DRa.

The first fluid inlet 42 and the third fluid outlet 46 are adjacent to each other in the circumferential direction DRc. The second fluid inlet 44 and the fourth fluid outlet 48 are adjacent to each other in the circumferential direction DRc. The third fluid inlet 45 and the first fluid outlet 41 are adjacent to each other in the circumferential direction DRc. The fourth fluid inlet 47 and the second fluid outlet 43 are adjacent to each other in the circumferential direction DRc.

The port forming portion 13 is provided at a position facing the first fluid inlet 42, the second fluid inlet 44, the third fluid inlet 45, the fourth fluid inlet 47, the first fluid outlet 41, the second fluid outlet 43, the third fluid outlet 46, and the fourth fluid outlet 48.

Hereinafter, a group of opening portions including the first fluid outlet 41, the first fluid inlet 42, the second fluid outlet 43, and the second fluid inlet 44 may be referred to as a first-column opening portion, and a group of opening portions including the third fluid inlet 45, the third fluid outlet 46, the fourth fluid inlet 47, and the fourth fluid outlet 48 may be referred to as a second-column opening portion. A group of opening portions including the third fluid inlet 45 and the first fluid outlet 41 may be referred to as a first-row opening portion, and a group of opening portions including the first fluid inlet 42 and the third fluid outlet 46 may be referred to as a second-row opening portion. A group of opening portions including the fourth fluid inlet 47 and the second fluid outlet 43 may be referred to as a third-row opening portion, and a group of opening portions including the second fluid inlet 44 and the fourth fluid outlet 48 may be referred to as a fourth-row opening portion.

The arrangement of the first fluid inlet 42, the second fluid inlet 44, the third fluid inlet 45, the fourth fluid inlet 47, the first fluid outlet 41, the second fluid outlet 43, the third fluid outlet 46, and the fourth fluid outlet 48 is not limited to this example, and can be appropriately changed. Hereinafter, the first fluid inlet 42, the second fluid inlet 44, the third fluid inlet 45, and the fourth fluid inlet 47 may be referred to as the first fluid inlet 42 to the fourth fluid inlet 47. The first fluid outlet 41, the second fluid outlet 43, the third fluid outlet 46, and the fourth fluid outlet 48 may be referred to as the first fluid outlet 41 to the fourth fluid outlet 48.

The bottom 12 closes a part of the valve accommodation space AS and supports a rotating shaft 62, described later, of the valve 60. The bottom 12 is formed by planar expansion along the radial direction DRr and the circumferential direction DRc. As illustrated in FIGS. 4 and 6, the bottom 12 includes a support hole 121 into which the second axial-center direction DRa2 side of the rotating shaft 62 of the valve 60 is fitted. The support hole 121 rotatably supports the rotating shaft 62.

As illustrated in FIG. 6, the bottom 12 is provided with two rotation regulating portions 122 that regulate the rotation of the valve 60. The rotation regulating portion 122 is formed at a position that can be in contact with a stopper 63, described later, of the valve 60. When the valve 60 rotates toward the first circumferential direction DRc1, the stopper 63 of the valve 60 comes into contact with one rotation regulating portion 122, reducing the rotation of the valve 60 in the first circumferential direction DRc1. When the valve 60 rotates toward the second circumferential direction DRc2, the stopper 63 of the valve 60 comes into contact with the other rotation regulating portion 122, reducing the rotation of the valve 60 toward the second circumferential direction DRc2. Thus, the rotational position of the valve 60 is set at the initial position.

Furthermore, the bottom 12 is provided with a radial-side seal regulating portion 123 that regulates the movement of the seal member 70 in the circumferential direction DRc and the radial direction DRr. When the valve 60 rotates in the circumferential direction DRc, the radial-side seal regulating portion 123 regulates the movement of the seal member 70 in the circumferential direction DRc with the rotation of the valve 60 and regulates movement inward in the radial direction DRr. The radial-side seal regulating portion 123 is formed in a groove shape recessed along the circumferential direction DRc from one circumferential-side seal regulating portion 112 to the other circumferential-side seal regulating portion 112 at the end portion of the cylinder 11 in the radial direction DRr.

The port forming portion 13 is a portion that allows the fluid to flow into the valve accommodation space AS and allows the fluid flowing into the valve accommodation space AS to flow out to the outside of the housing 10. The port forming portion 13 has a rectangular parallelepiped shape, and the axial-center direction DRa is formed in the longitudinal direction. The port forming portion 13 is formed with flow holes 131 that communicates with the first fluid inlet 42 to the fourth fluid inlet 47 and the first fluid outlet 41 to the fourth fluid outlet 48, respectively. The flow hole 131 is formed through the port forming portion 13 in the radial direction DRr.

The housing cover 20 closes the valve accommodation space AS by closing the opening side of the cylinder 11 in the housing 10, and supports the rotating shaft 62 of the valve 60. As illustrated in FIG. 4, the housing cover 20 includes a bearing portion 21 that supports the rotating shaft 62 of the valve 60 on the first axial-center direction DRa1 side, and an annular cover seal 23 that seals a gap between the rotating shaft 62 and a shaft hole 22 of the housing cover 20 into which the rotating shaft 62 is inserted. Furthermore, the housing cover 20 is provided with a drive unit seal 24 that seals a gap between a portion of the housing cover 20 into which the drive unit 30 is inserted and the drive unit 30.

The bearing portion 21 includes, for example, a ball bearing or a rolling bearing, and rotatably supports the rotating shaft 62. The cover seal 23 includes, for example, an O-ring formed of an elastically deformable rubber member. The cover seal 23 ensures sealability between the housing cover 20 and the rotating shaft 62. The drive unit seal 24 includes, for example, an O-ring formed of an elastically deformable rubber member. The drive unit seal 24 ensures sealability between the housing cover 20 and the drive unit 30.

As illustrated in FIGS. 1 to 3, the housing cover 20 includes an engagement receiving portion 25, into which the claw portion 111 provided in the cylinder 11 is fitted, on the first axial-center direction DRa1 side. The housing cover 20 is attached to the cylinder 11 by fitting the claw portion 111 into the engagement receiving portion 25. In other words, the housing cover 20 is fixed to the cylinder 11 by a snap-fit.

The housing cover 20 includes a cover screw receiving portion 26, into which the screw member S is inserted, on the second axial-center direction DRa2 side.

The drive unit 30 is provided on the first axial-center direction DRa1 side of the housing cover 20. The drive unit 30 is fixed to the housing cover 20 by a screw member S that is inserted into the cover screw receiving portion 26 of the housing cover 20.

The drive unit 30 is an actuator for outputting a rotational force for rotating the valve 60. The drive unit 30 includes a motor (not illustrated) serving as a drive source that rotates the valve 60, and a speed reduction mechanism (not illustrated) that transmits the output of the motor to the rotating shaft 62 of the valve 60. As the motor, for example, a servo motor, a stepping motor, or a brushless motor can be employed. As the speed reduction mechanism, for example, a gear mechanism including a helical gear or a spur gear can be employed. Although not illustrated, the motor rotates according to a control signal from a control unit electrically connected to the motor.

The control unit may employ a computer including a memory, which is a non-transitory tangible storage medium, a processor, and the like. The control unit is, for example, a control device that executes a computer program stored in a memory and executes various control processes in accordance with the computer program. The control unit executes the computer program stored in the memory and transmits a control signal for changing the rotational position of the valve 60 to the fluid control valve 1. The operation mode of the fluid control valve 1 is switched based on the control signal transmitted from the control unit.

The valve 60 is a valve member that switches the flow of the fluid to each of the first fluid inlet 42 to the fourth fluid inlet 47 and the first fluid outlet 41 to the fourth fluid outlet 48 by rotating about the axial center CL by the rotational force output from the drive unit 30. As illustrated in FIG. 4, the valve 60 is disposed in the valve accommodation space AS and is rotatably provided at a position not in contact with the inner circumferential surface 16 of the cylinder 11. That is, the valve 60 is disposed such that a predetermined gap is formed between the valve 60 and the cylinder 11. The valve 60 is formed such that the central axis is coaxial with the axial center CL and is also coaxial with the central axis of the cylinder 11.

The valve 60 is formed in a substantially conical shape with the outer diameter decreasing from the first axial-center direction DRa1 toward the second axial-center direction DRa2. That is, the valve 60 is formed in a substantially conical shape with the apex on the second axial-center direction DRa2 side and the bottom on the first axial-center direction DRa1 side. In other words, in the cross-section of the valve 60 orthogonal to the axial center CL, the distance from the axial center CL to the outer shell decreases from the first axial-center direction DRa1 toward the second axial-center direction DRa2. However, the valve 60 is formed flat, with the end portion on the first axial-center direction DRa1 side not being the apex.

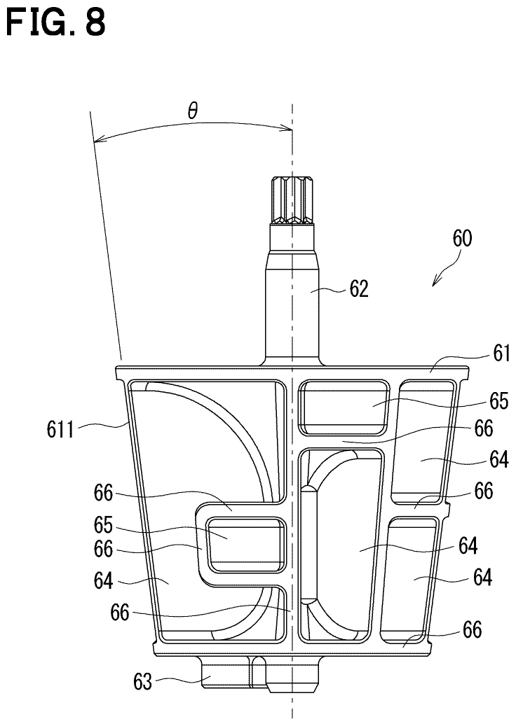

As illustrated in FIGS. 4 and 8, the valve 60 includes a valve outer wall portion 61 forming a substantially conical outer shell, the rotating shaft 62, and the stopper 63. The valve outer wall portion 61, the rotating shaft 62, and the stopper 63 are integrally molded. For example, the valve outer wall portion 61, the rotating shaft 62, and the stopper 63 are formed by molding any of a reinforcement of PA66, a reinforcement of PPA, a reinforcement of PPS, and a reinforcement of phenol (hereinafter referred to as “PF”).

Here, a conical shape having the same axis as the rotating shaft 62 of the valve 60 is defined. As illustrated in FIG. 4, in the valve 60, a valve outer wall portion 61 is formed along the side surface of the defined conical shape. The valve outer wall portion 61 faces the cylinder 11 in the radial direction DRr, and includes an outer circumferential surface 611 facing the inner circumferential surface 16 of the cylinder 11. Here, as illustrated in FIG. 8, the internal angle θ formed by the generatrix of the conical shape parallel to the valve outer wall portion 61 and the rotating shaft 62 (i.e., axial center CL) is set to 5 deg or more. In other words, the internal angle θ formed by the generatrix along the outer circumferential surface 611 and the axial center CL is set to 5 deg or more. In the present embodiment, the internal angle θ is set to 7 deg. The internal angle θ may be set to an angle smaller than 7 deg as long as the internal angle θ is 5 deg or more, or may be set to an angle larger than 7 deg.

The valve outer wall portion 61 has a conical shape along the cylinder 11. That is, portions of the outer circumferential surface 611 of the valve outer wall portion 61 and the inner circumferential surface 16 of the cylinder 11, which face each other, are substantially parallel, and the distance in the radial direction DRr between the outer circumferential surface 611 and the inner circumferential surface 16 is substantially constant. That is, the inner circumferential surface 16 forming the valve accommodation space AS in the cylinder 11 is shaped along the side surface of the conical shape similar to the valve outer wall portion 61. In other words, the cylinder 11 has a conical shape along the valve outer wall portion 61.

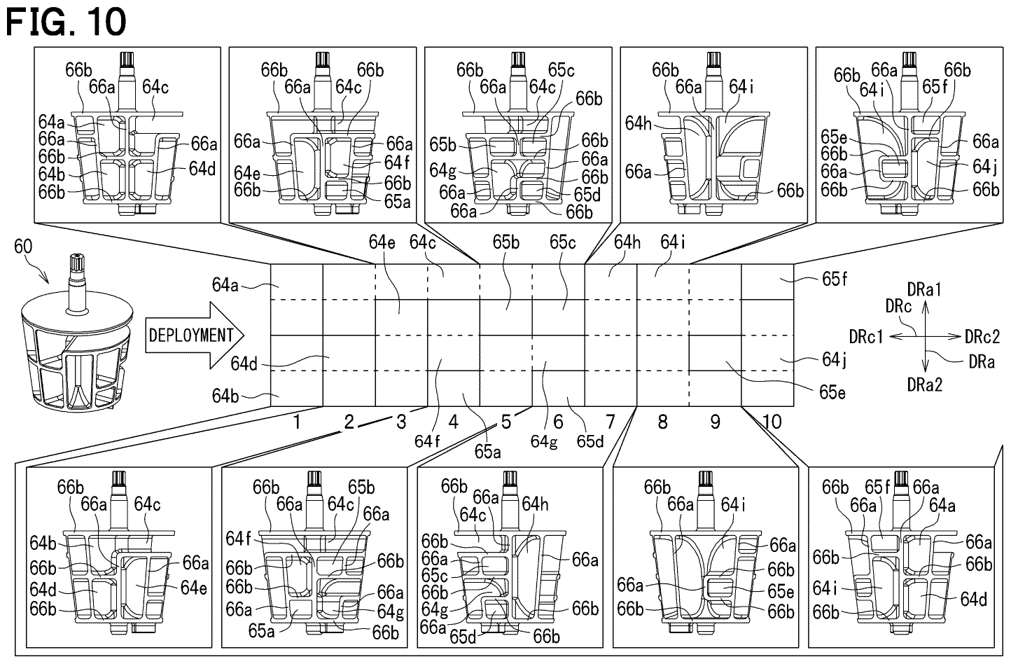

As illustrated in FIG. 8, in the valve outer wall portion 61, a plurality of fluid passages 64 are formed corresponding to the eight opening portions 41, 42, 43, 44, 45, 46, 47, 48, with four opening portions arranged in the axial-center direction DRa and the opening portions arranged in two columns in the circumferential direction DRc. Specifically, as illustrated in FIG. 10, the valve outer wall portion 61 is formed with ten fluid passages 64a, 64b, 64c, 64d, 64e, 64f, 64g, 64h, 64i, 64j through which the fluid flows.

Furthermore, the valve outer wall portion 61 is formed with a plurality of closing portions 65 that prohibit the inflow of the fluid into the valve accommodation space AS. Specifically, six closing portions 65a, 65b, 65c, 65d, 65e, 65f are formed in the valve outer wall portion 61. The ten fluid passages 64a, 64b, 64c, 64d, 64e, 64f, 64g, 64h, 64i, 64j and the six closing portions 65a, 65b, 65c, 65d, 65e, 65f are each formed to face any of the eight opening portions 41 to 48 when the valve 60 rotates. In addition, the valve outer wall portion 61 is formed with a rib 66 that separates the ten fluid passages 64a, 64b, 64c, 64d, 64e, 64f, 64g, 64h, 64i, 64j and the six closing portions 65a, 65b, 65c, 65d, 65e, 65f.

The ten fluid passages 64a, 64b, 64c, 64d, 64e, 64f, 64g, 64h, 64i, 64j switch the inflow and outflow of the fluid to and from the fluid control valve 1 by the rotation of the valve 60, which switches the opening portion that each fluid passage faces among the eight opening portions 41 to 48. In addition, the six closing portions 65a, 65b, 65c, 65d, 65e, 65f prohibit the inflow and outflow of the fluid to and from the facing opening portion by the rotation of the valve 60, which switches the opening portion that each closing portion faces among the eight opening portions 41 to 48. The rib 66 is formed to surround the ten fluid passages 64a, 64b, 64c, 64d, 64e, 64f, 64g, 64h, 64i, 64j and the six closing portions 65a, 65b, 65c, 65d, 65e, 65f.

Hereinafter, the ten fluid passages 64a, 64b, 64c, 64d, 64e, 64f, 64g, 64h, 64i, 64j may be referred to as ten fluid passages 64a to 64j. The ten fluid passages 64a, 64b, 64c, 64d, 64e, 64f, 64g, 64h, 64i, 64j are referred to as a first fluid passage 64a, a second fluid passage 64b, a third fluid passage 64c, a fourth fluid passage 64d, a fifth fluid passage 64e, a sixth fluid passage 64f, a seventh fluid passage 64g, an eighth fluid passage 64h, a ninth fluid passage 64i, and a tenth fluid passage 64j. The first fluid passage 64a, the second fluid passage 64b, the third fluid passage 64c, the fourth fluid passage 64d, the fifth fluid passage 64e, the sixth fluid passage 64f, the seventh fluid passage 64g, the eighth fluid passage 64h, the ninth fluid passage 64i, and the tenth fluid passage 64j may be referred to as the first fluid passage 64a to the tenth fluid passage 64j.

The six closing portions 65a, 65b, 65c, 65d, 65e, 65f may be referred to as six closing portions 65a to 65f. The six closing portions 65a, 65b, 65c, 65d, 65e, 65f are referred to as a first closing portion 65a, a second closing portion 65b, a third closing portion 65c, a fourth closing portion 65d, a fifth closing portion 65e, and a sixth closing portion 65f. The first closing portion 65a, the second closing portion 65b, the third closing portion 65c, the fourth closing portion 65d, the fifth closing portion 65e, and the sixth closing portion 65f may be referred to as the first closing portion 65a to the sixth closing portion 65f. In addition, the side of the valve 60 facing the eight opening portions 41 to 48 is defined as the front side, and the side facing the front side is defined as the back side. In the valve 60, any of the first fluid passage 64a to the tenth fluid passage 64j and any of the first closing portion 65a to the sixth closing portion 65f, positioned on the front side, face the first fluid inlet 42 to the fourth fluid inlet 47 and the first fluid outlet 41 to the fourth fluid outlet 48.

The ten fluid passages 64a to 64j are recessed toward the axial center CL along at least one of the axial-center direction DRa or the circumferential direction DRc. The ten fluid passages 64a to 64j have shapes in which a plurality of substantially trapezoidal shapes, corresponding to the eight opening portions 41 to 48 having opening shapes in a grid pattern, are combined. That is, the opening shape of each of the first fluid passage 64a to the tenth fluid passage 64j is a combination of a plurality of trapezoidal shapes in which the size in the circumferential direction DRc is smaller on the second axial-center direction DRa2 side than on the first axial-center direction DRa1 side. The first fluid passage 64a to the tenth fluid passage 64j are formed in a size capable of straddling two or more of the eight opening portions 41 to 48 when the fluid passages are positioned at positions facing the eight opening portions 41 to 48 by the rotation of the valve 60.

Here, the first fluid passage 64a to the tenth fluid passage 64j are formed so that at least one of the first fluid inlet 42 to the fourth fluid inlet 47 and at least one of the first fluid outlet 41 to the fourth fluid outlet 48 to communicate with each other. Thus, each of the first fluid passage 64a to the tenth fluid passage 64j can guide the fluid flowing in from any communicating fluid inlet of the first fluid inlet 42 to the fourth fluid inlet 47 to any communicating fluid outlet of the first fluid outlet 41 to the fourth fluid outlet 48.

The first closing portion 65a to the sixth closing portion 65f are formed to be able to prohibit the inflow of the fluid from the facing inlet into the valve accommodation space AS when the first closing portion 65a to the sixth closing portion 65f face any one of the first fluid inlet 42 to the fourth fluid inlet 47. Specifically, the first closing portion 65a to the sixth closing portion 65f have opening shapes corresponding to the first fluid inlet 42 to the fourth fluid inlet 47 and are formed to be recessed toward the axial center CL. That is, the first closing portion 65a to the sixth closing portion 65f are recessed in a substantially trapezoidal shape.

When facing any one of the first fluid outlet 41 to the fourth fluid outlet 48, each of the first closing portion 65a to the sixth closing portion 65f is formed to be able to prohibit the outflow of the fluid from the facing outlet. Specifically, the first closing portion 65a to the sixth closing portion 65f have opening shapes corresponding to the first fluid outlet 41 to the fourth fluid outlet 48 and are formed to be recessed toward the axial center CL. That is, the first closing portion 65a to the sixth closing portion 65f are recessed in a substantially trapezoidal shape.

The rib 66 separates the first fluid passage 64a to the tenth fluid passage 64j and the first closing portion 65a to the sixth closing portion 65f. The rib 66 includes an axial-side rib 66a formed extending in the axial-center direction DRa and a circumferential-side rib 66b formed extending in the circumferential direction DRc. The axial-side rib 66a is formed to be able to face the axial-side partition 52 when the valve 60 rotates. The circumferential-side rib 66b is formed to be able to face the circumferential-side partition 51 when the valve 60 rotates. The first fluid passage 64a to the tenth fluid passage 64j and the first closing portion 65a to the sixth closing portion 65f is surrounded by the axial-side rib 66a and the circumferential-side rib 66b. For example, the axial-side rib 66a and the circumferential-side rib 66b surrounding the first closing portion 65a to the sixth closing portion 65f are formed at positions facing the axial-side partition 52 and the circumferential-side partition 51 surrounding any one of the first fluid inlet 42 to the fourth fluid inlet 47.

In the present embodiment, the first fluid passage 64a to the tenth fluid passage 64j and the first closing portion 65a to the sixth closing portion 65f are formed adjacent to each other. The rib 66 that separates the first fluid passage 64a to the tenth fluid passage 64j and the first closing portion 65a to the sixth closing portion 65f, which are adjacent to each other, is formed such that the axial-side rib 66a and the circumferential-side rib 66b, which separate the portions adjacent to each other, are common and integrally formed.

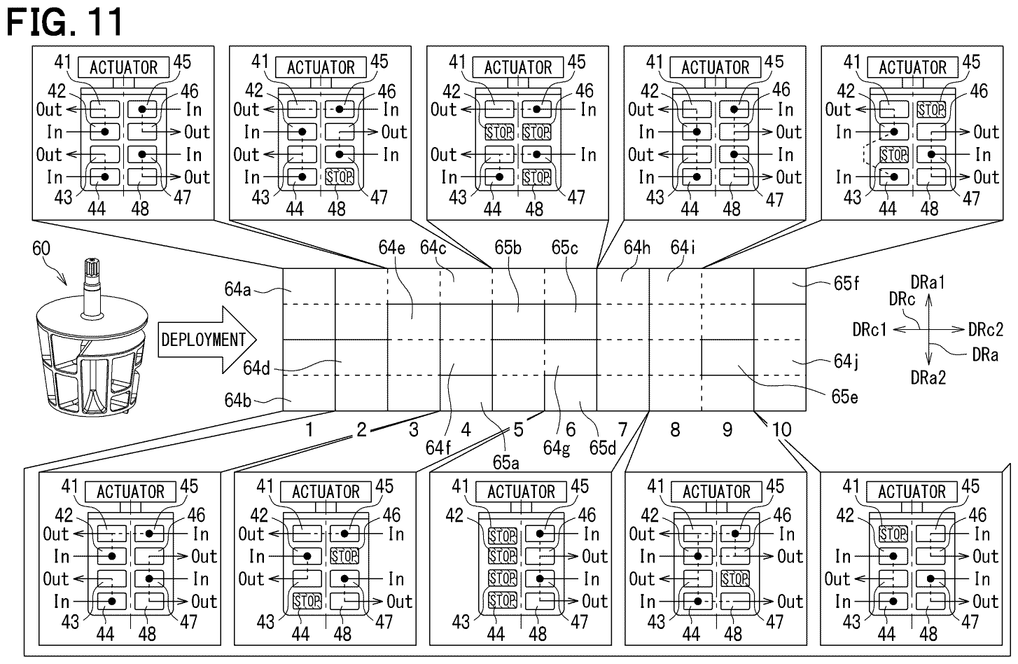

Specific shapes and formation positions of the first fluid passage 64a to the tenth fluid passage 64j and the first closing portion 65a to the sixth closing portion 65f will be described with reference to FIGS. 10 and 11. Each valve 60 in FIGS. 10 and 11 illustrates the front side of the valve 60 when the valve 60 is rotated in the circumferential direction DRc such that the corresponding fluid passages and closing portions facing eight opening portions 41 to 48 can be seen. In FIGS. 10 and 11, the grid masses schematically show portions where the ten fluid passages 64a to 64j and the first closing portion 65a to the sixth closing portion 65f are formed when the valve 60 is developed into a grid pattern in the circumferential direction DRc, and the grid shows the rib 66. In the grid, a solid line indicates a portion where the rib 66 is formed. A dashed line indicates a portion where the rib 66 is not formed.

As illustrated in FIGS. 10 and 11, the first fluid passage 64a to the tenth fluid passage 64j and the first closing portion 65a to the sixth closing portion 65f are formed over the entire axial-center direction DRa of the valve outer wall portion 61 and formed over the entire circumferential direction DRc. The first fluid passage 64a to the tenth fluid passage 64j and the first closing portion 65a to the sixth closing portion 65f are formed in any column when the fluid passage is divided into a plurality of columns in the circumferential direction DRc and in any row when the fluid passage is divided into a plurality of rows in the axial-center direction DRa.

The first fluid passage 64a to the tenth fluid passage 64j are formed as ten cells in the valve outer wall portion 61 when the fluid passage of each column is a one-cell flow path portion. That is, the first fluid passage 64a to the tenth fluid passage 64j are formed in any one or more of ten columns when the valve outer wall portion 61 is divided into ten columns in the circumferential direction DRc. The valve 60 rotates in the circumferential direction DRc such that the first fluid passage 64a to the tenth fluid passage 64j facing the eight opening portions 41 to 48 arranged in two columns in the circumferential direction DRc change every one column.

Here, each area of the valve outer wall portion 61, formed by dividing the valve outer wall portion 61 into four parts in the axial-center direction DRa and dividing the valve outer wall portion 61 into ten parts in the circumferential direction DRc, is defined as one section. One section corresponds to each of the eight opening portions 41 to 48, and in FIGS. 10 and 11, the size of each section is illustrated in the same shape for clarity.

The sections obtained when the valve outer wall portion 61 is divided into four parts in the axial-center direction DRa are defined as a first row section, a second row section, a third row section, and a fourth row section, from the first axial-center direction DRa1 side toward the second axial-center direction DRa2 side. The sections obtained when the valve outer wall portion 61 is divided into ten parts in the circumferential direction DRc are defined as a first-column section, a second-column section, a third-column section, a fourth-column section, a fifth-column section, a sixth-column section, a seventh-column section, an eighth-column section, a ninth-column section, and a tenth-column section, from the first axial-center direction DRa1 side toward the second axial-center direction DRa2 side. The column corresponds to the cell described above.

The first fluid passage 64a to the tenth fluid passage 64j, when defined in this manner, have shapes formed by combining a plurality of sections, each positioned in any of the first to fourth rows and any of the first to ten columns. The first fluid passage 64a to the tenth fluid passage 64j are each formed at positions facing any of the first fluid inlet 42 to the fourth fluid inlet 47 and capable of facing any of the first fluid outlet 41 to the fourth fluid outlet 48. The first closing portion 65a to the sixth closing portion 65f correspond to one section positioned in any of the first to fourth rows and any of the first to ten columns. The first closing portion 65a to the sixth closing portion 65f are each formed at a position capable of facing any of the first fluid inlet 42 to the fourth fluid inlet 47 or any of the first fluid outlet 41 to the fourth fluid outlet 48. Hereinafter, the shapes and positions of the first fluid passage 64a to the tenth fluid passage 64j and the first closing portion 65a to the sixth closing portion 65f will be described using sections.

The first fluid passage 64a has a shape formed by combining the section in the first row and the first column with the section in the second row and the first column. In the first fluid passage 64a, the axial-side rib 66a separates the first circumferential direction DRc1 side and the second circumferential direction DRc2 side, and the circumferential-side rib 66b separates the first axial-center direction DRa1 side and the second axial-center direction DRa2 side. The first fluid passage 64a has a shape in which the circumferential-side rib 66b is not formed between the section in the first row and the first row and the section in the second row and the first column.

The first fluid passage 64a thus configured can straddle two opening portions in the axial-center direction DRa. Here, it is assumed that the valve 60 rotates in the circumferential direction DRc, positioning the first fluid passage 64a at a position facing the eight opening portions 41 to 48. The first fluid passage 64a can face the first-row opening portion and the second-row opening portion. The first fluid passage 64a enables the first fluid inlet 42 and the first fluid outlet 41, adjacent to each other in the axial-center direction DRa, to communicate. The first fluid passage 64a enables the third fluid inlet 45 and the third fluid outlet 46, adjacent to each other in the axial-center direction DRa, to communicate.

In this case, between the first fluid inlet 42 and the first fluid outlet 41 adjacent to each other, the first fluid inlet 42 corresponds to a first adjacent inlets, and the first fluid outlet 41 corresponds to a first adjacent outlet. Between the third fluid inlet 45 and the third fluid outlet 46 adjacent to each other, the third fluid inlet 45 corresponds to the first adjacent inlets, and the third fluid outlet 46 corresponds to the first adjacent outlet.

It is assumed that the valve 60 rotates in the circumferential direction DRc, positioning the first fluid passage 64a at a position where the first fluid inlet 42 and the first fluid outlet 41 communicate. At this time, the axial-side rib 66a and the circumferential-side rib 66b, which separate the first fluid passage 64a, face the partition 50 that separates the first fluid inlet 42 and the first fluid outlet 41 from other fluid inlets and fluid outlets. The circumferential-side rib 66b is not formed at a position facing the circumferential-side partition 51 that separates the first fluid inlet 42 and the first fluid outlet 41.

The second fluid passage 64b has a shape formed by combining the section in the third row and the first column with the section in the fourth row and the first column. In the second fluid passage 64b, the axial-side rib 66a separates the first circumferential direction DRc1 side and the second circumferential direction DRc2 side, and the circumferential-side rib 66b separates the first axial-center direction DRa1 side and the second axial-center direction DRa2 side. The second fluid passage 64b has a shape in which the circumferential-side rib 66b is not formed between the section in the third row and the first row and the section in the fourth row and the first column.

The second fluid passage 64b thus configured can straddle two opening portions in the axial-center direction DRa. Here, it is assumed that the valve 60 rotates in the circumferential direction DRc, positioning the second fluid passage 64b at a position facing the eight opening portions 41 to 48. The second fluid passage 64b can face the third-row opening portion and the fourth-row opening portion. The second fluid passage 64b enables the second fluid inlet 44 and the second fluid outlet 43, adjacent to each other in the axial-center direction DRa, to communicate. The second fluid passage 64b enables the fourth fluid inlet 47 and the fourth fluid outlet 48, adjacent to each other in the axial-center direction DRa, to communicate.

In this case, between the second fluid inlet 44 and the second fluid outlet 43 adjacent to each other, the second fluid inlet 44 corresponds to the first adjacent inlets, and the second fluid outlet 43 corresponds to the first adjacent outlet. Between the fourth fluid inlet 47 and the fourth fluid outlet 48 adjacent to each other, the fourth fluid inlet 47 corresponds to the first adjacent inlets, and the fourth fluid outlet 48 corresponds to the first adjacent outlet.

It is assumed that the valve 60 rotates in the circumferential direction DRc, positioning the second fluid passage 64b at a position where the second fluid inlet 44 and the second fluid outlet 43 communicate. At this time, the axial-side rib 66a and the circumferential-side rib 66b, which separate the second fluid passage 64b, face the partition 50 that separates the second fluid inlet 44 and the second fluid outlet 43 from other fluid inlets and fluid outlets. The circumferential-side rib 66b is not formed at a position facing the circumferential-side partition 51 that separates the second fluid inlet 44 and the second fluid outlet 43.

The third fluid passage 64c has a shape formed by combining the sections in the first row and the second to sixth columns with the section in the second row and the second column. In the third fluid passage 64c, the axial-side rib 66a separates the first circumferential direction DRc1 side and the second circumferential direction DRc2 side, and the circumferential-side rib 66b separates the first axial-center direction DRa1 side and the second axial-center direction DRa2 side. The third fluid passage 64c has a shape in which the circumferential-side rib 66b is not formed between the section in the first row and the second row and the section in the second row and the second column, and the axial-side rib 66a is not formed between each of the sections in the first row and the second to sixth columns.

The third fluid passage 64c thus configured can straddle two opening portions in the axial-center direction DRa and can straddle two opening portions in the circumferential direction DRc. The third fluid passage 64c can straddle three opening portions adjacent to each other in either the axial-center direction DRa or the circumferential direction DRc. Here, it is assumed that the valve 60 rotates in the circumferential direction DRc, positioning the third fluid passage 64c at a position facing the eight opening portions 41 to 48. The third fluid passage 64c can face the first-row opening portion and the second-row opening portion. The third fluid passage 64c enables the first fluid inlet 42 and the first fluid outlet 41, adjacent to each other in the axial-center direction DRa, to communicate. The third fluid passage 64c enables the third fluid inlet 45 and the third fluid outlet 46, adjacent to each other in the axial-center direction DRa, to communicate. Furthermore, the third fluid passage 64c enables the third fluid inlet 45 and the first fluid outlet 41, adjacent to each other in the circumferential direction DRc, to communicate. The third fluid passage 64c enables the first fluid inlet 42, the first fluid outlet 41, and the third fluid inlet 45, adjacent to each other in either the axial-center direction DRa or the circumferential direction DRc, to communicate.

In this case, between the first fluid inlet 42 and the first fluid outlet 41 adjacent to each other, the first fluid inlet 42 corresponds to a first adjacent inlets, and the first fluid outlet 41 corresponds to a first adjacent outlet. Between the third fluid inlet 45 and the third fluid outlet 46 adjacent to each other, the third fluid inlet 45 corresponds to the first adjacent inlets, and the third fluid outlet 46 corresponds to the first adjacent outlet. Furthermore, between the third fluid inlet 45 and the first fluid outlet 41 adjacent to each other, the third fluid inlet 45 corresponds to the first adjacent inlets, and the first fluid outlet 41 corresponds to the first adjacent outlet.

It is assumed that the valve 60 rotates in the circumferential direction DRc, positioning the third fluid passage 64c at a position where the first fluid inlet 42 and the first fluid outlet 41 communicate. At this time, the axial-side rib 66a and the circumferential-side rib 66b, which separate the third fluid passage 64c, face the partition 50 that separates the first fluid inlet 42, the first fluid outlet 41, and the third fluid inlet 45 from other fluid inlets and fluid outlets. The circumferential-side rib 66b is not formed at a position facing the circumferential-side partition 51 that separates the first fluid inlet 42 and the first fluid outlet 41.

It is assumed that the valve 60 rotates in the circumferential direction DRc, positioning the third fluid passage 64c at a position where the third fluid inlet 45 and the first fluid outlet 41 communicate. At this time, the axial-side rib 66a is not formed at a position facing the axial-side partition 52 that separates between the third fluid inlet 45 and the first fluid outlet 41.

The fourth fluid passage 64d has a shape formed by combining the section in the third row and the second column with the section in the fourth row and the second column. In the fourth fluid passage 64d, the axial-side rib 66a separates the first circumferential direction DRc1 side and the second circumferential direction DRc2 side, and the circumferential-side rib 66b separates the first axial-center direction DRa1 side and the second axial-center direction DRa2 side. The fourth fluid passage 64d has a shape in which the circumferential-side rib 66b is not formed between the section in the third row and the second row and the section in the fourth row and the second column.

The fourth fluid passage 64d thus configured can straddle two opening portions in the axial-center direction DRa. Here, it is assumed that the valve 60 rotates in the circumferential direction DRc, positioning the fourth fluid passage 64d at a position facing the eight opening portions 41 to 48. The fourth fluid passage 64d can face the third-row opening portion and the fourth-row opening portion. The fourth fluid passage 64d enables the second fluid inlet 44 and the second fluid outlet 43, adjacent to each other in the axial-center direction DRa, to communicate. The fourth fluid passage 64d enables the fourth fluid inlet 47 and the fourth fluid outlet 48, adjacent to each other in the axial-center direction DRa, to communicate.

In this case, between the second fluid inlet 44 and the second fluid outlet 43 adjacent to each other, the second fluid inlet 44 corresponds to the first adjacent inlets, and the second fluid outlet 43 corresponds to the first adjacent outlet. Between the fourth fluid inlet 47 and the fourth fluid outlet 48 adjacent to each other, the fourth fluid inlet 47 corresponds to the first adjacent inlets, and the fourth fluid outlet 48 corresponds to the first adjacent outlet.

It is assumed that the valve 60 rotates in the circumferential direction DRc, positioning the fourth fluid passage 64d at a position where the second fluid inlet 44 and the second fluid outlet 43 communicate. At this time, the axial-side rib 66a and the circumferential-side rib 66b, which separate the fourth fluid passage 64d, face the partition 50 that separates the second fluid inlet 44 and the second fluid outlet 43 from other fluid inlets and fluid outlets. The circumferential-side rib 66b is not formed at a position facing the circumferential-side partition 51 that separates the second fluid inlet 44 and the second fluid outlet 43.

The fifth fluid passage 64e has a shape formed by combining the sections in the second to fourth rows and the third column. In the fifth fluid passage 64e, the axial-side rib 66a separates the first circumferential direction DRc1 side and the second circumferential direction DRc2 side, and the circumferential-side rib 66b separates the first axial-center direction DRa1 side and the second axial-center direction DRa2 side. The fifth fluid passage 64e has a shape in which the circumferential-side rib 66b is not formed between each of the sections in the second to fourth rows and the third column.

The fifth fluid passage 64e thus configured can straddle three opening portions in the axial-center direction DRa. Here, it is assumed that the valve 60 rotates in the circumferential direction DRc, positioning the fifth fluid passage 64e at a position facing the eight opening portions 41 to 48. The fifth fluid passage 64e can face the second-row opening portion to the fourth-row opening portion. The fifth fluid passage 64e enables the first fluid inlet 42, the second fluid inlet 44, and the second fluid outlet 43, adjacent to each other in the axial-center direction DRa, to communicate. The fifth fluid passage 64e enables the third fluid outlet 46, the fourth fluid inlet 47, and the fourth fluid outlet 48, adjacent to each other in the axial-center direction DRa, to communicate.

In this case, among the first fluid inlet 42, the second fluid inlet 44, and the second fluid outlet 43 adjacent to each other, the first fluid inlet 42 and the second fluid inlet 44 correspond to the third adjacent inlets, and the second fluid outlet 43 corresponds to the third adjacent outlet. Among the third fluid outlet 46, the fourth fluid inlet 47, and the fourth fluid outlet 48 adjacent to each other, the third fluid inlet 45 corresponds to a second adjacent inlet, and the fourth fluid inlet 47 and the fourth fluid outlet 48 correspond to second adjacent outlets.

It is assumed that the valve 60 rotates in the circumferential direction DRc, positioning the fifth fluid passage 64e at a position where the first fluid inlet 42, the second fluid inlet 44, and the second fluid outlet 43 communicate. The axial-side rib 66a and the circumferential-side rib 66b, which separate the fifth fluid passage 64e, face the partition 50 that separates the first fluid inlet 42, the second fluid inlet 44, and the second fluid outlet 43 from other fluid inlets and fluid outlets. The circumferential-side rib 66b is not formed at a position facing the circumferential-side partition 51 that separates the first fluid inlet 42, the second fluid inlet 44, and the second fluid outlet 43.

The sixth fluid passage 64f has a shape formed by combining the section in the second row and the fourth column with the section in the third row and the fourth column. In the sixth fluid passage 64f, the axial-side rib 66a separates the first circumferential direction DRc1 side and the second circumferential direction DRc2 side, and the circumferential-side rib 66b separates the first axial-center direction DRa1 side and the second axial-center direction DRa2 side. The sixth fluid passage 64f has a shape in which the circumferential-side rib 66b is not formed between the section in the second row and the fourth row and the section in the third row and the fourth column.

The sixth fluid passage 64f thus configured can straddle two opening portions in the axial-center direction DRa. Here, it is assumed that the valve 60 rotates in the circumferential direction DRc, positioning the sixth fluid passage 64f at a position facing the eight opening portions 41 to 48. The sixth fluid passage 64f can face the second-row opening portion and the third-row opening portion. The sixth fluid passage 64f enables the first fluid inlet 42 and the second fluid outlet 43, adjacent to each other in the axial-center direction DRa, to communicate. The sixth fluid passage 64f enables the fourth fluid inlet 47 and the third fluid outlet 46, adjacent to each other in the axial-center direction DRa, to communicate.

In this case, between the first fluid inlet 42 and the second fluid outlet 43 adjacent to each other, the first fluid inlet 42 corresponds to the first adjacent inlets, and the second fluid outlet 43 corresponds to the first adjacent outlet. Between the fourth fluid inlet 47 and the third fluid outlet 46 adjacent to each other, the fourth fluid inlet 47 corresponds to the first adjacent inlets, and the third fluid outlet 46 corresponds to the first adjacent outlet.

It is assumed that the valve 60 rotates in the circumferential direction DRc, positioning the sixth fluid passage 64f at a position where the first fluid inlet 42 and the second fluid outlet 43 communicate. At this time, the axial-side rib 66a and the circumferential-side rib 66b, which separate the sixth fluid passage 64f, face the partition 50 that separates the first fluid inlet 42 and the second fluid outlet 43 from other fluid inlets and fluid outlets. The circumferential-side rib 66b is not formed at a position facing the circumferential-side partition 51 that separates the first fluid inlet 42 and the second fluid outlet 43.

The seventh fluid passage 64g has a shape formed by combining the section in the third row and the fifth column, the section in the fourth row and the fifth column, and the section in the third row and the sixth column. In the seventh fluid passage 64g, the axial-side rib 66a separates the first circumferential direction DRc1 side and the second circumferential direction DRc2 side, and the circumferential-side rib 66b separates the first axial-center direction DRa1 side and the second axial-center direction DRa2 side. The seventh fluid passage 64g has a shape in which the circumferential-side rib 66b is not formed between the section in the third row and the fifth row and the section in the fourth row and the fifth column, and the axial-side rib 66a is not formed between the section in the third row and the fifth row and the section in the third row and the sixth column.

The seventh fluid passage 64g thus configured can straddle two opening portions in the axial-center direction DRa and can straddle two opening portions in the circumferential direction DRc. The seventh fluid passage 64g can straddle three opening portions adjacent to each other in either the axial-center direction DRa or the circumferential direction DRc. Here, it is assumed that the valve 60 rotates in the circumferential direction DRc, positioning the seventh fluid passage 64g at a position facing the eight opening portions 41 to 48. The seventh fluid passage 64g can face the third-row opening portion and the fourth-row opening portion. The seventh fluid passage 64g enables the fourth fluid inlet 47 and the fourth fluid outlet 48, adjacent to each other in the axial-center direction DRa, to communicate. The seventh fluid passage 64g enables the second fluid inlet 44, the second fluid outlet 43, and the fourth fluid inlet 47, adjacent to each other in either the axial-center direction DRa or the circumferential direction DRc, to communicate.

In this case, among the fourth fluid inlet 47 and the fourth fluid outlet 48 adjacent to each other, the fourth fluid inlet 47 corresponds to the first adjacent inlets, and the fourth fluid outlet 48 corresponds to the first adjacent outlet. Among the second fluid inlet 44, the second fluid outlet 43, and the fourth fluid inlet 47 adjacent to each other, the second fluid inlet 44 and the fourth fluid inlet 47 correspond to the third adjacent inlets, and the second fluid outlet 43 corresponds to the third adjacent outlet.

It is assumed that the valve 60 rotates in the circumferential direction DRc, positioning the seventh fluid passage 64g at a position where the second fluid inlet 44, the second fluid outlet 43, and the fourth fluid inlet 47 communicate. At this time, the axial-side rib 66a and the circumferential-side rib 66b, which separate the seventh fluid passage 64g, face the partition 50 that separates the second fluid inlet 44, the second fluid outlet 43, and the fourth fluid inlet 47 from other fluid inlets and fluid outlets. The circumferential-side rib 66b is not formed at a position facing the circumferential-side partition 51 that separates the second fluid inlet 44 and the second fluid outlet 43.

It is assumed that the valve 60 rotates in the circumferential direction DRc, positioning the seventh fluid passage 64g at a position where the second fluid inlet 44, the second fluid outlet 43, and the fourth fluid inlet 47 communicate. At this time, the axial-side rib 66a is not formed at a position facing the axial-side partition 52 that separates between the second fluid outlet 43 and the fourth fluid inlet 47.

The eighth fluid passage 64h has a shape formed by combining the sections in the first to fourth rows and the seventh column. In the eighth fluid passage 64h, the axial-side rib 66a separates the first circumferential direction DRc1 side and the second circumferential direction DRc2 side, and the circumferential-side rib 66b separates the first axial-center direction DRa1 side and the second axial-center direction DRa2 side. The eighth fluid passage 64h has a shape in which the circumferential-side rib 66b is not formed between each of the sections in the first to fourth rows and the seventh column.

The eighth fluid passage 64h thus configured can straddle four opening portions in the axial-center direction DRa. Here, it is assumed that the valve 60 rotates in the circumferential direction DRc, positioning the eighth fluid passage 64h at a position facing the eight opening portions 41 to 48. The eighth fluid passage 64h can face the first-row opening portion to the fourth-row opening portion. The eighth fluid passage 64h enables the first fluid inlet 42, the second fluid inlet 44, the second fluid outlet 43, and the second fluid inlet 44, adjacent to each other in the axial-center direction DRa, to communicate. The eighth fluid passage 64h enables the third fluid inlet 45, the third fluid outlet 46, the fourth fluid inlet 47, and the fourth fluid outlet 48, adjacent to each other in the axial-center direction DRa, to communicate.

In this case, among the first fluid outlet 41, the first fluid inlet 42, the second fluid outlet 43, and the second fluid inlet 44 adjacent to each other, the first fluid inlet 42 and the second fluid inlet 44 correspond to fourth adjacent inlets, and the first fluid outlet 41 and the second fluid outlet 43 correspond to fourth adjacent outlets. Among the third fluid inlet 45, the fourth fluid inlet 47, the third fluid outlet 46, and the fourth fluid inlet 47 adjacent to each other, the third fluid inlet 45 and the fourth fluid inlet 47 correspond to the fourth adjacent inlets, and the third fluid outlet 46 and the fourth fluid outlet 48 correspond to the fourth adjacent outlets.

It is assumed that the valve 60 rotates in the circumferential direction DRc, positioning the eighth fluid passage 64h at a position where the first fluid inlet 42, the second fluid inlet 44, the second fluid outlet 43, and the second fluid inlet 44 communicate. At this time, the axial-side rib 66a and the circumferential-side rib 66b, which separate the eighth fluid passage 64h, face the partition 50 that separates the first fluid inlet 42, the second fluid inlet 44, the second fluid outlet 43, and the second fluid inlet 44 from other fluid inlets and fluid outlets. The circumferential-side rib 66b is not formed at a position facing the circumferential-side partition 51 that separates the first fluid inlet 42, the second fluid inlet 44, the second fluid outlet 43, and the second fluid inlet 44.

The ninth fluid passage 64i has a shape formed by combining the sections in the first to fourth rows and the eighth column, the section in the first row and the ninth column, the section in the second row and the ninth column, and the section in the fourth row and the ninth column. In the ninth fluid passage 64i, the axial-side rib 66a separates the first circumferential direction DRc1 side and the second circumferential direction DRc2 side, and the circumferential-side rib 66b separates the first axial-center direction DRa1 side and the second axial-center direction DRa2 side. The ninth fluid passage 64i has a shape in which the circumferential-side rib 66b is not formed between each of the sections in the first to fourth rows and the eighth column, and the circumferential-side rib 66b is not formed between the section in the first row and the ninth row and the section in the second row and the ninth column. The ninth fluid passage 64i has a shape in which the axial-side rib 66a is not formed between the section in the first row and the eighth row and the section in the first row and the ninth column, and between the section in the second row and the eighth row and the section in the second row and the ninth column. Furthermore, the ninth fluid passage 64i has a shape in which the axial-side rib 66a is not formed between the section in the fourth row and the eighth row and the section in the fourth row and the ninth column.

The ninth fluid passage 64i thus configured can straddle two and four opening portions in the axial-center direction DRa and can straddle two opening portions in the circumferential direction DRc. The ninth fluid passage 64i can straddle seven opening portions adjacent to each other in either the axial-center direction DRa or the circumferential direction DRc.

Here, it is assumed that the valve 60 rotates in the circumferential direction DRc, positioning the ninth fluid passage 64i at a position facing the eight opening portions 41 to 48. The ninth fluid passage 64i can face the first-row opening portion and the second-row opening portion, or can face the first-row opening portion to the fourth-row opening portion. The ninth fluid passage 64i enables the first fluid inlet 42 and the first fluid outlet 41, adjacent to each other in the axial-center direction DRa, to communicate. The ninth fluid passage 64i enables the first fluid inlet 42, the first fluid outlet 41, the second fluid inlet 44, the second fluid outlet 43, the third fluid inlet 45, the third fluid outlet 46, and the fourth fluid outlet 48, adjacent to each other in either the axial-center direction DRa or the circumferential direction DRc, to communicate.

In this case, between the first fluid outlet 41 and the first fluid inlet 42 adjacent to each other, the first fluid inlet 42 corresponds to the first adjacent inlets, and the first fluid outlet 41 corresponds to the first adjacent outlet. Among the first fluid inlet 42, the first fluid outlet 41, the second fluid inlet 44, the second fluid outlet 43, the third fluid inlet 45, the third fluid outlet 46, and the fourth fluid outlet 48 adjacent to each other, the first fluid inlet 42, the second fluid inlet 44, and the third fluid inlet 45 correspond to the fourth adjacent inlets, and the first fluid outlet 41, the second fluid outlet 43, the third fluid outlet 46, and the fourth fluid outlet 48 correspond to the fourth adjacent outlets.

It is assumed that the valve 60 rotates in the circumferential direction DRc, positioning ninth fluid passage 64i at a position where the first fluid inlet 42, the first fluid outlet 41, the second fluid inlet 44, the second fluid outlet 43, the third fluid inlet 45, the third fluid outlet 46, and the fourth fluid outlet 48 communicate. At this time, the axial-side rib 66a and the circumferential-side rib 66b, which separate the ninth fluid passage 64i, face the partition 50 that separates the first fluid inlet 42, the first fluid outlet 41, the second fluid inlet 44, the second fluid outlet 43, the third fluid inlet 45, the third fluid outlet 46, and the fourth fluid outlet 48, from the fourth fluid inlet 47 that is different from these.

The circumferential-side rib 66b is not formed at a position facing the circumferential-side partition 51 that separates the first fluid inlet 42, the first fluid outlet 41, the second fluid inlet 44, and the second fluid outlet 43. The circumferential-side rib 66b is not formed at a position facing the circumferential-side partition 51 that separates the third fluid inlet 45 and the third fluid outlet 46.

Furthermore, the axial-side rib 66a is not formed at each of a position facing the axial-side partition 52 that separates the first fluid outlet 41 and the third fluid inlet 45 and a position facing the axial-side partition 52 that separates the first fluid inlet 42 and the third fluid outlet 46. The axial-side rib 66a is not formed at a position facing the axial-side partition 52 that separates the second fluid inlet 44 and the fourth fluid outlet 48.

It is assumed that the valve 60 rotates in the circumferential direction DRc, positioning the ninth fluid passage 64i at a position where the first fluid inlet 42 and the first fluid outlet 41 communicate with each other. At this time, in the axial-side partition 52 that separates the first fluid inlet 42, the axial-side rib 66a is not formed at a position facing the axial-side partition 52 on the side where the third fluid outlet 46 does not exist in the circumferential direction DRc, that is, first circumferential direction DRc1 side. In the axial-side partition 52 that separates the second fluid inlet 44, the axial-side rib 66a is not formed at a position facing the axial-side partition 52 on the side where the fourth fluid outlet 48 does not exist in the circumferential direction DRc, that is, first circumferential direction DRc1 side. Furthermore, in the axial-side partition 52 that separates the first fluid outlet 41, the axial-side rib 66a is not formed at a position facing the axial-side partition 52 on the side where the third fluid inlet 45 does not exist in the circumferential direction DRc, that is, first circumferential direction DRc1 side.

The tenth fluid passage 64j has a shape formed by combining the sections in the second to fourth rows and the tenth column. In the tenth fluid passage 64j, the axial-side rib 66a separates the first circumferential direction DRc1 side and the second circumferential direction DRc2 side, and the circumferential-side rib 66b separates the first axial-center direction DRa1 side and the second axial-center direction DRa2 side. The tenth fluid passage 64j has a shape in which the circumferential-side rib 66b is not formed between each of the sections in the second to fourth rows and the tenth column.

The tenth fluid passage 64j thus configured can straddle three opening portions in the axial-center direction DRa. Here, it is assumed that the valve 60 rotates in the circumferential direction DRc, positioning the tenth fluid passage 64j at a position facing the eight opening portions 41 to 48. The tenth fluid passage 64j can face the second-row opening portion to the fourth-row opening portion. The tenth fluid passage 64j enables the first fluid inlet 42, the second fluid inlet 44, and the second fluid outlet 43, adjacent to each other in the axial-center direction DRa, to communicate. The tenth fluid passage 64j enables the third fluid outlet 46, the fourth fluid inlet 47, and the fourth fluid outlet 48, adjacent to each other in the axial-center direction DRa, to communicate.

In this case, among the first fluid inlet 42, the second fluid inlet 44, and the second fluid outlet 43 adjacent to each other, the first fluid inlet 42 and the second fluid inlet 44 correspond to the third adjacent inlets, and the second fluid outlet 43 corresponds to the third adjacent outlet. Among the third fluid outlet 46, the fourth fluid inlet 47, and the fourth fluid outlet 48 adjacent to each other, the third fluid inlet 45 corresponds to a second adjacent inlet, and the fourth fluid inlet 47 and the fourth fluid outlet 48 correspond to second adjacent outlets.

It is assumed that the valve 60 rotates in the circumferential direction DRc, positioning the tenth fluid passage 64j at a position where the first fluid inlet 42, the second fluid inlet 44, and the second fluid outlet 43 communicate. At this time, the axial-side rib 66a and the circumferential-side rib 66b, which separate the tenth fluid passage 64j, face the partition 50 that separates the first fluid inlet 42, the second fluid inlet 44, and the second fluid outlet 43 from other fluid inlets and fluid outlets. The circumferential-side rib 66b is not formed at a position facing the circumferential-side partition 51 that separates the first fluid inlet 42, the second fluid inlet 44, and the second fluid outlet 43.

The first closing portion 65a is formed in the section in the fourth row and the fourth row. The first closing portion 65a is surrounded by the axial-side rib 66a and the circumferential-side rib 66b. The first closing portion 65a thus configured can face the fourth-row opening portion when positioned at a position facing the eight opening portions 41 to 48 by the rotation of the valve 60 in the circumferential direction DRc. When positioned at a position facing the second fluid inlet 44, the first closing portion 65a closes the second fluid inlet 44, thereby prohibiting the inflow of the fluid into the second fluid inlet 44. When positioned at a position facing the fourth fluid outlet 48, the first closing portion 65a closes the fourth fluid outlet 48, thereby prohibiting the outflow of the fluid from the fourth fluid outlet 48.

The second closing portion 65b is formed in the section in the second row and the fifth column. The second closing portion 65b is surrounded by the axial-side rib 66a and the circumferential-side rib 66b. The second closing portion 65b thus configured can face the second-row opening portion when positioned at a position facing the eight opening portions 41 to 48 by the rotation of the valve 60 in the circumferential direction DRc. When positioned at a position facing the first fluid inlet 42, the second closing portion 65b closes the first fluid inlet 42, thereby prohibiting the inflow of the fluid into the first fluid inlet 42. When positioned at a position facing the third fluid outlet 46, the second closing portion 65b closes the third fluid outlet 46, thereby prohibiting the outflow of the fluid from the third fluid outlet 46.

The third closing portion 65c is formed in the section in the second row and the sixth column. The third closing portion 65c is surrounded by the axial-side rib 66a and the circumferential-side rib 66b. The third closing portion 65c thus configured can face the second-row opening portion when positioned at a position facing the eight opening portions 41 to 48 by the rotation of the valve 60 in the circumferential direction DRc. When positioned at a position facing the first fluid inlet 42, the third closing portion 65c closes the first fluid inlet 42, thereby prohibiting the inflow of the fluid into the first fluid inlet 42. When positioned at a position facing the third fluid outlet 46, the third closing portion 65c closes the third fluid outlet 46, thereby prohibiting the outflow of the fluid from the third fluid outlet 46.

The fourth closing portion 65d is formed in the section in the fourth row and the sixth column. The fourth closing portion 65d is surrounded by the axial-side rib 66a and the circumferential-side rib 66b. The fourth closing portion 65d thus configured can face the fourth-row opening portion when positioned at a position facing the eight opening portions 41 to 48 by the rotation of the valve 60 in the circumferential direction DRc. When positioned at a position facing the second fluid inlet 44, the fourth closing portion 65d closes the second fluid inlet 44, thereby prohibiting the inflow of the fluid into the second fluid inlet 44. In addition, when positioned at a position facing the fourth fluid outlet 48, the fourth closing portion 65d closes the fourth fluid outlet 48, thereby prohibiting the outflow of the fluid from the fourth fluid outlet 48.

The fifth closing portion 65e is formed in the section in the third row and the ninth column. The fifth closing portion 65e is surrounded by the axial-side rib 66a and the circumferential-side rib 66b. The fifth closing portion 65e thus configured can face the third-row opening portion when positioned at a position facing the eight opening portions 41 to 48 by the rotation of the valve 60 in the circumferential direction DRc. When positioned at a position facing the fourth fluid inlet 47, the fifth closing portion 65e closes the fourth fluid inlet 47, thereby prohibiting the inflow of the fluid into the fourth fluid inlet 47. In addition, when positioned at a position facing the second fluid outlet 43, the fifth closing portion 65e closes the second fluid outlet 43, thereby prohibiting the outflow of the fluid from the second fluid outlet 43.

The sixth closing portion 65f is formed in the section in the first row and the tenth column. The sixth closing portion 65f is surrounded by the axial-side rib 66a and the circumferential-side rib 66b. The sixth closing portion 65f thus configured can face the first-row opening portion when positioned at a position facing the eight opening portions 41 to 48 by the rotation of the valve 60 in the circumferential direction DRc. When positioned at a position facing the third fluid inlet 45, the sixth closing portion 65f closes the third fluid inlet 45, thereby prohibiting the inflow of the fluid into the third fluid inlet 45. In addition, when positioned at a position facing the first fluid outlet 41, the sixth closing portion 65f closes the first fluid outlet 41, thereby prohibiting the outflow of the fluid from the first fluid outlet 41.

The valve 60 includes the rotating shaft 62 protruding from each of the first axial-center direction DRa1 side and the second axial-center direction DRa2 side. In the rotating shaft 62, a portion protruding toward the first axial-center direction DRa1 side is rotatably supported by the bearing portion 21, and a portion protruding toward the second axial-center direction DRa2 is rotatable by a support hole 121 formed in the bottom 12. The end portion of the rotating shaft 62 on the first axial-center direction DRa1 side penetrates the housing cover 20 and is connected to the speed reduction mechanism of the drive unit 30.

Furthermore, the valve 60 is provided with the stopper 63 on the surface of the valve 60 on the second axial-center direction DRa2 side, which is a portion different from the portion facing the housing cover 20. The stopper 63 is formed extending in the axial-center direction DRa toward the second axial-center direction DRa2 at a position away from the rotating shaft 62 in the radial direction DRr. The stopper 63 is formed at a position facing the rotation regulating portion 122 in the circumferential direction DRc, and can come into contact with the rotation regulating portion 122 when the valve 60 rotates in the circumferential direction DRc. The seal member 70 is provided between the valve outer wall portion 61 of the valve 60 and the cylinder 11 of the housing 10.

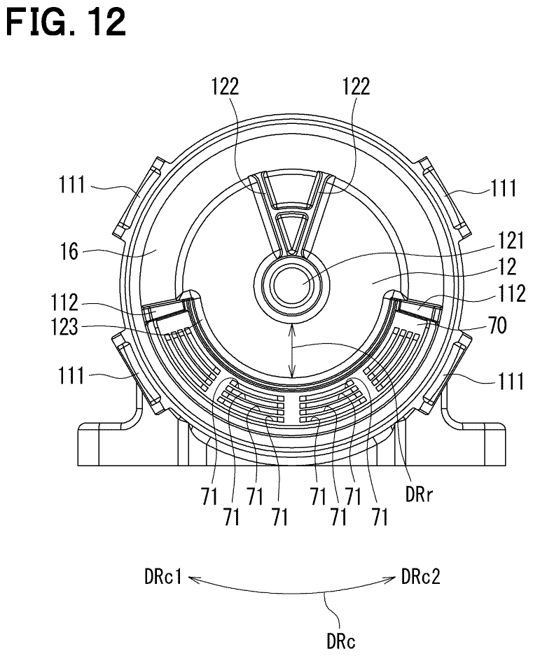

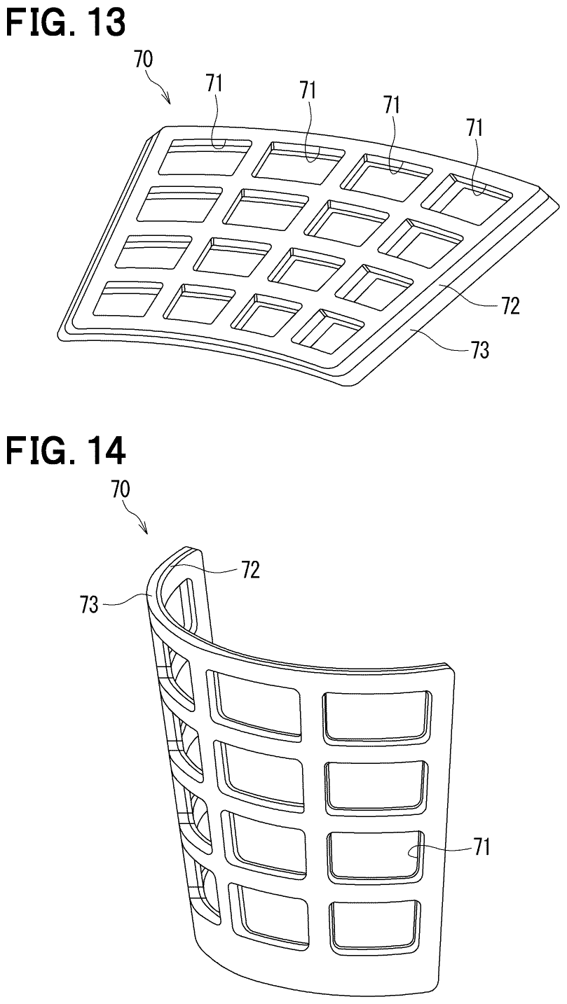

The seal member 70 is disposed at a portion where the eight opening portions 41 to 48 are formed in the valve outer wall portion 61 and the cylinder 11, and seals a predetermined gap between the valve 60 and the eight opening portions 41 to 48. As illustrated in FIG. 12, the seal member 70 is configured to cover all of the eight opening portions 41 to 48. As illustrated in FIGS. 13 and 14, the seal member 70 is formed with a plurality of through-holes 71 that allow passage of the fluid flowing through the eight opening portions 41 to 48.

As illustrated in FIG. 13, the seal member 70 is formed in a substantially fan-shaped plate in a state before attachment between the valve outer wall portion 61 and the cylinder 11. As illustrated in FIG. 12, the seal member 70 is disposed such that the plate thickness direction is the radial direction DRr. The seal member 70 is bent and disposed when placed between the valve outer wall portion 61 and the cylinder 11, as illustrated in FIGS. 12 and 14, and a portion forming an arc extends in the circumferential direction DRc and is disposed along the inner circumferential surface 16 of the cylinder 11. As described above, the plate surface of the seal member 70 has a planar shape before being attached, and has a curved surface shape bent in the circumferential direction DRc in the attached state.

The seal member 70 is provided between the two circumferential-side seal regulating portions 112, and one side and the other side in the circumferential direction DRc are supported by the circumferential-side seal regulating portion 112. In addition, the seal member 70 is fitted into and supported by a circumferential-side seal regulating portion 112 formed on the bottom 12 on the second axial-center direction DRa2 side.

The seal member 70 includes a sliding portion 72 positioned on the valve outer wall portion 61 side and a pressing portion 73 positioned on the cylinder 11 side when disposed between the valve outer wall portion 61 and the cylinder 11. That is, the seal member 70 is configured by laminating the sliding portion 72 and the pressing portion 73 in the plate thickness direction. The sliding portion 72 and the pressing portion 73 are made of different materials.

Specifically, in the seal member 70, the sliding portion 72 is formed of a high-lubricity member with a small friction coefficient, such as polytetrafluoroethylene (hereinafter referred to as “PTFE”) or a fluororesin. In contrast, the pressing portion 73 is formed of an elastic member such as a rubber member.

The seal member 70 is formed, for example, by applying the sliding portion 72, formed of PTFE, a fluororesin, or the like, to the surface of the pressing portion 73, formed of an elastic member such as a rubber member. Alternatively, the seal member 70 may be formed by integral assembly of the sliding portion 72, formed of PTFE, a fluororesin, or the like, and the pressing portion 73, formed of an elastic member such as a rubber member, or by bonding with an adhesive or by baking.

Thus, when the seal member 70 is disposed between the valve outer wall portion 61 and the cylinder 11, the pressing portion 73 can be easily deformed to conform to the shape of the cylinder 11. Therefore, the ease of assembly of the seal member 70 can be improved, and the gap between the valve 60 and the seal member 70 and the gap between the housing 10 and the seal member 70 can be reduced. This enables a reduction in the flow of the fluid into the gap between the valve 60 and the seal member 70 and the gap between the housing 10 and the seal member 70.

Furthermore, the sliding portion 72 positioned on the valve outer wall portion 61 side is a high-lubricity member with a small friction coefficient, such as PTFE or a fluororesin, so that the sliding resistance between the valve 60 and the seal member 70 can be reduced.

Here, in the seal member 70 of the present embodiment, the size in the circumferential direction DRc is formed to be larger than the range in which the eight opening portions 41 to 48 in the cylinder 11 are formed. In the seal member 70, a plurality of through-holes 71 are formed in a grid pattern, penetrating the seal member 70 in the plate thickness direction over the entire axial-center direction DRa and the entire circumferential direction DRc. The through-holes 71 are formed in four rows in the axial-center direction DRa and in four columns in the circumferential direction DRc.

The four through-holes 71 arranged in each of the axial-center direction DRa and the circumferential direction DRc have opening shapes that are trapezoidal shapes corresponding to the eight opening portions 41 to 48, respectively, and the size in the circumferential direction DRc on the second axial-center direction DRa2 side is smaller than that on the first axial-center direction DRa1 side. In other words, the opening shape of the through-hole 71 corresponds to the first fluid passage 64a to the tenth fluid passage 64j, and specifically corresponds to the sections forming the first fluid passage 64a to the tenth fluid passage 64j.

Among the through-holes 71 arranged in four columns in the circumferential direction DRc, the groups of the through-holes 71 in two central columns are formed at positions facing the eight opening portions 41 to 48. The group of through-holes 71 in the two central columns allows passage of the fluid flowing through the eight opening portions 41 to 48.

In contrast, among the through-holes 71 arranged in four columns in the circumferential direction DRc, the group of through-holes 71 in one column formed at the end portion on the first circumferential direction DRc1 side and the group of through-holes 71 in one column formed at the end portion on the second circumferential direction DRc2 side are formed at positions not facing the eight opening portions 41 to 48. That is, the group of through-holes 71 in one column formed at the end portion on the first circumferential direction DRc1 side and the group of through-holes 71 in one column formed at the end portion on the second circumferential direction DRc2 side are formed on the first circumferential direction DRc1 side and the second circumferential direction DRc2 side with respect to the eight opening portions 41 to 48.

The portions of the seal member 70 forming the groups of the through-holes 71 in the two central columns surround the eight opening portions 41 to 48, and reduce the mixture of the fluid passing through each of the eight opening portions 41 to 48.

In the seal member 70, the group of through-holes 71 in one column formed at the end portion on the first circumferential direction DRc1 side and the group of through-holes 71 in one column formed at the end portion on the second circumferential direction DRc2 side surround the fluid passage not facing the eight opening portions 41 to 48. Thus, among the first fluid passage 64a to the tenth fluid passage 64j, the seal member 70 seals the fluid passage in which the group of through-holes 71 in one column formed at the end portion on each of the first circumferential direction DRc1 side and the second circumferential direction DRc2 side does not face the eight opening portions 41 to 48. In this case, the seal member 70 reduces the mixture of the fluid flowing through the fluid passage not facing the eight opening portions 41 to 48 among the first fluid passage 64a to the tenth fluid passage 64j.

Here, the number of columns of the eight opening portions 41 to 48 arranged in two columns in the circumferential direction DRc is referred to as the number of opening columns, and the number of columns of the through-holes 71 arranged in four columns in the circumferential direction DRc is referred to as the number of through-hole columns. In the present embodiment, the number of opening columns is set to two. The number of through-hole columns is set to four. That is, in the present embodiment, the number of through-hole columns is set to two more than the number of opening columns. Specifically, the through-holes 71 are provided in one additional column on each of one side and the other side in the circumferential direction DRc with respect to the eight opening portions 41 to 48, which are arranged in two columns in the circumferential direction DRc. Thus, the seal member 70 includes the group of through-holes 71 in one column on the first circumferential direction DRc1 side and the group of through-holes 71 in one column on the second circumferential direction DRc2 side, formed at positions not facing the eight opening portions 41 to 48 in the circumferential direction DRc.

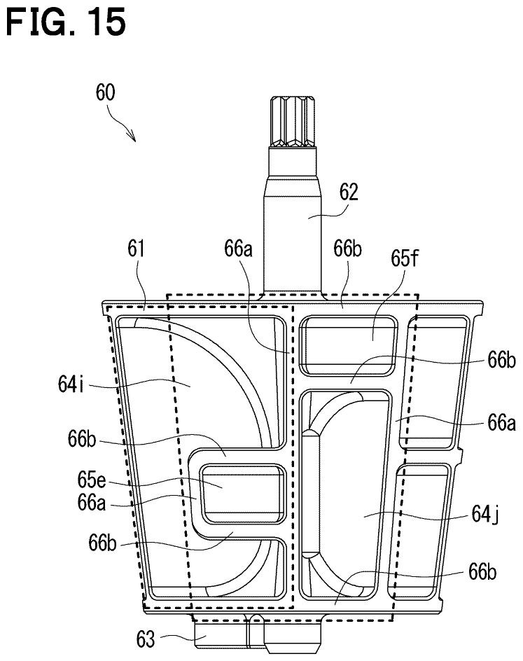

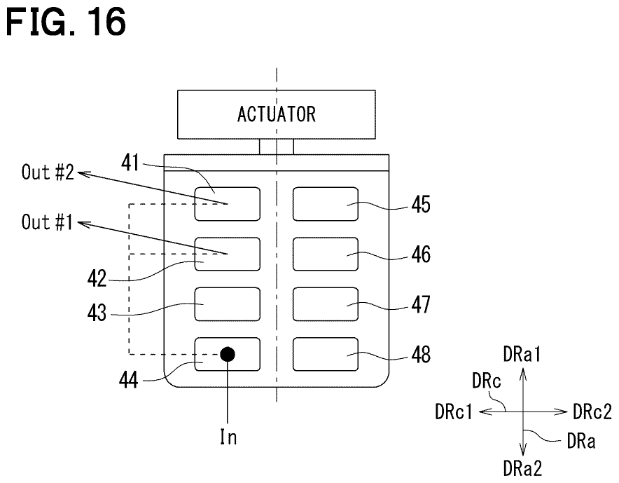

The reason why the number of through-hole columns is set to be larger than the number of opening columns will be described with reference to FIGS. 15 and 16. Here, FIG. 15 illustrates a front view of the valve 60 when the valve 60 is positioned at a position where a part of the ninth fluid passage 64i faces the first-column opening portion and the sixth closing portion 65f and the tenth fluid passage 64j face the second-column opening portion. A dashed line in FIG. 15 indicates a range covered by the eight opening portions 41 to 48 in the valve outer wall portion 61.

As described above, the ninth fluid passage 64i can straddle two opening portions in the circumferential direction DRc. Therefore, when the second circumferential direction DRc2 side of the ninth fluid passage 64i is positioned at a position facing the first-column opening portion, the first circumferential direction DRc1 side does not face the eight opening portions 41 to 48. Then, the ninth fluid passage 64i allows the first fluid inlet 42 and the second fluid inlet 44, which are not adjacent to each other, to communicate via a portion on the first circumferential direction DRc1 side not facing the eight opening portions 41 to 48. Then, the fluid flowing into the valve 60 from the second fluid inlet 44 flows to the first fluid outlet 41 via a portion of the ninth fluid passage 64i on the first circumferential direction DRc1 side. That is, the fluid flowing into the valve 60 from the second fluid inlet 44 flows to the first fluid outlet 41 while bypassing the position facing the eight opening portions 41 to 48.

Here, it is assumed that the number of through-hole columns is set to be the same as the number of opening columns. In this case, when the fluid flowing into the valve 60 from the second fluid inlet 44 flows into the portion of the ninth fluid passage 64i on the first circumferential direction DRc1 side, the fluid may leak from the gap between the outer circumferential surface 611 of the valve outer wall portion 61 and the inner circumferential surface 16 of the cylinder 11.

In contrast, in the present embodiment, the number of through-hole columns is set to two more than the number of opening columns. The seal member 70 includes portions forming the group of through-holes 71 in one column on the first circumferential direction DRc1 side and the group of through-holes 71 in one column on the second circumferential direction DRc2 side at positions not facing the eight opening portions 41 to 48 in the circumferential direction DRc.

Thus, even when the seal member 70 is positioned at a position where the first circumferential direction DRc1 side of the ninth fluid passage 64i does not face the eight opening portions 41 to 48, the portion forming the group of through-holes 71 in one column on the first circumferential direction DRc1 side surrounds the non-facing portion. Therefore, when the fluid flowing into the valve 60 from the second fluid inlet 44 flows into the portion of the ninth fluid passage 64i on the first circumferential direction DRc1 side, it is possible to reduce the leakage of the fluid from the gap between the outer circumferential surface 611 of the valve outer wall portion 61 and the inner circumferential surface 16 of the cylinder 11.

Returning to FIG. 4, the biasing portion 80 is provided between the first axial-center direction DRa1 side of the valve 60 and the second axial-center direction DRa2 side of the housing cover 20. The biasing portion 80 is a member that presses the valve 60 in the second axial-center direction DRa2, and is formed of, for example, a compression coil spring. The compression coil spring is provided between the valve 60 and the housing cover 20 in a compressed state, and presses the valve 60 in the second axial-center direction DRa2 by a biasing force generated by the compression.

Here, as described above, the internal angle Θ formed by the generatrix of the conical shape parallel to the valve outer wall portion 61 and the axial center CL is set to 5 deg or more. Thus, the biasing force of the biasing portion 80 acts as a component force for pressing the valve 60 and the seal member 70, and acts as a component force for pressing the seal member 70 and the cylinder 11. Therefore, by adjusting the biasing force of the biasing portion 80, it is possible to keep a state in which the outer circumferential surface 611 of the valve outer wall portion 61 and the seal member 70 are in sliding contact with each other and a state in which the inner circumferential surface 16 of the cylinder 11 and the seal member 70 are in contact with each other during both the rotation and stop of the valve 60.

A spring guide 81 is provided between the first axial-center direction DRa1 side of the valve 60 and the second axial-center direction DRa2 side of the housing cover 20. The spring guide 81 supports the biasing portion 80 including a compression coil spring. The spring guide 81 includes a cylindrical portion 811 having a cylindrical shape and provided inside the biasing portion 80, and a disk portion 812 having a thin disk shape and connected to the cylindrical portion 811 on the second axial-center direction DRa2 side.

The cylindrical portion 811 extends along the axial-center direction DRa, and the inside thereof is supported by the housing cover 20. The disk portion 812 is placed on the first axial-center direction DRa1 side of the valve 60 and supported by the valve 60. The disk portion 812 supports the biasing portion 80 on the second axial-center direction DRa2 side.

The spring guide 81 configured as described above can reduce the positional displacement of the biasing portion 80 in the radial direction DRr and transmit the biasing force of the biasing portion 80 to the valve 60.

In each configuration of the fluid control valve 1 described above, the housing cover 20, the cover seal 23, the valve 60, the seal member 70, and the biasing portion 80 are configured to be removable from the housing 10 from the first axial-center direction DRa1 side. Therefore, the following steps can be employed as a method for manufacturing the fluid control valve 1. First, the seal member 70 is assembled to the housing 10. Next, the valve 60 is assembled to the housing 10. Subsequently, the housing cover 20 provided with the cover seal 23 is assembled to the housing 10 while the spring guide 81 and the biasing portion 80 are arranged. Finally, the drive unit 30 is assembled to the housing cover 20, and the assembly of the fluid control valve 1 is completed.

Next, the operation of the fluid control valve 1 of the present embodiment will be described with reference to FIG. 11. The fluid control valve 1 enables the fluid to flow into the valve accommodation space AS from any one or more of the first fluid inlet 42 to the fourth fluid inlet 47 by adjusting the rotational position of the valve 60. The fluid control valve 1 enables the fluid flowing into the valve accommodation space AS to flow out from any one or more of the first fluid outlet 41 to the fourth fluid outlet 48. That is, the fluid control valve 1 rotates the valve 60 about the axial center CL and switches the flow path inlet facing the first fluid passage 64a to the tenth fluid passage 64j, thereby switching the fluid outlet from which the fluid flows out. Thus, the operation mode of the fluid control valve 1 is switched. The fluid control valve 1 of the present embodiment is configured to switch the operation mode to ten switching patterns by switching the rotational position of the valve 60 to ten rotational positions described with reference to FIG. 11.

Here, among the rotational positions of the valve 60 illustrated in FIG. 11, a position where the first fluid passage 64a faces the first-column opening portion is defined as a first valve position, and a position where the fourth fluid passage 64d faces the first-column opening portion is defined as a second valve position. Further, a position where the fifth fluid passage 64e faces the first-column opening portion is defined as a third valve position, a position where the sixth fluid passage 64f faces the first-column opening portion is defined as a fourth valve position, and a position where the first closing portion 65a faces the first-column opening portion is defined as a fifth valve position. A position where the eighth fluid passage 64h faces the second-column opening portion is defined as a sixth valve position, a position where the eighth fluid passage 64h faces the first-column opening portion is defined as a seventh valve position, and a position where the fifth closing portion 65e faces the second-column opening portion is defined as an eighth valve position. A position where the tenth fluid passage 64j faces the second-column opening portion is defined as a ninth valve position, and a position where the tenth fluid passage 64j faces the first-column opening portion is defined as a tenth valve position.

When the valve 60 is positioned at the first valve position, the fluid flow upstream side of the first fluid passage 64a communicates with the first fluid inlet 42, and the fluid flow downstream side communicates with the first fluid outlet 41. In the second fluid passage 64b, the fluid flow upstream side communicates with the second fluid inlet 44, and the fluid flow downstream side communicates with the second fluid outlet 43. In the third fluid passage 64c, the fluid flow upstream side communicates with the third fluid inlet 45, and the fluid flow downstream side communicates with the third fluid outlet 46. In the fourth fluid passage 64d, the fluid flow upstream side communicates with the fourth fluid inlet 47, and the fluid flow downstream side communicates with the fourth fluid outlet 48.

Thus, the fluid flowing in from the first fluid inlet 42 is guided to the first fluid outlet 41 via the first fluid passage 64a and flows to the outside of the fluid control valve 1. The fluid flowing in from the second fluid inlet 44 is guided to the second fluid outlet 43 via the second fluid passage 64b and flows to the outside of the fluid control valve 1. The fluid flowing in from the third fluid inlet 45 is guided to the third fluid outlet 46 via the third fluid passage 64c and flows to the outside of the fluid control valve 1. Furthermore, the fluid flowing in from the fourth fluid inlet 47 is guided to the fourth fluid outlet 48 via the fourth fluid passage 64d and flows to the outside of the fluid control valve 1.

In this case, each of the first fluid passage 64a, the second fluid passage 64b, the third fluid passage 64c, and the fourth fluid passage 64d functions as a first flow path portion that guides the fluid flowing in from any one of the first fluid inlet 42 to the fourth fluid inlet 47 to any one of the first fluid outlet 41 to the fourth fluid outlet 48, with which each fluid passage allows communication.

When the valve 60 is positioned at the second valve position, the fluid flow upstream side of the third fluid passage 64c communicates with the first fluid inlet 42 and the third fluid inlet 45, and the fluid flow downstream side communicates with the first fluid outlet 41. In the fourth fluid passage 64d, the fluid flow upstream side communicates with the second fluid inlet 44, and the fluid flow downstream side communicates with the second fluid outlet 43. In the fifth fluid passage 64e, the fluid flow upstream side communicates with the fourth fluid inlet 47, and the fluid flow downstream side communicates with the third fluid outlet 46 and the fourth fluid outlet 48.

Thus, the fluid flowing in from the first fluid inlet 42 and the fluid flowing in from the third fluid inlet 45 are joined at the third fluid passage 64c, guided to the first fluid outlet 41, and flow to the outside of the fluid control valve 1. The fluid flowing in from the second fluid inlet 44 is guided to the second fluid outlet 43 via the fourth fluid passage 64d and flows to the outside of the fluid control valve 1. The fluid flowing in from the fourth fluid inlet 47 is divided by the fifth fluid passage 64e, guided to the third fluid outlet 46 and the fourth fluid outlet 48, and flows to the outside of the fluid control valve 1.

In this case, the third fluid passage 64c functions as a third flow path portion that guides the fluid flowing in from two of the first fluid inlet 42 to the fourth fluid inlet 47 to any one of the first fluid outlet 41 to the fourth fluid outlet 48, with which the fluid passage allows communication. The fourth fluid passage 64d functions as the first flow path portion that guides the fluid flowing in from any one of the first fluid inlet 42 to the fourth fluid inlet 47 to any one of the first fluid outlet 41 to the fourth fluid outlet 48, with which the fluid passage allows communication. The fifth fluid passage 64e functions as a second flow path portion that guides the fluid flowing in from any one of the first fluid inlet 42 to the fourth fluid inlet 47 to any two of the first fluid outlet 41 to the fourth fluid outlet 48, with which the fluid passage allows communication.

When the valve 60 is positioned at the third valve position, the fluid flow upstream side of the third fluid passage 64c communicates with the third fluid inlet 45, and the fluid flow downstream side communicates with the first fluid outlet 41. In the fifth fluid passage 64e, the fluid flow upstream side communicates with the first fluid inlet 42 and the second fluid inlet 44, and the fluid flow downstream side communicates with the second fluid outlet 43. In the sixth fluid passage 64f, the fluid flow upstream side communicates with the fourth fluid inlet 47, and the fluid flow downstream side communicates with the third fluid outlet 46. The first closing portion 65a closes the fourth fluid outlet 48.

Thus, the fluid flowing in from the third fluid inlet 45 is guided to the first fluid outlet 41 via the third fluid passage 64c and flows to the outside of the fluid control valve 1. The fluid flowing in from the first fluid inlet 42 and the fluid flowing in from the second fluid inlet 44 are joined at the fifth fluid passage 64e, guided to the second fluid outlet 43, and flow to the outside of the fluid control valve 1. The fluid flowing in from the fourth fluid inlet 47 is guided to the third fluid outlet 46 via the sixth fluid passage 64f and flows to the outside of the fluid control valve 1. However, the fourth fluid outlet 48 is closed by the first closing portion 65a and does not communicate with any of the first fluid inlet 42 to the fourth fluid inlet 47, thus preventing the fluid from flowing out.

In this case, the third fluid passage 64c and the sixth fluid passage 64f function as a first flow path portion that guides the fluid flowing in from one of the first fluid inlet 42 to the fourth fluid inlet 47 to any one of the first fluid outlet 41 to the fourth fluid outlet 48, with which the fluid passages allow communication. The fifth fluid passage 64e functions as a second flow path portion that guides the fluid flowing in from any one of the first fluid inlet 42 to the fourth fluid inlet 47 to any two of the first fluid outlet 41 to the fourth fluid outlet 48, with which the fluid passage allows communication.

Here, when the valve 60 is positioned at the third valve position, one column of the third fluid passage 64c on the first circumferential direction DRc1 side does not face the eight opening portions 41 to 48, and two columns on the second circumferential direction DRc2 side do not face the eight opening portions 41 to 48. The fluid flowing in from the third fluid inlet 45 flows to a portion forming one column on the first circumferential direction DRc1 side and a portion forming two columns on the second circumferential direction DRc2 side in the third fluid passage 64c.

However, the portion forming the one column on the first circumferential direction DRc1 side in the third fluid passage 64c is surrounded by the portion forming the group of through-holes 71 in one column on the first circumferential direction DRc1 side in the seal member 70. This leads to a reduction in the leakage of the fluid flowing to the portion forming the one column on the first circumferential direction DRc1 side in the third fluid passage 64c from the gap between the outer circumferential surface 611 of the valve outer wall portion 61 and the inner circumferential surface 16 of the cylinder 11.

In contrast, among the portions forming the two columns on the second circumferential direction DRc2 side in the third fluid passage 64c, the portion closest to the second circumferential direction DRc2 side is not surrounded by the portion forming the group of through-holes 71 in one column on the second circumferential direction DRc2 side in the seal member 70. For this reason, the fluid flowing to the portion forming the two columns on the second circumferential direction DRc2 side in the third fluid passage 64c may flow from the gap between the outer circumferential surface 611 of the valve outer wall portion 61 and the inner circumferential surface 16 of the cylinder 11 to the back side of the valve 60.

However, assuming that the fluid flows to the back side of the valve 60, the portion forming the one column on the first circumferential direction DRc1 side in the third fluid passage 64c is surrounded by the portion forming the group of through-holes 71 in one column on the first circumferential direction DRc1 side in the seal member 70. The fourth fluid passage 64d is surrounded by the portion of the seal member 70 forming the group of through-holes 71 in one column on the first circumferential direction DRc1 side. This enables a reduction in the leakage of the fluid flowing into the back side of the valve 60 from flowing into the third fluid passage 64c and the fourth fluid passage 64d.

When the valve 60 is positioned at the fourth valve position, the fluid flow upstream side of the third fluid passage 64c communicates with the third fluid inlet 45, and the fluid flow downstream side communicates with the first fluid outlet 41. In the sixth fluid passage 64f, the fluid flow upstream side communicates with the first fluid inlet 42, and the fluid flow downstream side communicates with the second fluid outlet 43. In the seventh fluid passage 64g, the fluid flow upstream side communicates with the fourth fluid inlet 47, and the fluid flow downstream side communicates with the fourth fluid outlet 48. The first closing portion 65a closes the second fluid inlet 44. The second closing portion 65b closes the third fluid outlet 46.

Thus, the fluid flowing in from the third fluid inlet 45 is guided to the first fluid outlet 41 via the third fluid passage 64c and flows to the outside of the fluid control valve 1. The fluid flowing in from the first fluid inlet 42 is guided to the second fluid outlet 43 via the sixth fluid passage 64f and flows to the outside of the fluid control valve 1. The fluid flowing in from the fourth fluid inlet 47 is guided to the fourth fluid outlet 48 via the seventh fluid passage 64g and flows to the outside of the fluid control valve 1. However, the second fluid inlet 44 is closed by the first closing portion 65a, thus preventing the fluid from flowing into the valve accommodation space AS. The third fluid outlet 46 is closed by the second closing portion 65b and does not communicate with any of the first fluid inlet 42 to the fourth fluid inlet 47, thus preventing the fluid from flowing out.

In this case, the third fluid passage 64c, the sixth fluid passage 64f, and the seventh fluid passage 64g function as a first flow path portion that guides the fluid flowing in from one of the first fluid inlet 42 to the fourth fluid inlet 47 to any one of the first fluid outlet 41 to the fourth fluid outlet 48, with which the fluid passages allow communication.

Here, when the valve 60 is positioned at the fourth valve position, in the third fluid passage 64c, two columns on the first circumferential direction DRc1 side do not face the eight opening portions 41 to 48, and one column on the second circumferential direction DRc2 side does not face the eight opening portions 41 to 48. The fluid flowing in from the third fluid inlet 45 flows to the portion forming the two columns on the first circumferential direction DRc1 side and the portion forming the one column on the second circumferential direction DRc2 side in the third fluid passage 64c.

However, the portion forming the one column on the second circumferential direction DRc2 side in the third fluid passage 64c is surrounded by the portion forming the group of through-holes 71 in one column on the second circumferential direction DRc2 side in the seal member 70. This leads to a reduction in the leakage of the fluid flowing to the portion forming the one column on the second circumferential direction DRc2 side in the third fluid passage 64c from the gap between the outer circumferential surface 611 of the valve outer wall portion 61 and the inner circumferential surface 16 of the cylinder 11.

In contrast, among the portions forming the two columns on the first circumferential direction DRc1 side in the third fluid passage 64c, the portion closest to the first circumferential direction DRc1 side is not surrounded by the portion forming the group of through-holes 71 in one column on the first circumferential direction DRc1 side in the seal member 70. For this reason, the fluid flowing to the portion forming the one column on the first circumferential direction DRc1 side in the third fluid passage 64c may flow from the gap between the outer circumferential surface 611 of the valve outer wall portion 61 and the inner circumferential surface 16 of the cylinder 11 to the back side of the valve 60.

However, assuming that the fluid flows to the back side of the valve 60, the portion forming the one column on the second circumferential direction DRc2 side in the third fluid passage 64c is surrounded by the portion forming the group of through-holes 71 in one column on the second circumferential direction DRc2 side in the seal member 70. The seventh fluid passage 64g is surrounded by the portion of the seal member 70 forming the group of through-holes 71 in one column on the second circumferential direction DRc2 side. Furthermore, the third closing portion 65c and the fourth closing portion 65d are surrounded by the portion of the seal member 70 forming the group of through-holes 71 in one column on the first circumferential direction DRc1 side. This enables a reduction in the flow of the fluid, flowing into the back side of the valve 60, into the third fluid passage 64c and the seventh fluid passage 64g.

When the valve 60 is positioned at the fifth valve position, the fluid flow upstream side of the third fluid passage 64c communicates with the third fluid inlet 45, and the fluid flow downstream side communicates with the first fluid outlet 41. In the seventh fluid passage 64g, the fluid flow upstream side communicates with the second fluid inlet 44 and the fourth fluid inlet 47, and the fluid flow downstream side communicates with the second fluid outlet 43. The second closing portion 65b closes the first fluid inlet 42. The third closing portion 65c closes the third fluid outlet 46. The fourth closing portion 65d closes the fourth fluid outlet 48.

Thus, the fluid flowing in from the third fluid inlet 45 is guided to the first fluid outlet 41 via the third fluid passage 64c and flows to the outside of the fluid control valve 1. The fluid flowing in from the second fluid inlet 44 and the fluid flowing in from the fourth fluid inlet 47 are joined at the seventh fluid passage 64g, guided to the second fluid outlet 43, and flow to the outside of the fluid control valve 1. However, the first fluid inlet 42 is closed by the second closing portion 65b, thus preventing the fluid from flowing into the valve accommodation space AS. The third fluid outlet 46 is closed by the third closing portion 65c and does not communicate with any of the first fluid inlet 42 to the fourth fluid inlet 47, thus preventing the fluid from flowing out. The fourth fluid outlet 48 is closed by the fourth closing portion 65d and does not communicate with any of the first fluid inlet 42 to the fourth fluid inlet 47, thus preventing the fluid from flowing out.

In this case, the third fluid passage 64c functions as a first flow path portion that guides the fluid flowing in from one of the first fluid inlet 42 to the fourth fluid inlet 47 to any one of the first fluid outlet 41 to the fourth fluid outlet 48, with which the fluid passage allows communication. The seventh fluid passage 64g functions as a third flow path portion that guides the fluid flowing in from two of the first fluid inlet 42 to the fourth fluid inlet 47 to any one of the first fluid outlet 41 to the fourth fluid outlet 48, with which the fluid passage allows communication.

When the valve 60 is positioned at the sixth valve position, the fluid flow upstream side of the eighth fluid passage 64h communicates with the third fluid inlet 45 and the fourth fluid inlet 47, and the fluid flow downstream side communicates with the third fluid outlet 46 and the fourth fluid outlet 48. The third fluid passage 64c closes the first fluid outlet 41. The third closing portion 65c closes the first fluid inlet 42. The seventh fluid passage 64g closes the second fluid outlet 43. The fourth closing portion 65d closes the second fluid inlet 44.

Thus, the fluid flowing in from the third fluid inlet 45 and the fluid flowing in from the fourth fluid inlet 47 are joined and divided at the eighth fluid passage 64h, guided to the third fluid outlet 46 and the fourth fluid outlet 48, and flow to the outside of the fluid control valve 1. However, the first fluid outlet 41 is closed by the third fluid passage 64c and does not communicate with any of the first fluid inlet 42 to the fourth fluid inlet 47, thus preventing the fluid from flowing out. The first fluid inlet 42 is closed by the third closing portion 65c, thus preventing the fluid from flowing into the valve accommodation space AS. The second fluid outlet 43 is closed by the seventh fluid passage 64g and does not communicate with any of the first fluid inlet 42 to the fourth fluid inlet 47, thus preventing the fluid from flowing out. The second fluid inlet 44 is closed by the fourth closing portion 65d, thus preventing the fluid from flowing into the valve accommodation space AS.

In this case, the eighth fluid passage 64h functions as a fourth flow path portion that guides the fluid flowing in from two of the first fluid inlet 42 to the fourth fluid inlet 47 to any two of the first fluid outlet 41 to the fourth fluid outlet 48, with which the fluid passage allows communication.

When the valve 60 is positioned at the seventh valve position, the fluid flow upstream side of the eighth fluid passage 64h communicates with the first fluid inlet 42 and the second fluid inlet 44, and the fluid flow downstream side communicates with the first fluid outlet 41 and the second fluid outlet 43. In the ninth fluid passage 64i, the fluid flow upstream side communicates with the third fluid inlet 45 and the fourth fluid inlet 47, and the fluid flow downstream side communicates with the third fluid outlet 46 and the fourth fluid outlet 48.

Thus, the fluid flowing in from the first fluid inlet 42 and the fluid flowing in from the second fluid inlet 44 are joined and divided at the eighth fluid passage 64h, guided to the first fluid outlet 41 and the second fluid outlet 43, and flow to the outside of the fluid control valve 1. Further, the fluid flowing in from the third fluid inlet 45 and the fluid flowing in from the fourth fluid inlet 47 are joined and divided at the ninth fluid passage 64i, guided to the third fluid outlet 46 and the fluid flowing in from the fourth fluid outlet 48, and flow to the outside of the fluid control valve 1.

In this case, the eighth fluid passage 64h and the ninth fluid passage 64i function as a fourth flow path portion that guides the fluid flowing in from two of the first fluid inlet 42 to the fourth fluid inlet 47 to any two of the first fluid outlet 41 to the fourth fluid outlet 48, with which the fluid passages allow communication.

When the valve 60 is positioned at the eighth valve position, the fluid flow upstream side of the ninth fluid passage 64i communicates with the first fluid inlet 42, the second fluid inlet 44, and the third fluid inlet 45, and the fluid flow downstream side communicates with the first fluid outlet 41, the second fluid outlet 43, the third fluid outlet 46, and the fourth fluid outlet 48. The fifth closing portion 65e closes the fourth fluid inlet 47.

Thus, the fluid flowing in from the first fluid inlet 42, the fluid flowing in from the second fluid inlet 44, and the fluid flowing in from the third fluid inlet 45 are joined and divided in the ninth fluid passage 64i, guided to the first fluid outlet 41, the second fluid outlet 43, the third fluid outlet 46, and the fourth fluid outlet 48, and flow to the outside of the fluid control valve 1. However, the fourth fluid inlet 47 is closed by the fifth closing portion 65e, thus preventing the fluid from flowing into the valve accommodation space AS.

In this case, the ninth fluid passage 64i functions as a fourth flow path portion that guides the fluid flowing in from three of the first fluid inlet 42 to the fourth fluid inlet 47 to all four of the first fluid outlet 41 to the fourth fluid outlet 48, with which the fluid passage allows communication.

When the valve 60 is positioned at the ninth valve position, the fluid flow upstream side of the ninth fluid passage 64i communicates with the first fluid inlet 42 and the second fluid inlet 44, and the fluid flow downstream side communicates with the first fluid outlet 41. At this time, the second fluid inlet 44 and the first fluid outlet 41 communicate with each other via a portion on the first circumferential direction DRc1 side not facing any of the eight opening portions 41 to 48 in the ninth fluid passage 64i. That is, the ninth fluid passage 64i allows the second fluid inlet 44 and the first fluid outlet 41, which are not adjacent to each other, to communicate in the first-column opening portion provided at the end portion on the first circumferential direction DRc1 side among the eight opening portions 41 to 48 arranged in two columns in the circumferential direction DRc. When the valve 60 is positioned at the ninth valve position, the fluid flow upstream side of the tenth fluid passage 64j communicates with the fourth fluid inlet 47, and the fluid flow downstream side communicates with the third fluid outlet 46 and the fourth fluid outlet 48. The fifth closing portion 65e closes the second fluid outlet 43. The sixth closing portion 65f closes the third fluid inlet 45.

Thus, the fluid flowing in from the first fluid inlet 42 and the fluid flowing in from the second fluid inlet 44 are joined and divided at the ninth fluid passage 64i, guided to the first fluid outlet 41, and flow to the outside of the fluid control valve 1. At this time, the fluid flowing in from the second fluid inlet 44 is guided to the first fluid outlet 41 while bypassing the portions facing the eight opening portions 41 to 48 in the valve outer wall portion 61. The fluid flowing in from the fourth fluid inlet 47 is divided by the tenth fluid passage 64j, guided to the third fluid outlet 46 and the fourth fluid outlet 48, and flows to the outside of the fluid control valve 1. However, the second fluid outlet 43 is closed by the fifth closing portion 65e and does not communicate with any of the first fluid inlet 42 to the fourth fluid inlet 47, thus preventing the fluid from flowing out. The third fluid inlet 45 is closed by the sixth closing portion 65f, thus preventing the fluid from flowing into the valve accommodation space AS.

Here, when the fluid flowing in from the second fluid inlet 44 flows to the first fluid outlet 41, the fluid flows while bypassing the portions facing the eight opening portions 41 to 48 of the valve outer wall portion 61 in the ninth fluid passage 64i. The portion forming one column on the first circumferential direction DRc1 side, which is a portion allowing the flow while bypassing the portions facing the eight opening portions 41 to 48, in the ninth fluid passage 64i is surrounded by the portion forming the group of through-holes 71 in one column on the first circumferential direction DRc1 side in the seal member 70. This leads to a reduction in the leakage of the fluid flowing through the portion forming the one column on the first circumferential direction DRc1 side in the ninth fluid passage 64i from the gap between the outer circumferential surface 611 of the valve outer wall portion 61 and the inner circumferential surface 16 of the cylinder 11.

In this case, the ninth fluid passage 64i functions as a bypass flow path portion that guides the fluid flowing in from the second fluid inlet 44 provided at the end portion on the first circumferential direction DRc1 side to the first fluid outlet 41 while bypassing the portions facing the eight opening portions 41 to 48 in the valve outer wall portion 61. The ninth fluid passage 64i is provided at the end portion on the first circumferential direction DRc1 side, and allows the second fluid inlet 44, the first fluid inlet 42, and the first fluid outlet 41, which are not adjacent to each other, to communicate. Furthermore, the ninth fluid passage 64i is formed to have the same size on the circumferential direction DRc side as the eight opening portions 41 to 48, and also functions as the fourth flow path portion as described above when positioned at a position facing the eight opening portions 41 to 48. The tenth fluid passage 64j functions as a second flow path portion that guides the fluid flowing in from any one of the first fluid inlet 42 to the fourth fluid inlet 47 to any two of the first fluid outlet 41 to the fourth fluid outlet 48, with which the fluid passage allows communication. When the valve 60 is positioned at the tenth valve position, the fluid flow upstream side of the tenth fluid passage 64j communicates with the first fluid inlet 42 and the second fluid inlet 44, and the fluid flow downstream side communicates with the second fluid outlet 43. In the first fluid passage 64a, the fluid flow upstream side communicates with the third fluid inlet 45, and the fluid flow downstream side communicates with the third fluid outlet 46. In the second fluid passage 64b, the fluid flow upstream side communicates with the fourth fluid inlet 47, and the fluid flow downstream side communicates with the fourth fluid outlet 48. The sixth closing portion 65f closes the first fluid outlet 41.

Thus, the fluid flowing in from the first fluid inlet 42 and the fluid flowing in from the second fluid inlet 44 are joined at the tenth fluid passage 64j, guided to the second fluid outlet 43, and flow to the outside of the fluid control valve 1. The fluid flowing in from the third fluid inlet 45 is guided to the third fluid outlet 46 via the first fluid passage 64a and flows to the outside of the fluid control valve 1. Furthermore, the fluid flowing in from the fourth fluid inlet 47 is guided to the fourth fluid outlet 48 via the second fluid passage 64b and flows to the outside of the fluid control valve 1.

In this case, each of the first fluid passage 64a and the second fluid passage 64b functions as a first flow path portion that guides the fluid flowing in from any one of the first fluid inlet 42 to the fourth fluid inlet 47 to any one of the first fluid outlet 41 to the fourth fluid outlet 48, with which the fluid passage allows communication. The tenth fluid passage 64j functions as a third flow path portion that guides the fluid flowing in from two of the first fluid inlet 42 to the fourth fluid inlet 47 to any one of the first fluid outlet 41 to the fourth fluid outlet 48, with which the fluid passage allows communication.

In this manner, by switching the valve 60 from the first valve position to the tenth valve position, the switching pattern of the operation mode is switched to any of the ten patterns. In each switching pattern, the fluid inlet into which the fluid flows among the first fluid inlet 42 to the fourth fluid inlet 47 can be switched, and the fluid outlet from which the fluid flows among the first fluid outlet 41 to the fourth fluid outlet 48 can be switched.

As described above, in the fluid control valve 1 of the present embodiment, the seal member 70 is formed with a plurality of through-holes 71 arranged in the axial-center direction DRa and arranged in a plurality of columns in the circumferential direction DRc. The number of through-hole columns is set to be larger than the number of opening columns.

According to this, when the third fluid passage 64c, the seventh fluid passage 64g, and the ninth fluid passage 64i are positioned at positions straddling the opening portion at the end portion in the circumferential direction DRc, the seal member 70 surrounds the third fluid passage 64c, the seventh fluid passage 64g, and the ninth fluid passage 64i.

Therefore, even if the third fluid passage 64c, the seventh fluid passage 64g, and the ninth fluid passage 64i are positioned at positions straddling the opening portion at the end portion in the circumferential direction DRc, it is possible to reduce the flow of the fluid flowing through these fluid passages between the valve outer wall portion 61 and the cylinder 11. It is possible to reduce the flow of the fluid that flows through the third fluid passage 64c, the seventh fluid passage 64g, and the ninth fluid passage 64i to the back side of the valve 60 Therefore, the rotational position of the valve 60 may not be adjusted so that the third fluid passage 64c, the seventh fluid passage 64g, and the ninth fluid passage 64i do not straddle the opening portion formed at the end portion in the circumferential direction DRc. That is, it is possible to reduce the flow of the fluid to the back side of the valve 60 without limiting the switching pattern of the fluid control valve 1 that is switched by adjusting the rotational position of the valve 60.

According to the above embodiment, the following effects can be obtained.
(1) In the above embodiment, the number of through-hole columns is set to two more than the number of opening columns. The through-holes 71 are provided in one additional column on each of one side and the other side in the circumferential direction DRc with respect to the eight opening portions 41 to 48, which are arranged in two columns in the circumferential direction DRc.

According to this, even if the third fluid passage 64c, the seventh fluid passage 64g, and the ninth fluid passage 64i are positioned at positions straddling the opening portion at either the end portion on the first circumferential direction DRc1 side or the end portion on the second circumferential direction DRc2 side, it is possible to reduce the flow of the fluid around to the back side of the valve 60.
(2) In the above embodiment, the eight opening portions 41 to 48 are formed in a grid pattern, and the first fluid outlet 41, the first fluid inlet 42, and the second fluid inlet 44 are provided at the end portion on the first circumferential direction DRc1 side. The valve outer wall portion 61 is formed with the ninth fluid passage 64i that guides the fluid flowing in from the second fluid inlet 44 to the first fluid outlet 41 while bypassing the portions facing the eight opening portions 41 to 48 in the valve outer wall portion 61. The seal member 70 surrounds the ninth fluid passage 64i at a position not facing the eight opening portions 41 to 48 in the circumferential direction DRc.

According to this, the flow path can be formed by the ninth fluid passage 64i positioned at a position not facing the eight opening portions 41 to 48 and not directly connected to the eight opening portions 41 to 48. That is, the portion of the valve outer wall portion 61 through which the fluid flows is not limited to the position facing the eight opening portions 41 to 48, enabling an improvement in the degree of freedom in the manner of fluid flow. This enables an increase in switching patterns at the time of switching the first fluid inlet 42 to the fourth fluid inlet 47 that communicate with the first fluid outlet 41 to the fourth fluid outlet 48.
(3) In the above embodiment, the ninth fluid passage 64i allows the second fluid inlet 44 and the first fluid outlet 41, which are not adjacent to each other, to communicate.

According to this, among the eight opening portions 41 to 48, the opening portions in communication by the ninth fluid passage 64i are not limited to the opening portions facing each other, enabling an improvement in the degree of freedom in the manner of fluid flow. This enables an increase in switching patterns at the time of switching the first fluid inlet 42 to the fourth fluid inlet 47 that communicate with the first fluid outlet 41 to the fourth fluid outlet 48.
(4) In the above embodiment, the first fluid passage 64a to the tenth fluid passage 64j are formed as ten cells in the valve outer wall portion 61 when the flow path portion of each column is a one-cell flow path portion.

According to this, even if the valve 60 is rotated every two columns such that all the portions facing the eight opening portions 41 to 48 are changed, five switching patterns can be ensured.
(5) In the above embodiment, the valve 60 rotates in the circumferential direction DRc such that the first fluid passage 64a to the tenth fluid passage 64j facing the eight opening portions 41 to 48 arranged in two columns in the circumferential direction DRc change every one column.

According to this, the rotation of the valve 60 changes the portions facing the eight opening portions 41 to 48 arranged in two columns in the circumferential direction DRc every one column, so that ten switching patterns can be ensured.
(6) In the above embodiment, the seal member 70 includes the sliding portion 72 facing the valve outer wall portion 61 and the pressing portion 73 facing the cylinder 11. The sliding portion 72 and the pressing portion 73 are made of different materials.

According to this, among the characteristics required for the seal member 70, materials corresponding to the required characteristics can be selected, respectively, for the cylinder 11 side requiring elasticity and the valve outer wall portion 61 side requiring slidability.
(7) In the above embodiment, the biasing portion 80 that biases the valve 60 in the second axial-center direction DRa2 is provided. The valve outer wall portion 61 is formed along the side surface of the conical shape with the apex on the second axial-center direction DRa2 side. The biasing portion 80 biases the valve 60 toward the apex of the conical shape, keeps a state in which the valve outer wall portion 61 and the seal member 70 are pressed during both the rotation and stop of the valve 60, and keeps a state in which the cylinder 11 and the seal member 70 are pressed.

According to this, it is possible to easily adjust a component force for pressing the valve 60 and the seal member 70 and a component force for pressing the housing 10 and the seal member 70. Therefore, since the gap between the valve 60 and the seal member 70 and the gap between the housing 10 and the seal member 70 can be reduced, sealability between the valve 60 and the seal member 70 and between the housing 10 and the seal member 70 can be ensured.

Furthermore, the valve outer wall portion 61 is shaped along the side surface of the conical shape, and the valve 60 is biased toward the apex of the conical shape by the biasing portion 80. Thus, even if wear occurs on the sliding surface between the valve 60 and the seal member 70 due to aging degradation or the like, the valve 60 and the seal member 70 are kept in sliding contact with each other. Therefore, the fluid control valve 1 can maintain sealability between the valve 60 and the seal member 70 against aging degradation.
(8) In the above embodiment, the internal angle θ formed by the generatrix of the conical shape parallel to the valve outer wall portion 61 and the axial center CL is 5 deg or more.

According to this, the sliding contact state between the valve outer wall portion 61 and the seal member 70 can be easily ensured by the component force of the biasing force of the biasing portion 80 in the second axial-center direction DRa2, that is, a component force acting on the seal member 70 and the cylinder 11 from the valve outer wall portion 61. In addition, the contact state between the cylinder 11 and the seal member 70 can be kept, and sealability between the cylinder 11 and the seal member 70 can be ensured.
(9) In the above embodiment, the inner circumferential surface 16 forming the valve accommodation space AS in the cylinder 11 is shaped along the side surface of the conical shape similar to the valve outer wall portion 61.

According to this, the contact state between the cylinder 11 and the seal member 70 can be kept and sealability can be ensured by the component force of the biasing force of the biasing portion 80 in the second axial-center direction DRa2, that is, a component force acting on the seal member 70 and the cylinder 11 from the valve outer wall portion 61.
(10) In the above embodiment, the rotating shaft 62 of the valve 60 protrudes toward the first axial-center direction DRa1 side. The valve 60, the cover seal 23, and the housing cover 20 are removable from the housing 10 from the first axial-center direction DRa1 side.

Contrary to the configuration of the present embodiment, when the rotating shaft 62 protrudes toward the second axial-center direction DRa2, the shaft hole 22 and the cover seal 23 are provided in the bottom 12 of the housing 10. In this case, when the valve 60 is assembled to the housing 10 during the manufacturing of the fluid control valve 1, it is necessary to carefully assemble the valve so that the rotating shaft 62 and the cover seal 23 do not come into contact with each other and the cover seal 23 is not damaged, which is difficult. Specifically, it is necessary to assemble the valve 60 to the housing 10 while the central axis of the housing 10 and the central axis of the valve 60 over the entire assembly stroke.

In contrast, in the present embodiment, the rotating shaft 62 protrudes toward the first axial-center direction DRa1 side, and the cover seal 23 is provided in the shaft hole 22 of the housing cover 20. Therefore, when the valve 60 is assembled to the housing 10 during the manufacturing of the fluid control valve 1, the likelihood of contact between the rotating shaft 62 and the cover seal 23 is reduced, thereby facilitating the assembly.
(11) In contrast, in the present embodiment, the housing cover 20 is fixed to the housing 10 by a snap-fit.

According to this, compared to the case of using a fastening member such as a screw, the number of parts required for assembling and fixing the housing cover 20 to the housing 10 can be reduced.
(12) In contrast, in the present embodiment, the valve 60 includes the stopper 63 that regulates the rotation of the valve 60. The stopper 63 is provided at a portion different from a portion facing the housing cover 20.

If the stopper 63 is provided in the housing cover 20, a load at the time of regulating the rotation of the valve 60 is applied, via the housing cover 20, to the portion where the housing cover 20 is attached to the housing 10. Then, breakage may occur attached the portion where the housing cover 20 is attached to the housing 10. In contrast, according to the present embodiment, it is possible to avoid a load at the time of regulating the rotation of the valve 60 from being applied, via the housing cover 20, to the portion where the housing cover 20 is attached to the housing 10. Therefore, it is possible to avoid breakage of the portion where the housing cover 20 is attached to the housing 10.
(13) In contrast, according to the present embodiment, the housing 10 includes the bottom 12 that closes the second axial-center direction DRa2 side of the housing 10 on the second axial-center direction DRa2 side. The stopper 63 protrudes toward the bottom 12. The bottom 12 includes the rotation regulating portion 122 that is in contact with the stopper 63 to regulate the rotation of the valve 60.

According to this, compared to the case where the rotation regulating portion 122 is formed on the inner circumferential surface 16 of the housing 10 on which the seal member 70 is provided, the seal surface between the valve outer wall portion 61 and the cylinder 11 can be reliably ensured.
(14) In the above embodiment, the stopper 63 is formed extending in the axial-center direction DRa.

According to this, the stopper 63 can be easily brought into contact with the rotation regulating portion 122 provided on the bottom 12.

### Second Embodiment

Next, a second embodiment will be described with reference to FIGS. 17 to 20. The present embodiment differs from the first embodiment in the shapes of the housing 10, the valve 60, and the seal member 70. The other configurations are similar to those of the first embodiment. Therefore, in the present embodiment, the part that differs from the first embodiment will be mainly described, and the description of parts similar to those of the first embodiment may be omitted.

As illustrated in FIG. 17, the housing 10 of the present embodiment is larger in the axial-center direction DRa than that of the first embodiment. That is, the cylinder 11 of the present embodiment is larger in the axial-center direction DRa than the cylinder 11 of the first embodiment. To the cylinder 11 of the present embodiment, opening portions 49a, 49b are added compared to the first embodiment. That is, ten opening portions 41, 42, 43, 44, 45, 46, 47, 48, 49a, 49b are formed in the cylinder 11. These ten opening portions 41, 42, 43, 44, 45, 46, 47, 48, 49a, 49b are formed in a grid pattern, with five opening portions arranged in the axial-center direction DRa and the opening portions arranged in two columns in the circumferential direction DRc.

Hereinafter, the ten opening portions 41, 42, 43, 44, 45, 46, 47, 48, 49a, 49b are also referred to as ten opening portions 41 to 49b. The opening portion 49a is referred to as a fifth fluid inlet 49a. The opening portion 49b is referred to as a fifth fluid outlet 49b. The fifth fluid inlet 49a is an inlet port that allows fluid to flow into the valve accommodation space AS in the housing 10. The fifth fluid outlet 49b is an outlet port that allows the fluid flowing into the valve accommodation space AS in the housing 10 to flow out to the outside of the valve accommodation space AS.

The first fluid outlet 41, the first fluid inlet 42, the second fluid inlet 44, the second fluid outlet 43, and the fifth fluid outlet 49b are arranged from the first axial-center direction DRa1 toward the second axial-center direction DRa2 on the first circumferential direction DRc1 side. The third fluid inlet 45, the third fluid outlet 46, the fourth fluid outlet 48, the fourth fluid inlet 47, and the fifth fluid inlet 49a are arranged from the first axial-center direction DRa1 toward the second axial-center direction DRa2 on the second circumferential direction DRc2 side.

In the seal member 70 of the present embodiment, as the size in the axial-center direction DRa of the cylinder 11 increases, the size in the axial-center direction DRa increases compared to the first embodiment, as illustrated in FIG. 18. The five through-holes 71 formed in the seal member 70 are arranged in the axial-center direction DRa, and are formed corresponding to the ten opening portions 41 to 49b arranged in two columns in the circumferential direction DRc. Specifically, in the seal member 70 of the present embodiment, the through-holes 71 arranged in five rows in the axial-center direction DRa and arranged in four columns in the circumferential direction DRc are formed.

In the present embodiment, the through-holes 71 are provided in one additional column on each of one side and the other side in the circumferential direction DRc with respect to the ten opening portions 41 to 49b, which are arranged in two columns in the circumferential direction DRc. That is, the seal member 70 includes the group of through-holes 71 in one column on the first axial-center direction DRa1 side and the group of through-holes 71 in one column on the second axial-center direction DRa2 side, formed at positions not facing the ten opening portions 41 to 49b in the circumferential direction DRc.

The portions of the seal member 70 forming the groups of the through-holes 71 in the two central columns surround the ten opening portions 41 to 49b, and reduce mixture of the fluid passing through each of the ten opening portions 41 to 49b. In the seal member 70, the group of through-holes 71 in one column formed at the end portion on the first circumferential direction DRc1 side and the group of through-holes 71 in one column formed at the end portion on the second circumferential direction DRc2 side surround the fluid passage not facing the ten opening portions 41 to 49b. Thus, the seal member 70 seals the fluid passage in which the group of through-holes 71 in one column formed at the end portion on each of the first circumferential direction DRc1 side and the second circumferential direction DRc2 side does not face the ten opening portions 41 to 49b.

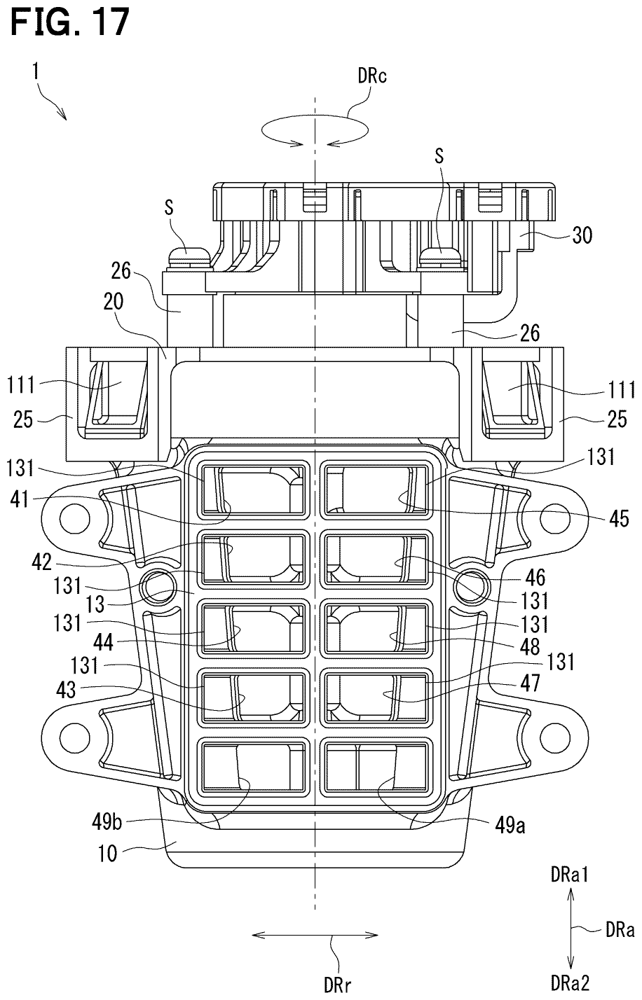

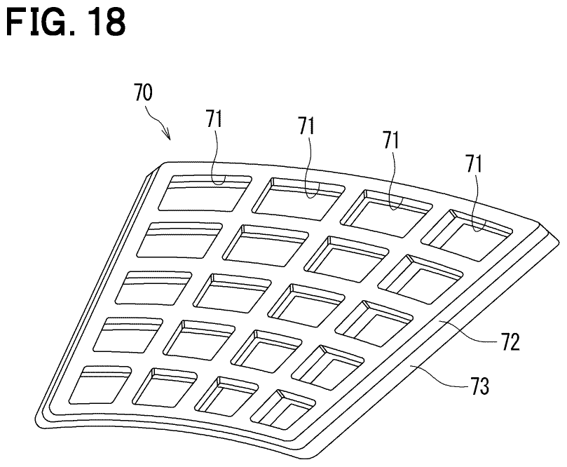

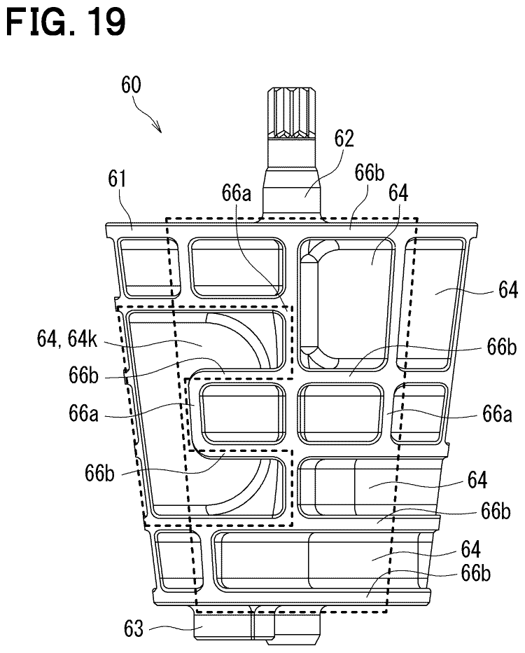

As illustrated in FIG. 19, in the valve 60 of the present embodiment, a plurality of fluid passages 64 are formed corresponding to the ten opening portions 41 to 49b, with five opening portions arranged in the axial-center direction DRa and the opening portions arranged in two columns in the circumferential direction DRc. In the valve outer wall portion 61, an eleventh fluid passage 64k is formed corresponding to the ninth fluid passage 64i in the first embodiment among the plurality of fluid passages 64.

Specifically, the eleventh fluid passage 64k can straddle five opening portions adjacent to each other in either the axial-center direction DRa or the circumferential direction DRc. When positioned at a position facing the ten opening portions 41 to 49b by the rotation of the valve 60 in the circumferential direction DRc, the eleventh fluid passage 64k can face the second-row opening portion and the fourth-row opening portion, or can face the second-row opening portion to the fourth-row opening portion.

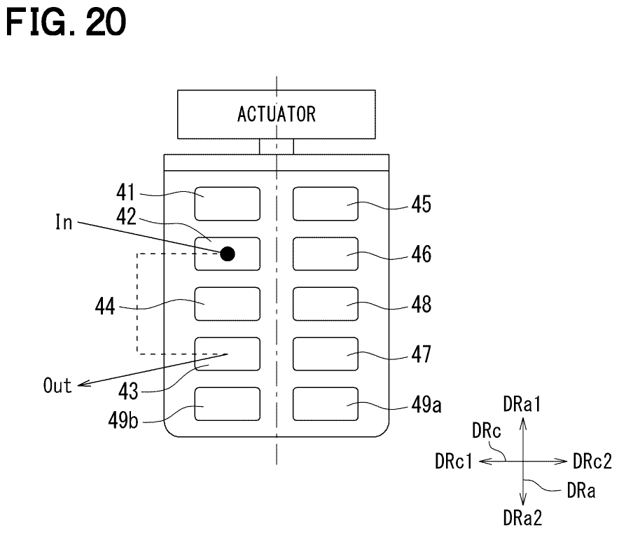

Here, in the eleventh fluid passage 64k, when the second circumferential direction DRc2 is positioned at a position facing the first-column opening portion, the first circumferential direction DRc1 side does not face the ten opening portions 41 to 49b. Then, the eleventh fluid passage 64k allows the first fluid inlet 42 and the second fluid outlet 43, which are not adjacent to each other, to communicate via a portion on the first circumferential direction DRc1 side not facing the ten opening portions 41 to 49b. Thus, as illustrated in FIG. 20, the fluid control valve 1 enables the fluid flowing into the valve 60 from the first fluid inlet 42 to flow to the second fluid outlet 43 via the portion of the eleventh fluid passage 64k on the first circumferential direction DRc1 side.

Here, when the fluid flowing in from the second fluid inlet 44 flows to the second fluid outlet 43, the fluid flows while bypassing the portions of the valve outer wall portion 61 facing the ten opening portions 41 to 49b in the eleventh fluid passage 64k. The portion forming one column on the first circumferential direction DRc1 side, which is a portion allowing the flow while bypassing the portions facing the ten opening portions 41 to 49b, in the eleventh fluid passage 64k is surrounded by the portion forming the group of through-holes 71 in one column on the first circumferential direction DRc1 side in the seal member 70. This leads to a reduction in the leakage of the fluid flowing through the portion forming the one column on the first circumferential direction DRc1 side in the eleventh fluid passage 64k from the gap between the outer circumferential surface 611 of the valve outer wall portion 61 and the inner circumferential surface 16 of the cylinder 11.

The other configurations are similar to those of the first embodiment. As in the first embodiment, the fluid control valve 1 of the present embodiment can obtain an effect obtained from a configuration common to or equivalent to that of the first embodiment.

### Third Embodiment

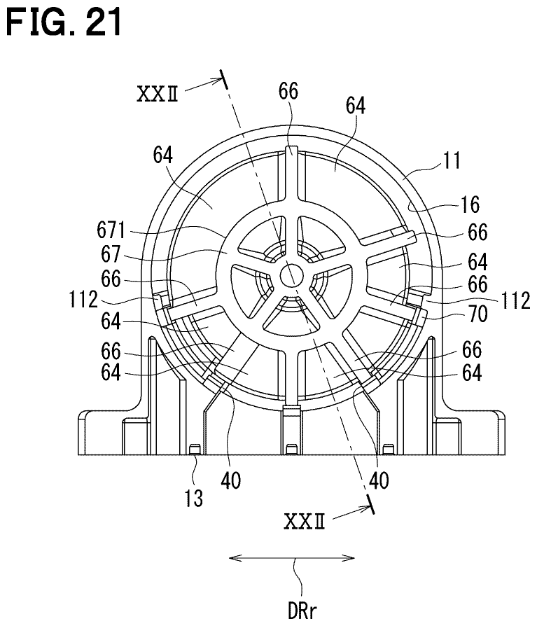

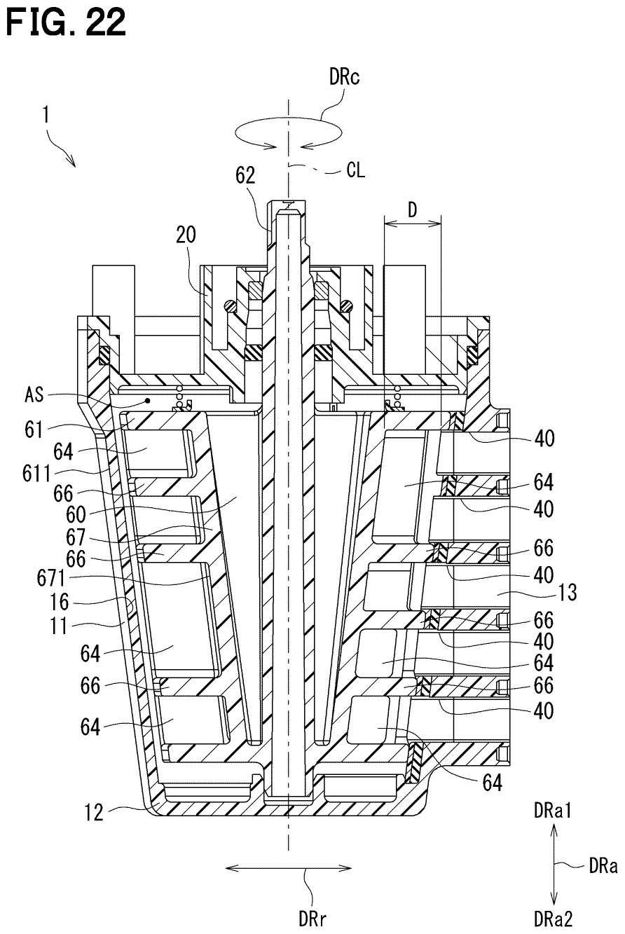

Next, a third embodiment will be described with reference to FIGS. 21 to 22. The present embodiment differs from the first embodiment in the shape of the valve 60. The other configurations are similar to those of the first embodiment. Therefore, in the present embodiment, the part that differs from the first embodiment will be mainly described, and the description of parts similar to those of the first embodiment may be omitted.

As illustrated in FIGS. 21 and 22, the valve 60 of the present embodiment includes an inner cylinder 67 that limits the size of the plurality of fluid passages 64 in the radial direction DRr. The inner cylinder 67 has a cylindrical shape and is formed such that the central axis is coaxial with the axial center CL.

As illustrated in FIG. 22, the inner cylinder 67 is formed from the end portion on the first axial-center direction DRa1 side to the end portion on the second axial-center direction DRa2 side along the axial-center direction DRa inside the valve 60. The inner cylinder 67 is formed in a substantially conical shape with the outer diameter decreasing from the first axial-center direction DRa1 toward the second axial-center direction DRa2. That is, the inner cylinder 67 is formed in a substantially conical shape with the apex on the second axial-center direction DRa2 side and the bottom on the first axial-center direction DRa1 side. In other words, in the cross-section of the inner cylinder 67 orthogonal to the axial center CL, the distance from the axial center CL to the outer shell decreases from the first axial-center direction DRa1 toward the second axial-center direction DRa2.

The inner cylinder 67 has a conical shape along the cylinder 11. That is, an outer side surface 671 forming the outer shell of the inner cylinder 67 is shaped along the side surface of the conical shape similar to the cylinder 11. In other words, the portion of the outer side surface 671 of the inner cylinder 67 facing the inner circumferential surface 16 of the cylinder 11 is substantially parallel to the inner circumferential surface, and the distance in the radial direction DRr between the outer side surface 671 and the inner circumferential surface 16 is substantially constant.

Here, the distance in the radial direction DRr between the outer side surface 671 and the inner circumferential surface 16 is defined as a distance D. According to the present embodiment, the distance D of each of the first fluid passage 64a to the tenth fluid passage 64j formed in the section in any of the first row, the second row, the third row, and the fourth row is constant.

In the first embodiment, the distance in the radial direction DRr of each of the first fluid passage 64a to the tenth fluid passage 64j formed in the section in any of the first row, the second row, the third row, and the fourth row decreases from the first axial-center direction DRa1 toward the second axial-center direction DRa2. For this reason, when the fluid flowing through each of the first fluid passage 64a to the tenth fluid passage 64j flows to a different row in the axial-center direction DRa, the flow path area decreases, and a pressure loss may occur.

In contrast, in the present embodiment, since the distance D of each of the first fluid passage 64a to the tenth fluid passage 64j formed in the section in any of the first row, the second row, the third row, and the fourth row is constant, he occurrence of a pressure loss due to a decrease in flow path area can be reduced.

The other configurations are similar to those of the first embodiment. As in the first embodiment, the fluid control valve 1 of the present embodiment can obtain an effect obtained from a configuration common to or equivalent to that of the first embodiment.

### Fourth Embodiment

Next, a fourth embodiment will be described with reference to FIGS. 23 to 25. The present embodiment differs from the first embodiment in a method of attaching the drive unit 30 and the housing cover 20 to the housing 10. The other configurations are similar to those of the first embodiment. Therefore, in the present embodiment, the part that differs from the first embodiment will be mainly described, and the description of parts similar to those of the first embodiment may be omitted.

As illustrated in FIG. 23, on the first axial-center direction DRa1 side of the cylinder 11, a housing screw hole 113 into which the screw member S for fixing the housing cover 20 is inserted is provided in addition to the claw portion 111 for attaching the housing cover 20.

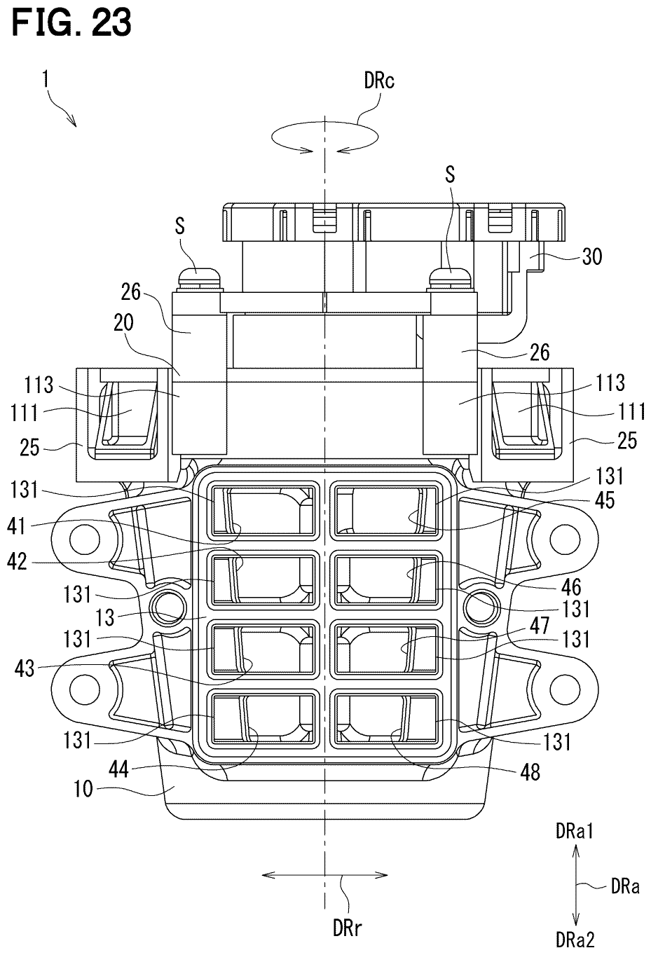

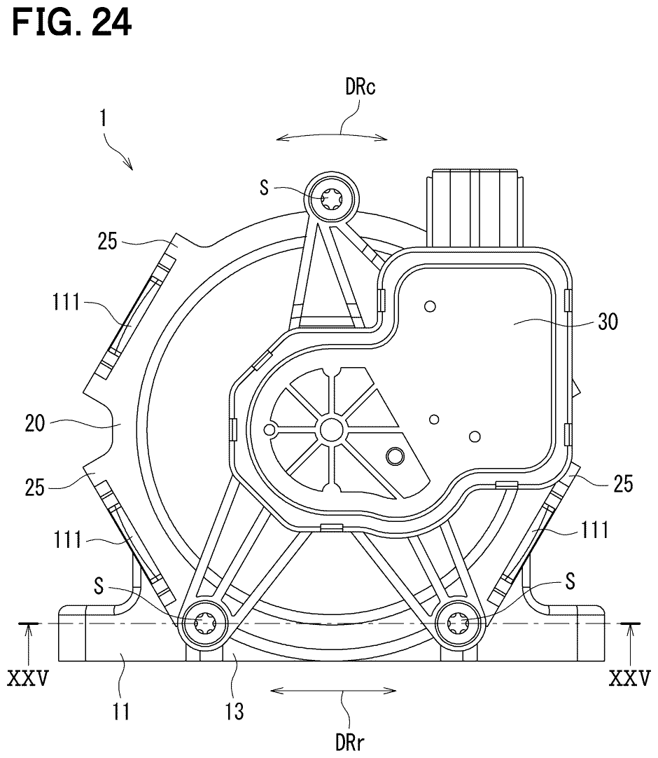

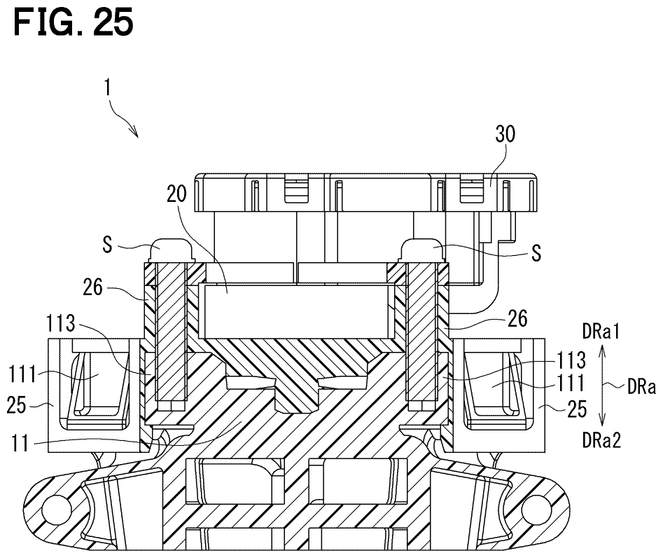

The housing cover 20 includes the cover screw receiving portion 26 for insertion of the screw member S that is inserted into the housing screw hole 113 provided in the cylinder 11. As illustrated in FIG. 25, the central axes of the housing screw hole 113 and the cover screw receiving portion 26 coincide with each other. The housing cover 20 is fastened and fixed by the screw member S that is inserted into the housing screw hole 113 and the cover screw receiving portion 26. In other words, the housing cover 20 is fixed to the cylinder 11 by a snap-fit and is fixed by the screw member S. As the screw member S, for example, various screws such as countersunk screws and tapping screws can be employed.

The drive unit 30 is fixed to the housing cover 20 by the screw member S for attaching the housing cover 20 to the cylinder 11. That is, the housing cover 20 and the drive unit 30 are fastened and fixed together to the cylinder 11 by the screw member S.

As described above, in the present embodiment, the drive unit 30 and the housing cover 20 are fastened and fixed together to the housing 10 by the screw member S.

According to this, the number of parts necessary for assembling and fixing the drive unit 30 and the housing cover 20 to the housing 10 can be reduced.

The other configurations are similar to those of the first embodiment. As in the first embodiment, the fluid control valve 1 of the present embodiment can obtain an effect obtained from a configuration common to or equivalent to that of the first embodiment.

### Modification of Fourth Embodiment

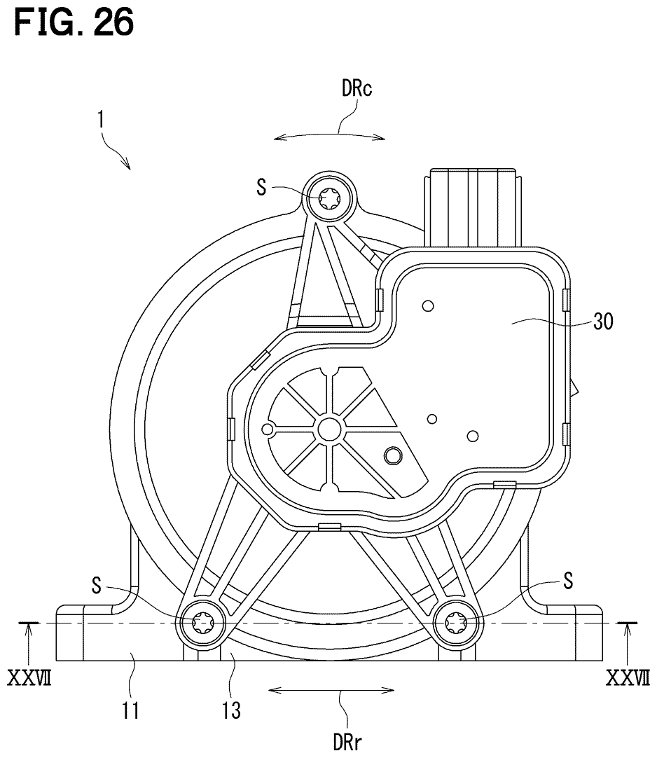

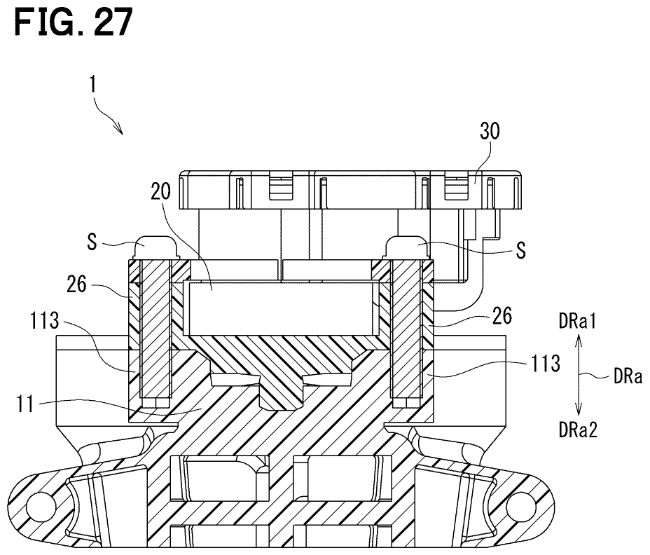

In the fourth embodiment described above, an example in which the housing cover 20 is fixed to the cylinder 11 by the snap-fit and is fixed by the screw member S has been described, but the present disclosure is not limited thereto. For example, when the housing cover 20 and the drive unit 30 are fastened together to the cylinder 11 by the screw member S, the housing cover 20 may not be fixed to the cylinder 11 by the snap-fit, as illustrated in FIGS. 26 and 27. In this case, the fluid control valve 1 may have a configuration in which the cylinder 11 is not provided with the claw portion 111 and the housing cover 20 is not provided with the engagement receiving portion 25.

### Fifth Embodiment

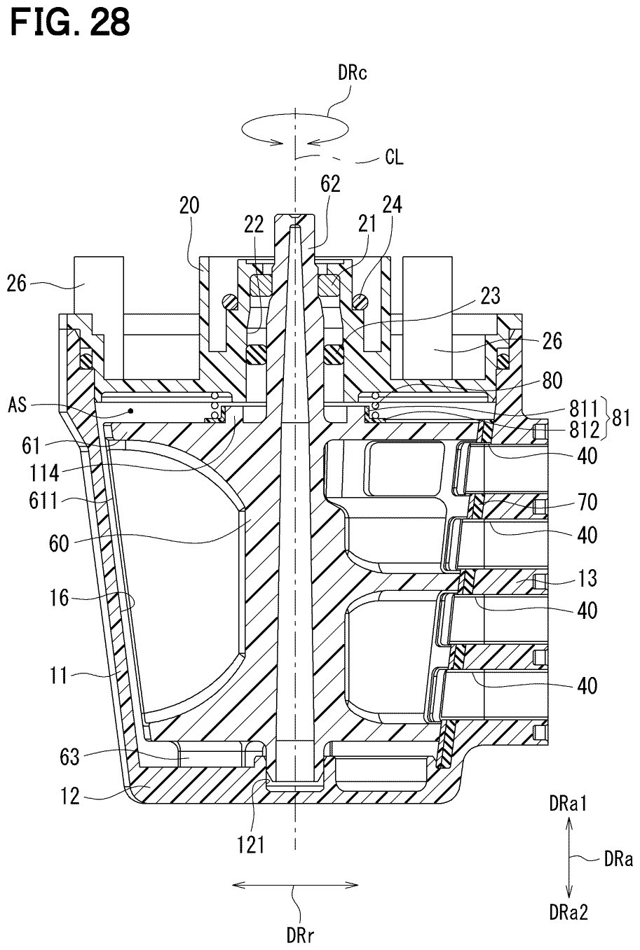

Next, a fifth embodiment will be described with reference to FIG. 28. The present embodiment differs from the first embodiment in a method of installing the biasing portion 80. The other configurations are similar to those of the first embodiment. Therefore, in the present embodiment, the part that differs from the first embodiment will be mainly described, and the description of parts similar to those of the first embodiment may be omitted.

As illustrated in FIG. 28, on the first axial-center direction DRa1 side of the valve 60 of the present embodiment, a protruding portion 114 protruding toward the first axial-center direction DRa1 side is provided The protruding portion 114 is provided inside the biasing portion 80 formed of a compression coil spring.

The biasing portion 80 has an L-shaped cross-section parallel to the axial center CL, and includes an inner surface in the radial direction in sliding contact with a protruding portion 460 provided on the first axial-center direction DRa1 side of the valve 60, and a surface on the first axial-center direction DRa1 side in sliding contact with the surface on the first axial-center direction DRa1 side of the valve 60.

According to this, the spring guide 81 can reduce the positional displacement of the biasing portion 80 in the radial direction DRr and transmit the biasing force of the biasing portion 80 to the valve 60.

The other configurations are similar to those of the first embodiment. As in the first embodiment, the fluid control valve 1 of the present embodiment can obtain an effect obtained from a configuration common to or equivalent to that of the first embodiment.

### Other Embodiments

Although the representative embodiments of the present disclosure have been described above, the present disclosure is not limited to the embodiments described above, and can be modified in various ways as follows, for example.

In each of the first embodiment and the second embodiment described above, an example of the shape of the valve 60 has been described, but the shape of the valve 60 is not limited thereto, and can be modified in various ways according to the system or the like in which the fluid control valve 1 is used. That is, the plurality of fluid passages 64 formed in the valve 60 can be formed in various shapes.

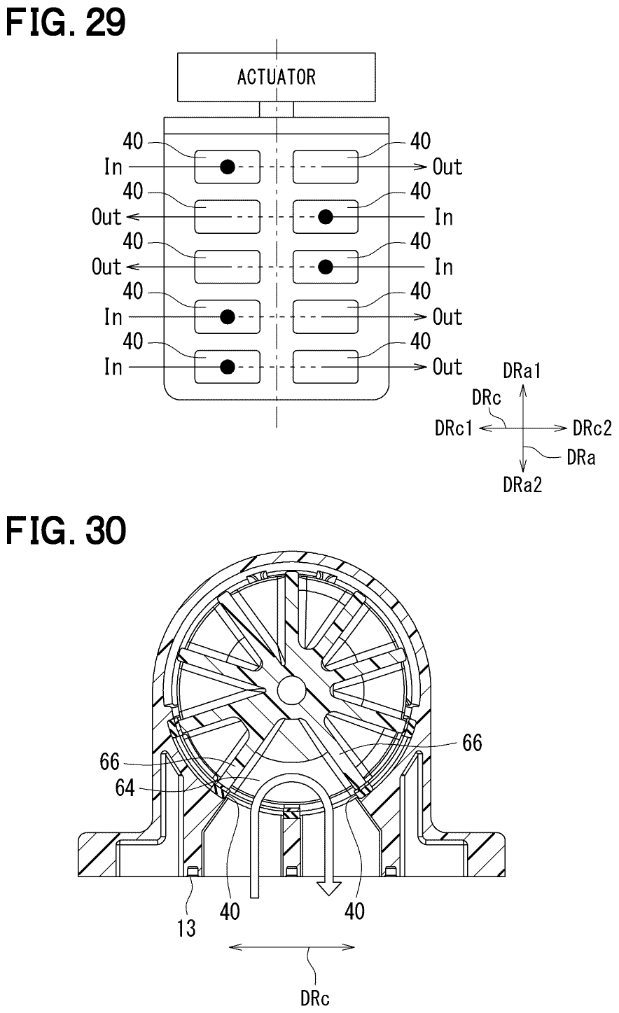

For example, as illustrated in FIG. 29, when the ten opening portions 40 are arranged in two columns in the circumferential direction DRc and arranged in five rows in the axial-center direction DRa, the valve 60 may be formed such that the fluid flowing in from one side in the circumferential direction DRc flows out from the other side in each row. In this case, the fluid passage 64 may be formed to straddle two opening portions 40 in the circumferential direction DRc, for example, as illustrated in FIG. 30.

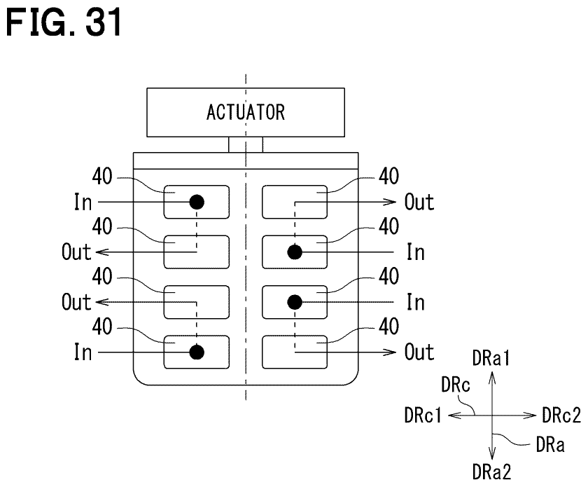

As illustrated in FIG. 31, when the eight opening portions 40 are arranged in two columns in the circumferential direction DRc and arranged in four rows in the axial-center direction DRa, the valve 60 may be formed such that the fluid flowing in from one side of the opening portions 40 adjacent to each other in the axial-center direction DRa flows out from the other side.

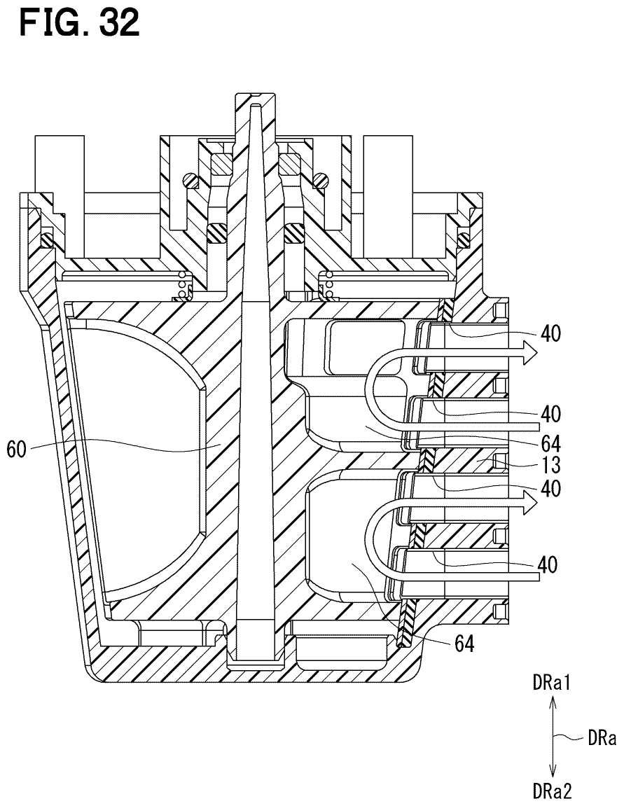

In this case, the fluid passage 64 may be formed to straddle two opening portions 40 in the axial-center direction DRa, for example, as illustrated in FIG. 32.

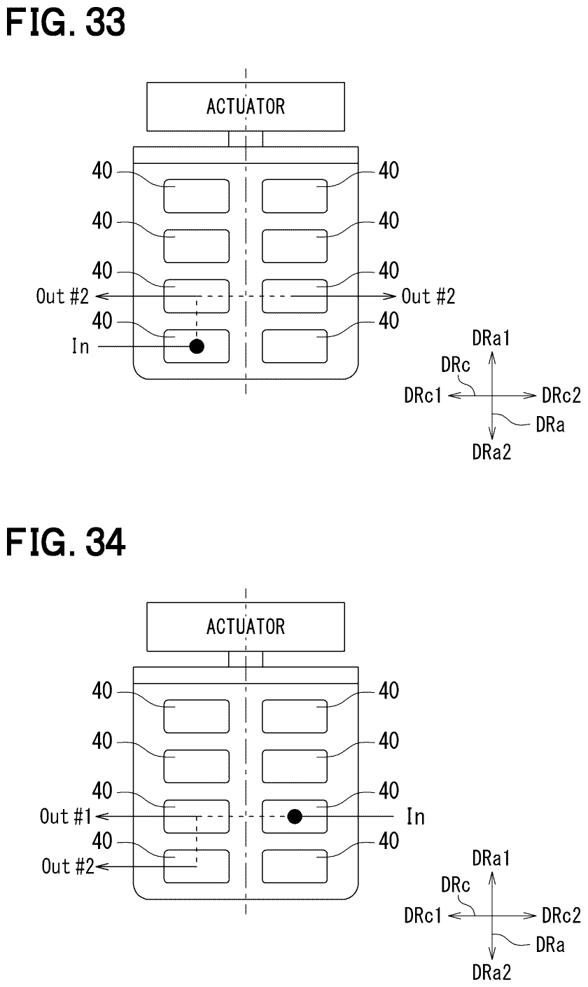

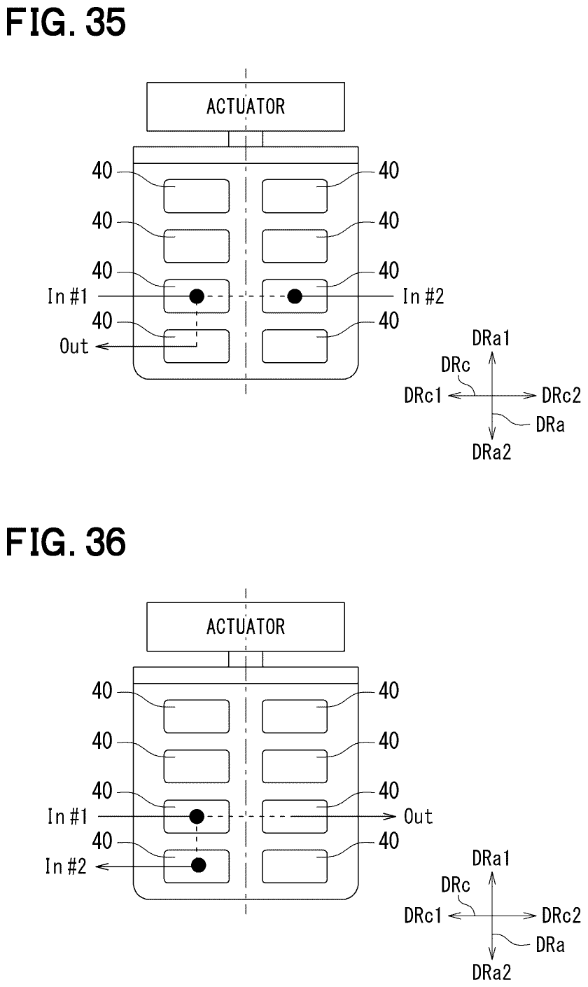

As illustrated in FIGS. 33 and 34, the valve 60 may be formed such that the fluid flowing in from one opening portion 40 flows out from two opening portions 40 among the plurality of opening portions 40. Alternatively, as illustrated in FIGS. 35 and 36, the valve 60 may be formed such that the fluid flowing in from two opening portions 40 flows out from one opening portion 40 among the plurality of opening portions 40.

In this case, for example, as indicated by a dashed line in FIG. 37, the fluid passage 64 may be formed to straddle two opening portions 40 in the axial-center direction DRa and straddle two opening portions 40 in the circumferential direction DRc.

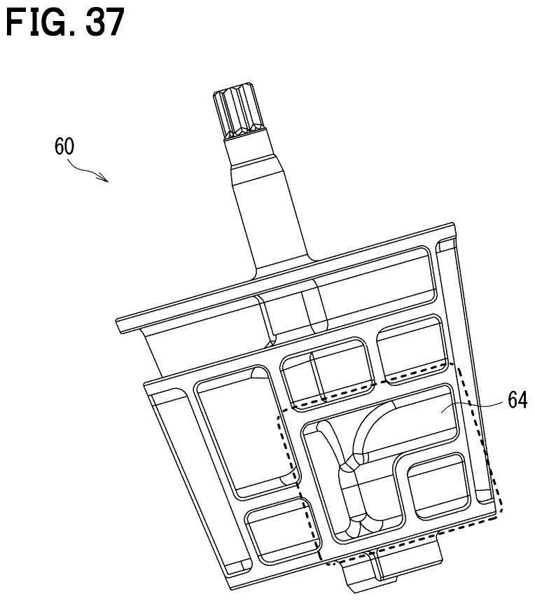

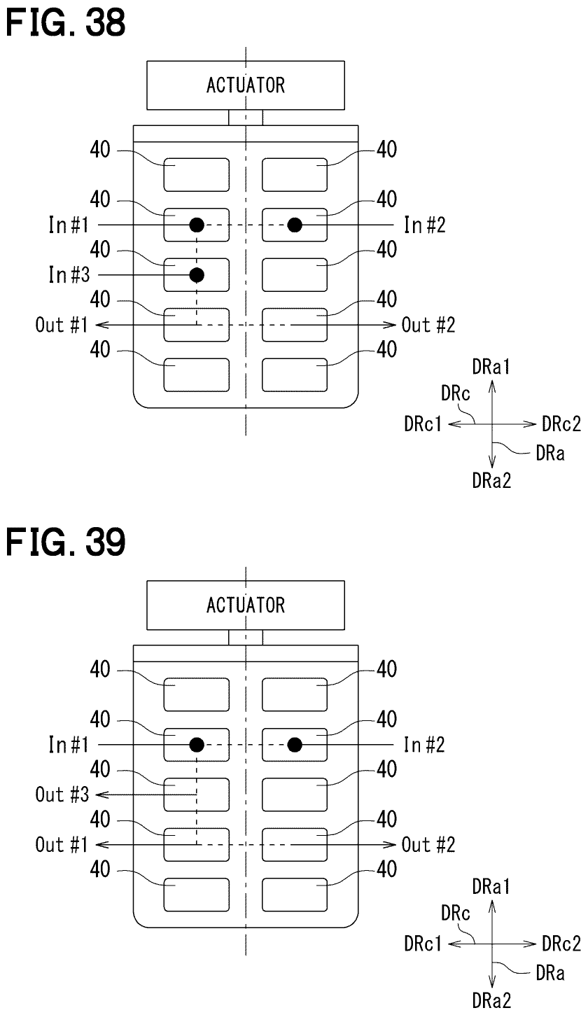

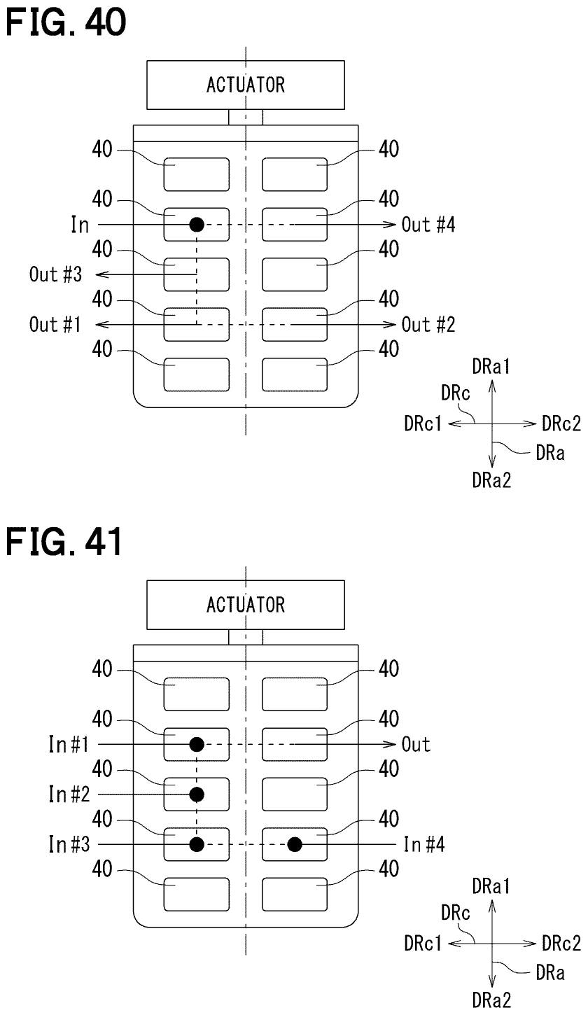

As illustrated in FIG. 38, the valve 60 may be formed such that the fluid flowing in from three opening portions 40 flows out from two opening portions 40 among the plurality of opening portions 40. Alternatively, as illustrated in FIG. 39, the valve 60 may be formed such that the fluid flowing in from two opening portions 40 flows out from three opening portions 40 among the plurality of opening portions 40. Alternatively, as illustrated in FIG. 40, the valve 60 may be formed such that the fluid flowing in from one opening portion 40 flows out from the four opening portions 40 among the plurality of opening portions 40. Alternatively, as illustrated in FIG. 41, the valve 60 may be formed such that the fluid flowing in from four opening portions 40 flows out from one opening portion 40 among the plurality of opening portions 40.

In this case, for example, as indicated by a dashed line in FIG. 42, the fluid passage 64 may be formed to straddle three opening portions 40 in the axial-center direction DRa and straddle two opening portions 40 in the circumferential direction DRc at the one-side end portion and the other-side end portion in the axial-center direction DRa.

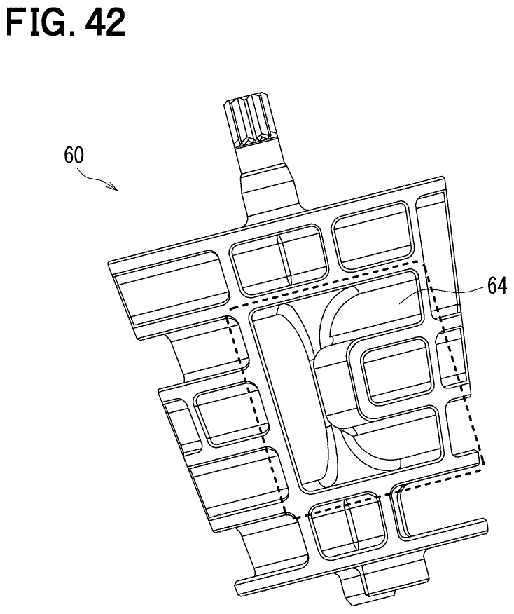

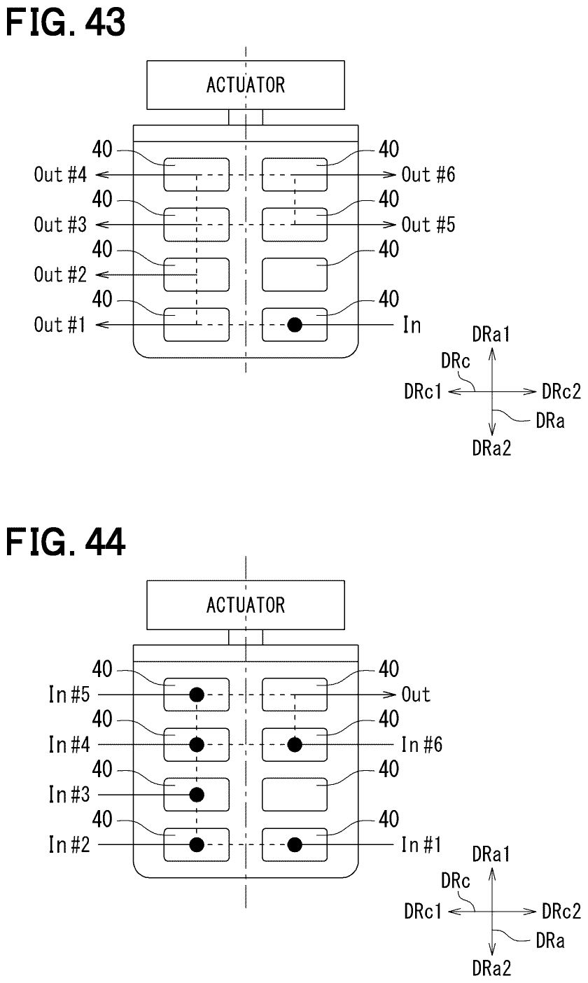

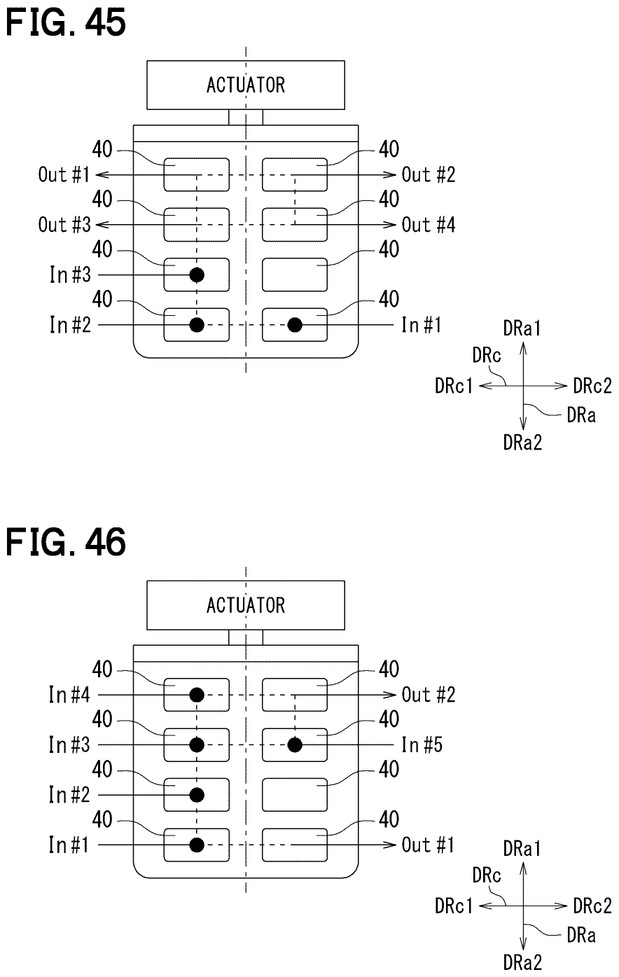

As illustrated in FIG. 43, the valve 60 may be formed such that the fluid flowing in from one opening portion 40 flows out from six opening portions 40 among the plurality of opening portions 40. Alternatively, as illustrated in FIG. 44, the valve 60 may be formed such that the fluid flowing in from six opening portions 40 flows out from one opening portion 40 among the plurality of opening portions 40. Alternatively, as illustrated in FIG. 45, the valve 60 may be formed such that the fluid flowing in from the three opening portions 40 flows out from the four opening portions 40 among the plurality of opening portions 40. Alternatively, as illustrated in FIG. 46, the valve 60 may be formed such that fluid flowing in from five opening portions 40 flows out from two opening portions 40 among the plurality of opening portions 40. Alternatively, although not illustrated, the valve 60 may be formed such that the fluid flowing in from two opening portions 40 flows out from five opening portions 40 among the plurality of opening portions 40. Alternatively, although not illustrated, the valve 60 may be formed such that the fluid flowing in from four opening portions 40 flows out from three opening portions 40 among the plurality of opening portions 40.

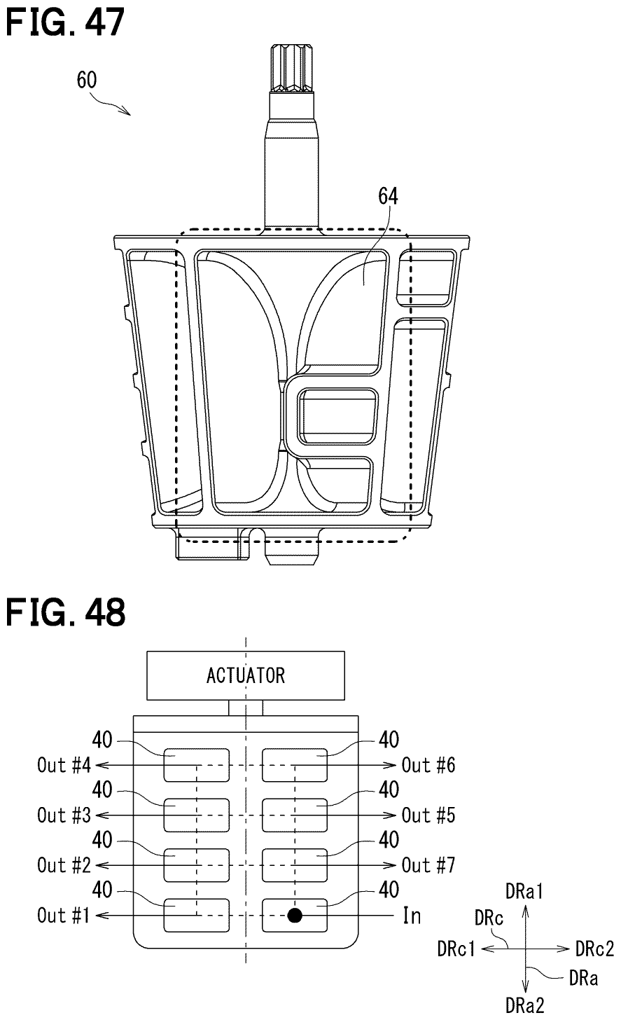

In this case, for example, as indicated by a dashed line in FIG. 47, the fluid passage 64 may be formed to straddle four opening portions 40 in the axial-center direction DRa and straddle two opening portions 40 in the circumferential direction DRc at the one-side end portion and the other-side end portion in the axial-center direction DRa. Furthermore, in the portion straddling the two opening portions 40 in the circumferential direction DRc, the portion may also be formed to straddle two opening portions 40 in the axial-center direction DRa.

As illustrated in FIG. 48, the valve 60 may be formed such that the fluid flowing in from one opening portion 40 flows out from seven opening portions 40 among the plurality of opening portions 40.

In this case, for example, as indicated by a dashed line in FIG. 49, the fluid passage 64 may be formed to straddle four opening portions 40 in the axial-center direction DRa and straddle two opening portions 40 in the circumferential direction DRc. That is, when the valve 60 is positioned at a position facing all of the plurality of opening portions 40, the rib 66 is not formed at any position facing the partition 50 that separates the opening portions 40.

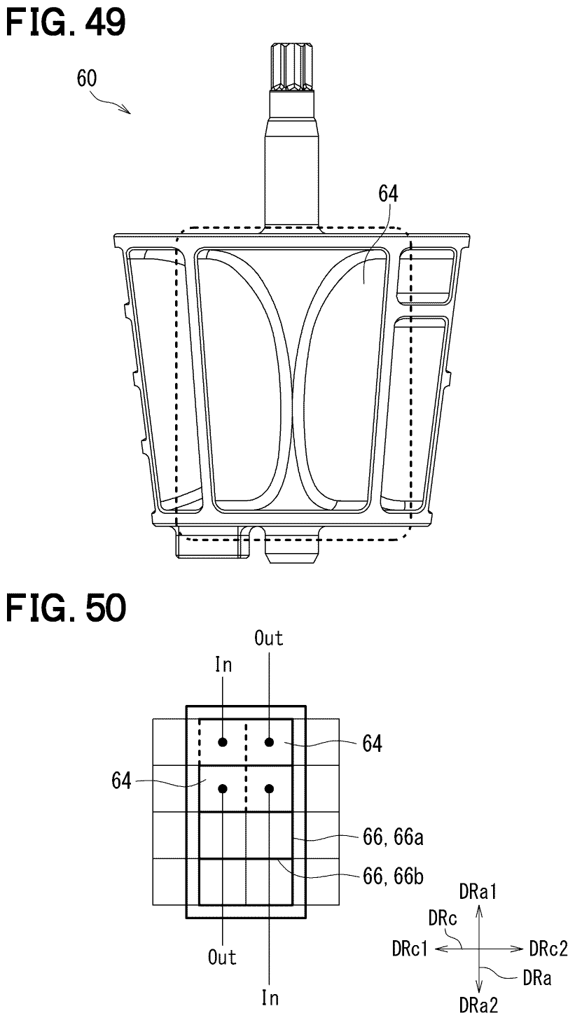

The shape of the fluid passage 64 described above is an example and is not limited thereto. Various shapes of the fluid passage 64 will be described with reference to FIGS. 10 to 11 using schematic views similar to FIGS. 50 and 62 of the first embodiment. In FIGS. 50 to 62, a lattice surrounded by a thick line indicates a portion facing the plurality of opening portions 40 in the valve 60. In the grid, a solid line indicates a portion where the rib 66 is formed. A dashed line indicates a portion where the rib 66 is not formed.

When the fluid flowing in from one side of the opening portions 40 adjacent to each other in the circumferential direction DRc flows out from the other side, as illustrated in FIG. 50, the fluid passage 64 may have a configuration in which the rib 66 is not formed at a position facing the partition 50 that separates the opening portions 40 adjacent to each other. In this case, the fluid passage 64 may have a shape in which the rib 66 fully surrounds two sections, or may have a shape in which the axial-side rib 66a is not provided on one side or the other side in the circumferential direction DRc.

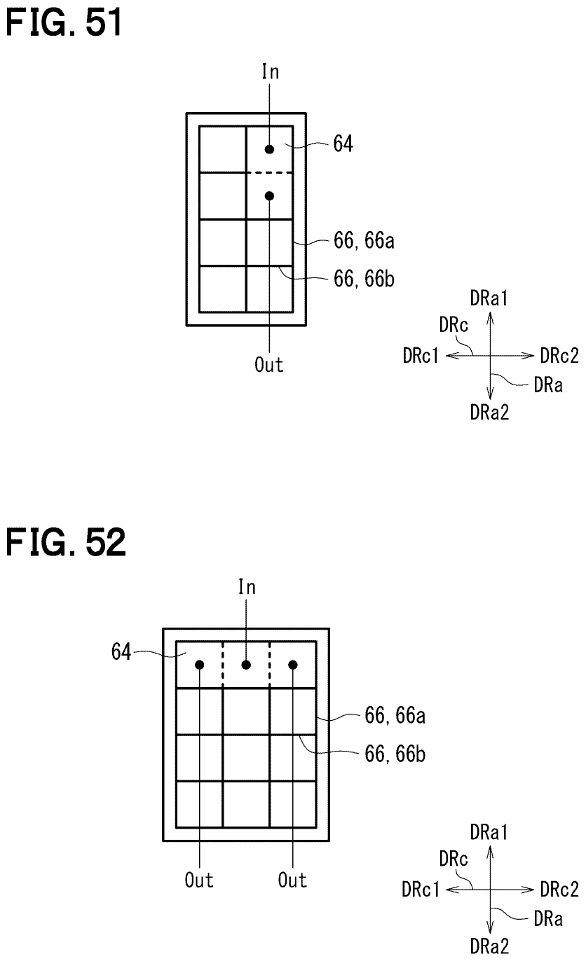

When the fluid flowing in from one side of the opening portions 40 adjacent to each other in the axial-center direction DRa flows out from the other side, as illustrated in FIG. 51, the fluid passage 64 may have a configuration in which the rib 66 is not formed at a position facing the partition 50 that separates the opening portions 40 adjacent to each other. In this case, the fluid passage 64 may have a shape in which the rib 66 fully surrounds two sections, or may have a shape in which the circumferential-side rib 66b is not provided on one side or the other side in the axial-center direction DRa.

When the fluid flowing in from one of the three opening portions 40 adjacent to each other in the circumferential direction DRc flows out from the remaining two, the fluid passage 64 may have a configuration in which the rib 66 is not formed at a position facing the partition 50 that separates the three opening portions 40 adjacent to each other.

For example, as illustrated in FIG. 52, a case will be described where the fluid flowing in from the middle opening portion 40 among the three opening portions 40 adjacent to each other in the circumferential direction DRc is allowed to flow out from the opening portions 40 on one side and the other side in the circumferential direction DRc with respect to the middle opening portion 40. In this case, the fluid passage 64 may have a shape in which the axial-side rib 66a is not provided at a position facing the partition 50 that separates one side and the other side in the circumferential direction DRc of the middle opening portion 40.

When the fluid flowing in from one of the three opening portions 40 adjacent to each other in the axial-center direction DRa flows out from the remaining two, the fluid passage 64 may have a configuration in which the rib 66 is not formed at a position facing the partition 50 that separates the three opening portions 40 adjacent to each other.

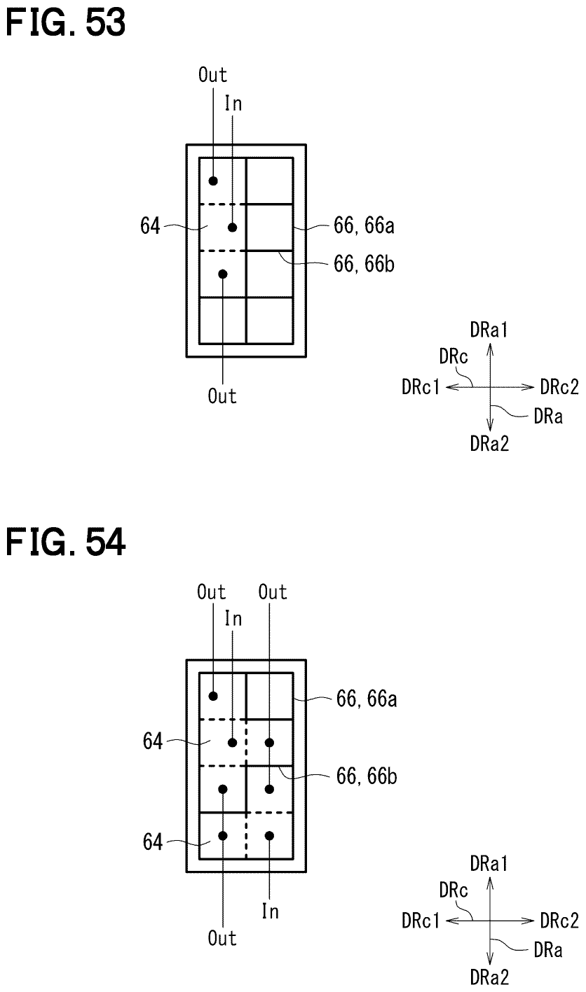

For example, as illustrated in FIG. 53, a case will be considered where the fluid flowing in from the middle opening portion 40 among the three opening portions 40 adjacent to each other in the axial-center direction DRa flows out from the opening portions 40 on one side and the other side in the axial-center direction DRa with respect to the middle opening portion 40. In this case, the fluid passage 64 may have a shape in which the circumferential-side rib 66b is not provided at a position facing the partition 50 that separates one side and the other side in the axial-center direction DRa of the middle opening portion 40.

When the opening portion 40 for fluid outflow in each of the axial-center direction DRa and the circumferential direction DRc are provided with respect to the opening portion 40 for fluid outflow, the fluid passage 64 may have a configuration in which the rib 66 is not formed at a position facing the partition 50 that separates the plurality of opening portions 40 adjacent to each other.

For example, as illustrated in FIG. 54, a case will be considered where the opening portion 40 for fluid outflow is provided on one side or both sides in the axial-center direction DRa with respect to the opening portion 40 for fluid inflow, and the opening portion 40 for fluid outflow is provided only on one side in the circumferential direction DRc. In this case, the fluid passage 64 may have a shape in which the axial-side rib 66a and the circumferential-side rib 66b are not provided at positions facing the partition 50 that separates the opening portion 40 for fluid outflow and the opening portion 40 for fluid inflow, respectively.

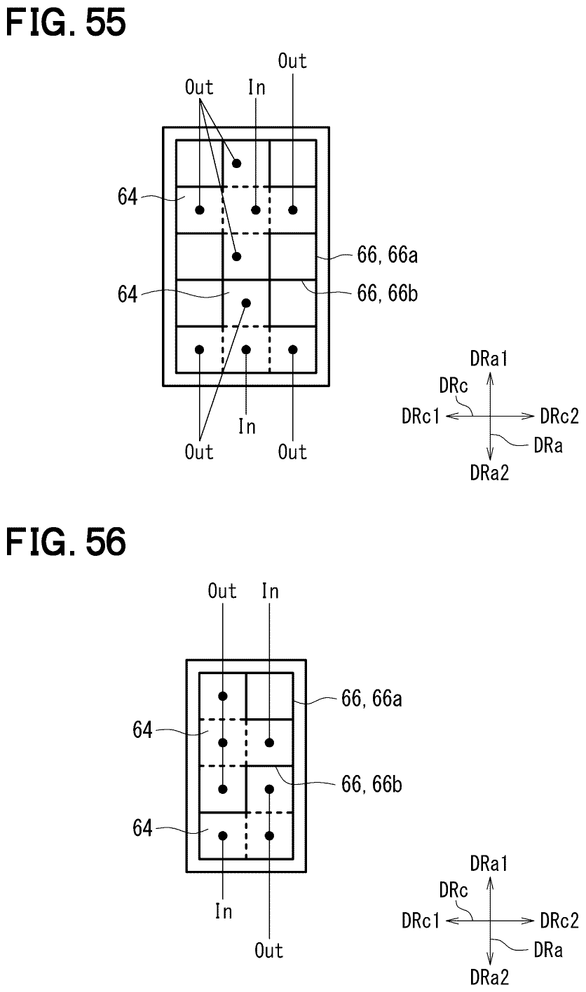

In addition, as illustrated in FIG. 55, a case will be considered where the opening portion 40 for fluid outflow is provided on one side or both sides in the axial-center direction DRa with respect to the opening portion 40 for fluid outflow, and the opening portion 40 for fluid outflow is provided on both sides in the circumferential direction DRc. In this case, the fluid passage 64 may have a shape in which the axial- side rib 66a and the circumferential-side rib 66b are not provided at positions facing the partition 50 that separates the opening portion 40 for fluid outflow and the opening portion 40 for fluid inflow, respectively.

In addition, as illustrated in FIG. 56, a case will be considered where the opening portion 40 for fluid outflow is provided only on one side in the circumferential direction DRc with respect to the opening portion 40 for fluid inflow, and the opening portion 40 for fluid outflow in the axial-center direction DRa is not provided. In this case, the fluid passage 64 may have a shape in which the axial-side rib 66a is not provided at each of positions facing the partition 50 that separates the opening portion 40 for fluid outflow and the opening portion 40 for fluid inflow.

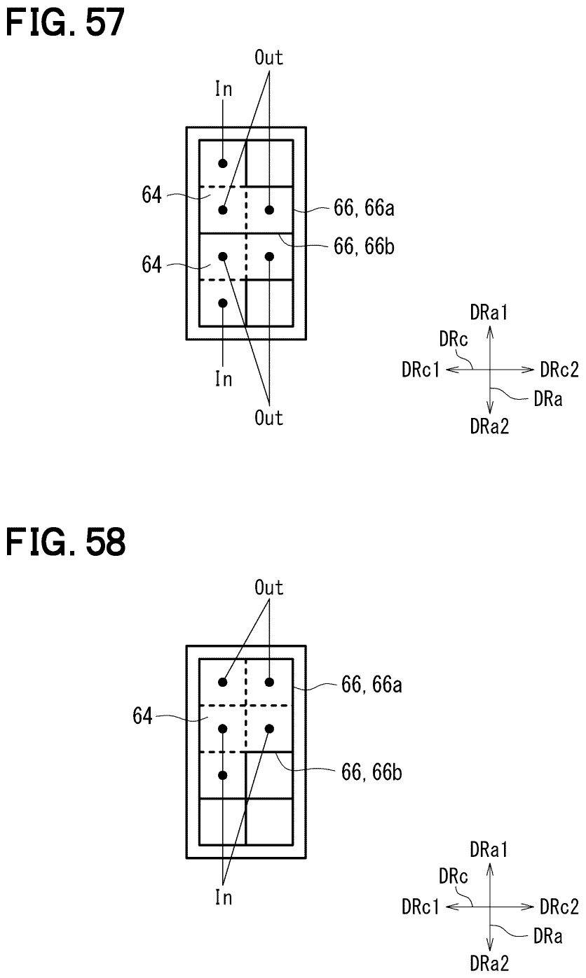

In addition, as illustrated in FIG. 57, a case will be considered where the opening portion 40 for fluid outflow is provided only on one side in the axial-center direction DRa with respect to the opening portion 40 for fluid inflow, and the opening portion 40 for fluid outflow in the circumferential direction DRc is not provided. In this case, the fluid passage 64 may have a shape in which the circumferential-side rib 66b is not provided at each position facing the partition 50 that separates the opening portion 40 for fluid outflow and the opening portion 40 for fluid inflow.

When the opening portions 40 for fluid inflow are arranged in at least one of the circumferential direction DRc or the axial-center direction DRa and the opening portions 40 for fluid outflow are arranged in at least one of the circumferential direction DRc or the axial-center direction DRa, the fluid passage 64 may have a configuration in which the rib 66 is not formed at a position facing the partition 50 that separates the plurality of opening portions 40 adjacent to each other.

For example, as illustrated in FIG. 58, a case where the opening portions 40 for fluid inflow are arranged in the circumferential direction DRc and the axial-center direction DRa, and the opening portions 40 for fluid outflow are arranged in the circumferential direction DRc will be considered. In this case, the fluid passage 64 may have a shape in which the axial-side rib 66a and the circumferential-side rib 66b are not provided at positions facing the partition 50 that separates the opening portion 40 for fluid outflow and the opening portion 40 for fluid inflow, respectively.

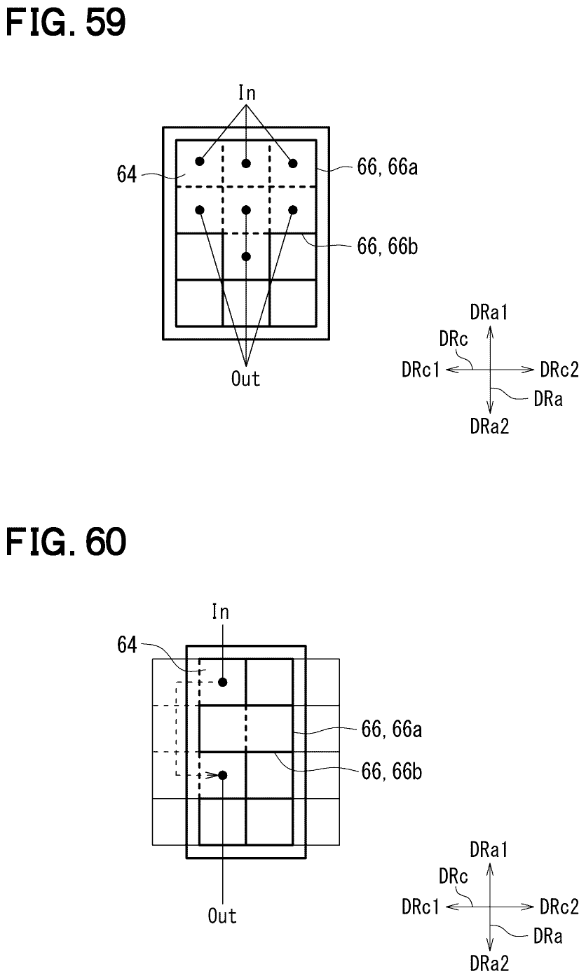

In addition, as illustrated in FIG. 59, a case will be considered where the opening portions 40 for fluid inflow are arranged in the circumferential direction DRc, and the opening portions 40 for fluid outflow are arranged in each of the axial-center direction DRa and the circumferential direction DRc. In this case, the fluid passage 64 may have a shape in which the axial-side rib 66a and the circumferential-side rib 66b are not provided at positions facing the partition 50 that separates the opening portion 40 for fluid outflow and the opening portion 40 for fluid inflow, respectively.

When the opening portion 40 for fluid inflow and the opening portion 40 for fluid outflow are provided at positions not adjacent to each other in the axial-center direction DRa, the fluid passage 64, which communicates the non-adjacent opening portions 40, is not provided with the axial-side rib 66a at a position facing the outer peripheral partition 53 that separates the opening portions 40 not adjacent to each other.

For example, as illustrated in FIG. 60, the opening portion 40 for fluid inflow at the end portion on the first circumferential direction DRc1 side is defined as an end-portion fluid inlet, and the opening portion 40 for fluid outflow at the end portion on the first circumferential direction DRc1 side is defined as an end-portion fluid outlet. In this case, the fluid passage 64 may have a shape in which the axial-side rib 66a is not provided in the axial-side partition 52, which separates the end-portion fluid inlet, at a position facing the axial-side partition 52 on the side where the opening portion 40 does not exist with respect to the end-portion fluid inlet in the circumferential direction DRc. The fluid passage 64 may have a shape in which the axial-side rib 66a is not provided in the axial-side partition 52, which separates the end-portion fluid outlet, at a position facing the axial-side partition 52 on the side where the opening portion 40 does not exist with respect to the end-portion fluid outlet in the circumferential direction DRc.

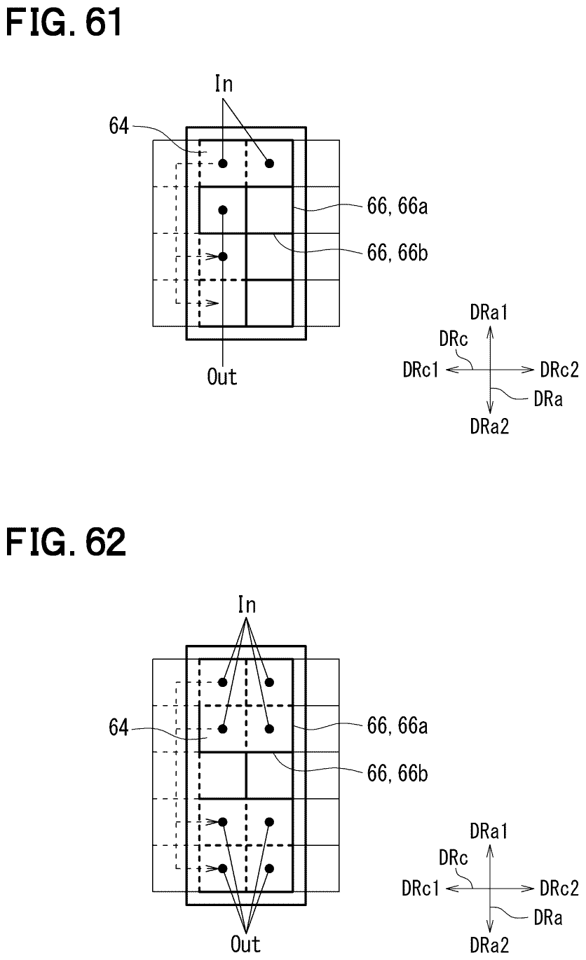

As illustrated in FIG. 61, when two end-portion fluid outlets are arranged in the axial-center direction DRa, the fluid passage 64 may have a shape in which, between the axial-side partitions 52 that separate the two end-portion fluid outlets, the axial-side rib 66a is not provided at either position facing the axial-side partition 52 on the side where the opening portion 40 does not exist with respect to the end-portion fluid outlet in the circumferential direction DRc.

As illustrated in FIG. 62, when two end-portion fluid inlets are arranged in the axial-center direction DRa, the fluid passage 64 may have a shape in which, between the axial-side partitions 52 that separate the two end-portion fluid inlets, the axial-side rib 66a is not provided at either position facing the axial-side partition 52 on the side where the opening portion 40 does not exist with respect to the end-portion fluid inlet in the circumferential direction DRc.

As described above, the shape of the valve 60 can be modified in various ways. In addition, not only the valve 60 but also various components constituting the fluid control valve 1 can be modified in various ways as follows.

In the embodiment described above, an example has been presented in which the number of inlet ports and the number of outlet ports are the same, both being four among the eight opening portions 41 to 48, but the present disclosure is not limited thereto. For example, the number of inlet ports and the number of outlet ports may differ, such as three inlet ports and five outlet ports among the eight opening portions 41 to 48.

In the embodiment described above, an example has been described in which the number of through-hole columns of the through-holes 71 formed in the seal member 70 is set to two more than the number of opening columns, and one additional column is provided on each of one side and the other side in the circumferential direction DRc with respect to the eight opening portions 41 to 48. However, the present disclosure is not limited thereto. For example, the number of through-hole columns is set to one more than the number of opening columns, and one additional through-hole column may be provided on either one side or the other side in the circumferential direction DRc with respect to the eight opening portions 41 to 48. The number of through-hole columns is set to three or more than the number of opening columns, and one or more through-hole columns may be provided on each of one side and the other side in the circumferential direction DRc with respect to the eight opening portions 41 to 48.

In the embodiment described above, an example has been described in which the ninth fluid passage 64i that guides the fluid flowing in from the second fluid inlet 44 to the valve outer wall portion 61 to the first fluid outlet 41 while bypassing the portions facing the eight opening portions 41 to 48 in the valve outer wall portion 61 is formed, but the present disclosure is not limited thereto. For example, the valve outer wall portion 61 may have a configuration in which the ninth fluid passage 64i that guides the fluid flowing in from the second fluid inlet 44 to the first fluid outlet 41 while bypassing the portions facing the eight opening portions 41 to 48 in the valve outer wall portion 61 is not formed.

In the embodiment described above, an example has been described where the ninth fluid passage 64i is surrounded by the seal member 70 at a position not facing the eight opening portions 41 to 48 in the valve outer wall portion 61, but the present disclosure is not limited thereto. For example, the ninth fluid passage 64i may be configured not to be surrounded by the seal member 70 at a position not facing the eight opening portions 41 to 48 in the valve outer wall portion 61.

In the embodiment described above, an example has been described where the ninth fluid passage 64i allows the second fluid inlet 44 and the first fluid outlet 41, which are not adjacent to each other, to communicate, but the present disclosure is not limited thereto. For example, the ninth fluid passage 64i may have a configuration in which the first fluid inlet 42 and the second fluid outlet 43, adjacent to each other, communicate via a portion of the valve outer wall portion 61 not facing the eight opening portions 41 to 48.

In the embodiment described above, an example has been described where the first fluid passage 64a to the tenth fluid passage 64j are formed as ten cells in the valve outer wall portion 61, but the present disclosure is not limited thereto. For example, the number of first fluid passage 64a to the tenth fluid passage 64j may be less than ten cells or may be more than ten cells as long as eight cells or more are formed in the valve outer wall portion 61.

In the embodiment described above, an example has been described where the valve 60 rotates in the circumferential direction DRc such that four flow path portions facing the eight opening portions 41 to 48 arranged in two columns in the circumferential direction DRc change every one column, but the present disclosure is not limited thereto. For example, the valve 60 may be configured to rotate in the circumferential direction DRc such that four flow path portions facing the eight opening portions 41 to 48 arranged in two columns in the circumferential direction DRc change every two columns.

In the embodiment described above, an example has been described in which the seal member 70 includes the sliding portion 72 facing the valve outer wall portion 61 and the pressing portion 73 facing the cylinder 11, and the sliding portion 72 and the pressing portion 73 are made of materials different from each other, but the present disclosure is not limited thereto. For example, the seal member 70 does not include the sliding portion 72 and the pressing portion 73, and the portion facing the valve outer wall portion 61 and the portion facing the cylinder 11 may be made of the same material.

In the embodiment described above, an example has been described where the fluid control valve 1 includes the biasing portion 80 that biases the conical valve 60 in the axial-center direction DRa, but the present disclosure is not limited thereto. For example, the fluid control valve 1 may be configured not to include the biasing portion 80.

In the embodiment described above, an example has been described where the internal angle θ formed by the generatrix of the conical shape parallel to the valve outer wall portion 61 and the axial center CL is 5 deg or more, but the disclosure is not limited thereto. For example, the valve 60 may be formed such that the internal angle θ formed by the generatrix of the conical shape parallel to the valve outer wall portion 61 and the axial center CL is smaller than 5 deg.

In the embodiment described above, an example has been described where the inner circumferential surface 16 forming the valve accommodation space AS in the cylinder 11 is shaped along the side surface of the conical shape similar to the valve outer wall portion 61, but the present disclosure is not limited thereto. For example, the inner circumferential surface 16 forming the valve accommodation space AS in the cylinder 11 may be shaped along the side surface of a conical shape that is not similar to the valve outer wall portion 61.

In the embodiment described above, an example has been described where the valve 60, the cover seal 23, and the housing cover 20 are removable from the housing 10 from the first axial-center direction DRa1 side, but the present disclosure is not limited thereto. For example, the valve 60, the cover seal 23, and the housing cover 20 may not be removable from the housing 10 from the first axial-center direction DRa1 side.

In the embodiment described above, an example has been described where the housing cover 20 is fixed to the housing 10 by the snap-fit, but the present disclosure is not limited thereto. For example, the housing cover 20 may be fixed to the housing 10 by a method different from the snap-fit, for example, using an adhesive or the like.

In the embodiment described above, an example has been described where the stopper 63 provided in the valve 60 is provided in a portion different from the portion facing the housing cover 20, but the present disclosure is not limited thereto. For example, the stopper 63 may be provided at a portion facing the housing cover 20.

In the embodiment described above, an example has been described where the rotation regulating portion 122 is formed in the bottom 12 of the housing 10, but the present disclosure is not limited thereto. For example, the rotation regulating portion 122 may be formed at a portion different from the bottom 12, such as the inner circumferential surface 16 of the housing 10.

In the embodiment described above, an example has been described where the stopper 63 is formed extending in the axial-center direction DRa, but the disclosure is not limited thereto. For example, the stopper 63 may extend in a direction different from the axial-center direction DRa, such as the radial direction DRr.

In the embodiment described above, an example has been described in which the plurality of opening portions 40 are formed in a grid pattern with four or five opening portions arranged in the axial-center direction DRa and opening portions arranged in two or three columns in the circumferential direction DRc, but the present disclosure is not limited thereto. For example, the plurality of opening portions 40 may be formed in a grid pattern with six or more opening portions arranged in the axial-center direction DRa. Further, the plurality of opening portions 40 may be formed in a grid pattern with the opening portions arranged in four or more columns in the circumferential direction DRc.

In the embodiment described above, the fluid control valve 1 has been described as being used in a fluid circulation system mounted on, for example, an electric vehicle or a hybrid vehicle, but the present disclosure is not limited thereto. For example, the fluid control valve 1 may be used in a fluid circulation system mounted on a vehicle other than an electric vehicle or a hybrid vehicle. The fluid control valve 1 may be used for applications other than vehicles.

In the embodiment described above, the fluid flowing in the fluid control valve 1 is described as the cooling water, but the present disclosure is not limited thereto. For example, the fluid may be a liquid or a gas other than cooling water.

It goes without saying that in the embodiments described above, the elements constituting the embodiments are not necessarily essential except for a case where it is explicitly stated that the elements are particularly essential and a case where the elements are considered to be obviously essential in principle.

In the embodiments described above, when a numerical value such as the number, a numerical value, an amount, or a range of the constituent elements of the embodiment is referred to, the numerical value is not limited to specific numerical values unless otherwise specified as being essential or obviously limited to the specific numerical values in principle.

In the embodiments described above, when the shapes, positional relationships, and the like of the components and the like are referred to, the shapes, positional relationships, and the like are not limited thereto unless otherwise specified or limited to specific shapes, positional relationships, and the like in principle.

The control unit and the technique according to the present disclosure may be achieved by a dedicated computer provided by configuring a processor and a memory programmed to execute one or more of functions embodied by a computer program. The control unit and technique thereof of the present disclosure may be achieved by a dedicated computer provided by configuring a processor by one or more dedicated hardware logic circuits. The control unit and the technique according to the present disclosure may be achieved by one or more dedicated computers configured by a combination of a processor and a memory programmed to execute one or more functions and a processor configured by one or more hardware logic circuits. The computer program may be stored in a computer-readable non-transitional tangible recording medium as an instruction to be executed by the computer.

### View Points of the Present Disclosure

The present disclosure described above can be understood, for example, from the following viewpoints.

### View Point 1

A fluid control valve including: a valve (60) configured to rotate about an axial center (CL) and including a valve outer wall portion (61) defining a plurality of flow path portions (64) configured to cause fluid to flow therethrough; a housing (11) including a housing outer wall portion (40) defining a valve accommodation space (AS) accommodating the valve, and a plurality of opening portions (10) in the housing outer wall portion configured to cause fluid to pass therethrough; and a seal member (70) provided between the valve outer wall portion and a portion of the housing outer wall portion defining the plurality of opening portions, in which a direction in which the axial center extends is an axial-center direction, a direction in which the valve is rotatable about the axial center is a circumferential direction, and the plurality of opening portions are defined in a grid pattern in which two or more opening portions of the plurality of opening portions are arranged in the axial-center direction in two or more columns in the circumferential direction, the seal member has a plurality of through-holes (71) configured to cause the fluid to pass therethrough, the plurality of flow path portions are in shapes corresponding to the plurality of opening portions and the plurality of through-holes, respectively, the plurality of through-holes are formed, with a plurality of through-holes arranged in the axial-center direction and the plurality of through-holes arranged in a plurality of columns in the circumferential direction, the number of columns of the plurality of opening portions, which are arranged in the circumferential direction, is the number of opening columns, the number of columns of the plurality of through-holes arranged in the circumferential direction is the number of through-hole columns, and the number of through-hole columns is set to be larger than the number of opening columns.

### View Point 2

The fluid control valve according to view point 1, in which the number of through-hole columns is two more than the number of opening columns, and one more column of the plurality of through-holes are provided on each of one side and an other side in the circumferential direction with respect to the plurality of opening portions arranged in the circumferential direction.

### View Point 3

The fluid control valve according to view point 1 or 2, in which the plurality of opening portions include an end-portion fluid inlet and an end-portion fluid outlet, each provided at either a one-side end portion or an other-side end portion in the circumferential direction, the valve outer wall portion is formed with a bypass flow path portion (64j, 64k) that guides the fluid flowing in from the end-portion fluid inlet to the end-portion fluid outlet while bypassing portions of the valve outer wall portion facing the plurality of opening portions, and the seal member surrounds the bypass flow path portion at a position offset from the plurality of opening portions in the circumferential direction.

### View Point 4

The fluid control valve according to view point 3, in which the bypass flow path portion is configured to communicate between the end-portion fluid inlet and the end-portion fluid outlet that are spaced apart from each other.

### View Point 5

The fluid control valve according to any one of view points 1 to 4, in which the plurality of flow path portions are flow path portions of eight cells or more in a case where a flow path portion in each of a plurality of columns arranged in the circumferential direction among the plurality of flow path portions is a one-cell flow path portion.

### View Point 6

The fluid control valve according to view point 5, in which the valve is configured to rotate in the circumferential direction such that the plurality of flow path portions facing the plurality of opening portions arranged in the plurality of columns in the circumferential direction change every one column.

### View Point 7

The fluid control valve according to any one of view points 1 to 6, in which the seal member includes a sliding portion (72) facing the valve outer wall portion and a pressing portion (73) facing the housing outer wall portion, and the sliding portion and the pressing portion are made of materials different from each other.

### View Point 8

The fluid control valve according to any one of view points 1 to 7, further including: a biasing portion (80) configured to bias the valve in the axial-center direction, in which the valve outer wall portion is along a side surface of the conical shape with an apex on one side in the axial-center direction, and the biasing portion is configured to bias the valve toward the apex of the conical shape, and during both rotation and stop of the valve, keep a state in which the valve outer wall portion and the seal member are pressed, and keep a state in which the housing outer wall portion and the seal member are pressed.

### View Point 9

The fluid control valve according to view point 8, in which an internal angle formed by a generatrix of a conical shape parallel to the valve outer wall portion and the axial center is 5 deg or more.

### View Point 10

The fluid control valve according to view point 8 or 9, in which an inner circumferential surface (16) defining the valve accommodation space in the housing outer wall portion is along the side surface of the conical shape similar to the valve outer wall portion.

### View Point 11

The fluid control valve according to any one of view points 1 to 10, in which the plurality of flow path portions are side by side in the axial-center direction, a direction extending radially from the axial center is a radial direction, and a distance in the radial direction from each of the plurality of flow path portions arranged side by side in the axial-center direction is constant.

### View Point 12

The fluid control valve according to any one of view points 1 to 11, further including: a housing cover (20) closing the valve accommodation space; a cover seal (23) attached to the housing cover; and a drive unit (30) configured to output a rotational force configured to rotate the valve, in which the valve includes a rotating shaft (62) that protrudes toward one side in the axial-center direction, is connected to the drive unit, and is rotated by the rotational force, the housing has a cylindrical shape extending in the axial-center direction and opens on one side in the axial-center direction, the housing cover has a shaft hole (22) into which the rotating shaft is inserted, the cover seal is provided between the shaft hole and the rotating shaft in the shaft hole, and the valve, the cover seal, and the housing cover are removable from the housing from one side in the axial-center direction.

### View Point 13

The fluid control valve according to view point 12, in which the housing cover is fixed to the housing by a snap-fit.

### View Point 14

The fluid control valve according to view point 12 or 13, in which the drive unit and the housing cover are fixed to the housing by a same screw member.

### View Point 15

The fluid control valve according to any one of view points 12 to 14, in which the valve includes a stopper (63) configured to regulate rotation of the valve, and the stopper is provided in a portion different from a portion facing the housing cover.

### View Point 16

The fluid control valve according to view point 15, in which the housing includes a bottom (12) that closes the other side in the axial-center direction, the stopper protrudes toward the bottom, and the bottom includes a rotation regulating portion (122) in contact with the stopper to regulate rotation of the valve.

### View Point 17

The fluid control valve according to view point 16, in which the stopper extends in the axial-center direction.

What is claimed is:

1. A fluid control valve comprising:
a valve configured to rotate about an axial center and including a valve outer wall portion defining a plurality of flow path portions configured to cause fluid to flow therethrough;
a housing including a housing outer wall portion defining a valve accommodation space accommodating the valve, and a plurality of opening portions in the housing outer wall portion configured to cause fluid to pass therethrough; and
a seal member provided between the valve outer wall portion and a portion of the housing outer wall portion defining the plurality of opening portions, wherein
a direction in which the axial center extends is an axial-center direction, a direction in which the valve is rotatable about the axial center is a circumferential direction, and the plurality of opening portions are defined in a grid pattern in which two or more opening portions of the plurality of opening portions are arranged in the axial-center direction in two or more columns in the circumferential direction,
the seal member has a plurality of through-holes configured to cause the fluid to pass therethrough,
the plurality of flow path portions are in shapes corresponding to the plurality of opening portions and the plurality of through-holes, respectively,
the plurality of through-holes include a plurality of through-holes arranged in the axial-center direction and a plurality of through-holes arranged in a plurality of columns in the circumferential direction,
the number of columns of the plurality of opening portions, which are arranged in the circumferential direction, is a number of opening columns,
the number of columns of the plurality of through-holes, which are arranged in the circumferential direction, is a number of through-hole columns, and
the number of through-hole columns is set to be larger than the number of opening columns.

2. The fluid control valve according to claim 1, wherein
the number of through-hole columns is two more than the number of opening columns, and
one more column of the plurality of through-holes are provided on each of one side and an other side in the circumferential direction with respect to the plurality of opening portions arranged in the circumferential direction.

3. The fluid control valve according to claim 1, wherein
the plurality of opening portions include an end-portion fluid inlet and an end-portion fluid outlet, each provided at either a one-side end portion or an other-side end portion in the circumferential direction,
the valve outer wall portion is formed with a bypass flow path portion that is configured to guide fluid flowing in from the end-portion fluid inlet to the end-portion fluid outlet while bypassing a portion of the valve outer wall portion facing the plurality of opening portions, and
the seal member surrounds the bypass flow path portion at a position offset from the plurality of opening portions in the circumferential direction.

4. The fluid control valve according to claim 3, wherein
the bypass flow path portion is configured to communicate between the end-portion fluid inlet and the end-portion fluid outlet that are spaced apart from each other.

5. The fluid control valve according to claim 1, wherein
a flow path portion in each of a plurality of columns arranged in the circumferential direction among the plurality of flow path portions is a one-cell flow path portion, and
the plurality of flow path portions are flow path portions of eight cells or more.

6. The fluid control valve according to claim 5, wherein
the valve is configured to rotate in the circumferential direction such that the plurality of flow path portions facing the plurality of opening portions arranged in the plurality of columns in the circumferential direction change every one column.

7. The fluid control valve according to claim 1, wherein
the seal member includes a sliding portion facing the valve outer wall portion and a pressing portion facing the housing outer wall portion, and
the sliding portion and the pressing portion are made of materials different from each other.

8. The fluid control valve according to claim 1, further comprising:
a biasing portion configured to bias the valve in the axial-center direction, wherein
the valve outer wall portion is along a side surface of the conical shape with an apex on one side in the axial-center direction, and
the biasing portion is configured to bias the valve toward the apex of the conical shape, and during both rotation and stop of the valve, keep a state in which the valve outer wall portion and the seal member are pressed, and keep a state in which the housing outer wall portion and the seal member are pressed.

9. The fluid control valve according to claim 8, wherein
an internal angle formed by a generatrix of a conical shape parallel to the valve outer wall portion and the axial center is 5 deg or more.

10. The fluid control valve according to claim 8, wherein
an inner circumferential surface defining the valve accommodation space in the housing outer wall portion is along the side surface of the conical shape similar to the valve outer wall portion.

11. The fluid control valve according to claim 1, wherein
the plurality of flow path portions are side by side in the axial-center direction,
a direction extending radially from the axial center is a radial direction, and
a distance in the radial direction from each of the plurality of flow path portions arranged side by side in the axial-center direction is constant.

12. The fluid control valve according to claim 1, further comprising:
a housing cover closing the valve accommodation space;
a cover seal attached to the housing cover; and
a drive unit configured to output a rotational force configured to rotate the valve, wherein
the valve includes a rotating shaft protruding toward one side in the axial-center direction,
the rotating shaft is connected to the drive unit and configured to be rotated by the rotational force,
the housing has a cylindrical shape extending in the axial-center direction and opens on one side in the axial-center direction,
the housing cover has a shaft hole into which the rotating shaft is inserted,
the cover seal is provided between the shaft hole and the rotating shaft in the shaft hole, and
the valve, the cover seal, and the housing cover are removable from the housing from one side in the axial-center direction.

13. The fluid control valve according to claim 12, wherein
the housing cover is fixed to the housing by a snap-fit.

14. The fluid control valve according to claim 12, wherein p1 the drive unit and the housing cover are fixed to the housing by a same screw member.

15. The fluid control valve according to claim 12, wherein
the valve includes a stopper configured to regulate rotation of the valve, and
the stopper is provided in a portion different from a portion facing the housing cover.

16. The fluid control valve according to claim 15, wherein
the housing includes a bottom that closes the other side in the axial-center direction,
the stopper protrudes toward the bottom, and
the bottom includes a rotation regulating portion in contact with the stopper to regulate rotation of the valve.

17. The fluid control valve according to claim 16, wherein
the stopper extends in the axial-center direction.
